(19) United States
(12) Patent Application Publication
(10) Pub. No.: US 2024/0396675 A1
(43) Pub. Date: Nov. 28, 2024

(54) JOINT TYPE-2 HYBRID AUTOMATIC REPEAT REQUEST CODEBOOK FOR DOWNLINK AND SIDELINK COMMUNICATIONS

(71) Applicant: QUALCOMM Incorporated, San Diego, CA (US)

(72) Inventors: Shaozhen GUO, Beijing (CN); Jing SUN, San Diego, CA (US); Changlong XU, Beijing (CN); Xiaoxia ZHANG, San Diego, CA (US); Luanxia YANG, Beijing (CN); Siyi CHEN, Beijing (CN); Hao XU, Beijing (CN)

(21) Appl. No.: 18/700,658

(22) PCT Filed: Dec. 14, 2021
(86) PCT No.: PCT/CN2021/137778

§ 371 Date: Apr. 11, 2024

(51) Int. Cl. H04L 1/1867; H04L 5/00; H04W 24/10

(52) U.S. Cl. CPC H04L 1/1896; H04L 5/0092; H04W 24/10

(57) ABSTRACT

Methods, systems, and devices for wireless communications are described. Methods, systems, and devices for wireless communications are described. The described techniques provide for joint hybrid automatic repeat request (HARQ) feedback for sidelink transmissions and downlink transmissions. In some examples, a base station may transmit control signaling to a user equipment (UE) indicating a configuration for a joint HARQ codebook. The UE may receive a set of sidelink transmissions and a set of downlink transmissions, generate a joint HARQ codebook based on a downlink counter (e.g., a counter downlink assignment index) for the downlink transmissions and a sidelink counter (e.g., a counter sidelink assignment index) for the sidelink transmissions, where the downlink counter and the sidelink counter are jointly summed, and transmit feedback message to the base station for the downlink transmissions and the sidelink transmissions based on the joint HARQ codebook.

### CROSS REFERENCE

The present application is a 371 national stage filing of International PCT Application No. PCT/CN2021/137778 by GUO et al. entitled “JOINT TYPE-2 HYBRID AUTOMATIC REPEAT REQUEST CODEBOOK FOR DOWNLINK AND SIDELINK COMMUNICATIONS,” filed Dec. 14, 2021, which is assigned to the assignee hereof, and which is expressly incorporated by reference in its entirety herein.

### FIELD OF TECHNOLOGY

The following relates to wireless communications, including a joint type-2 hybrid automatic repeat request (HARQ) codebook for downlink and sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support a joint type-2 hybrid automatic repeat request (HARQ) codebook for downlink and sidelink communications. Generally, the described techniques provide for joint HARQ feedback for sidelink transmissions and downlink transmissions. In some examples, a base station may transmit control signaling to a user equipment (UE) indicating a configuration for a joint HARQ codebook. The UE may receive a set of sidelink transmissions and a set of downlink transmissions, generate a joint HARQ codebook based on a downlink counter (e.g., a counter downlink assignment index) for the downlink transmissions and a sidelink counter (e.g., a counter sidelink assignment index) for the sidelink transmissions, where the downlink counter and the sidelink counter are jointly summed, and transmit feedback message to the base station for the downlink transmissions and the sidelink transmissions based on the joint HARQ codebook. In some examples, the UE may use and generate the joint HARQ codebook based on either a scheduled sidelink HARQ report or a scheduled downlink HARQ report failing. In some examples, the later received downlink control information (DCI) scheduling either the sidelink transmissions or the downlink transmissions may indicate to use and generate the joint HARQ codebook based on either a scheduled sidelink HARQ report or a scheduled downlink HARQ report failing. In some examples, the downlink transmissions and sidelink transmissions may be associated with either the same or different HARQ group indices.

In some examples, the base station may transmit DCI indicating a feedback report format for HARQ feedback for at least one set of sidelink transmissions and at least one set of downlink transmissions, and the UE may transmit a feedback report based on the indicated feedback report format. The formats may include, for example, transmitting HARQ feedback for a scheduled set of sidelink transmissions; transmitting HARQ feedback for a scheduled set of downlink transmissions; transmitting HARQ-ACK feedback for a scheduled set of sidelink transmissions having a first HARQ group index and an unscheduled set of sidelink transmissions having a different HARQ group index; transmitting HARQ-ACK feedback for a scheduled set of downlink transmissions having a first HARQ group index and an unscheduled set of downlink transmissions having a different group index; transmitting HARQ feedback for a scheduled set of sidelink transmissions and an unscheduled (e.g., not scheduled by the DCI indicating the feedback report format) set of downlink transmissions (where the set of sidelink transmissions and the set of downlink transmissions may be associated with the same or different HARQ group indices); transmitting HARQ feedback for a scheduled set of downlink transmissions and an unscheduled set of sidelink transmissions (where the set of sidelink transmissions and the set of downlink transmissions may be associated with the same or different HARQ group indices); transmitting HARQ feedback for a scheduled set of sidelink transmissions, an unscheduled set of downlink transmissions (where the set of sidelink transmissions and the set of downlink transmissions may be associated with the same or different HARQ group indices), and a set of unscheduled sidelink transmissions having a different HARQ group index; transmitting HARQ feedback for a scheduled set of downlink transmissions, an unscheduled set of sidelink transmissions (where the set of sidelink transmissions and the set of downlink transmissions may be associated with the same or different HARQ group indices), and a set of unscheduled downlink transmissions having a different HARQ group index; transmitting HARQ feedback for a scheduled set of sidelink transmissions having a first HARQ group index, an unscheduled set of downlink transmissions having the same HARQ group index and an unscheduled set of downlink transmissions having a different HARQ group index; transmitting HARQ feedback for a scheduled set of downlink transmissions having a first HARQ group index, an unscheduled set of sidelink transmissions having the same HARQ group index and an unscheduled set of sidelink transmissions having a different HARQ group index; transmitting HARQ feedback for a scheduled set of sidelink transmissions having a first HARQ group index, a set of unscheduled downlink transmissions having the same group index, a set of unscheduled downlink transmissions having a different HARQ group index, and an unscheduled set of sidelink transmissions having a different HARQ group index; and transmitting HARQ feedback for a scheduled set of downlink transmissions having a first HARQ group index, a set of unscheduled sidelink transmissions having the same group index, a set of unscheduled sidelink transmissions having a different HARQ group index, and an unscheduled set of downlink transmissions having a different HARQ group index.

A method for wireless communications at a first user equipment (UE) is described. The method may include receiving, from a base station, a downlink control information message indicating a feedback report format for reporting hybrid automatic repeat request feedback for sidelink transmissions and downlink transmissions, transmitting, to at least a second UE, a set of sidelink transmissions, receiving, from the base station, a set of downlink transmissions, and transmit, to the base station, a feedback report for at least one of the set of sidelink transmissions or the set of downlink transmissions based on the feedback report format.

An apparatus for wireless communications at a first UE is described. The apparatus may include a processor, memory coupled with the processor, and instructions stored in the memory. The instructions may be executable by the processor to cause the apparatus to receive, from a base station, a downlink control information message indicating a feedback report format for reporting hybrid automatic repeat request feedback for sidelink transmissions and downlink transmissions, transmit, to at least a second UE, a set of sidelink transmissions, receive, from the base station, a set of downlink transmissions, and transmit, to the base station, a feedback report for at least one of the set of sidelink transmissions or the set of downlink transmissions based on the feedback report format.

Another apparatus for wireless communications at a first UE is described. The apparatus may include means for receiving, from a base station, a downlink control information message indicating a feedback report format for reporting hybrid automatic repeat request feedback for sidelink transmissions and downlink transmissions, means for transmitting, to at least a second UE, a set of sidelink transmissions, means for receiving, from the base station, a set of downlink transmissions, and means for transmit, to the base station, a feedback report for at least one of the set of sidelink transmissions or the set of downlink transmissions based on the feedback report format.

A non-transitory computer-readable medium storing code for wireless communications at a first UE is described. The code may include instructions executable by a processor to receive, from a base station, a downlink control information message indicating a feedback report format for reporting hybrid automatic repeat request feedback for sidelink transmissions and downlink transmissions, transmit, to at least a second UE, a set of sidelink transmissions, receive, from the base station, a set of downlink transmissions, and transmit, to the base station, a feedback report for at least one of the set of sidelink transmissions or the set of downlink transmissions based on the feedback report format.

Some examples of the method, apparatuses, and non-transitory computer-readable medium described herein may further include operations, features, means, or instructions for receiving, from the base station, a second downlink control information message indicating scheduling information for the set of sidelink transmissions and a group index associated with the set of sidelink transmissions and receiving, with the downlink control information message, an indication of scheduling information for the set of downlink transmissions and that the set of downlink transmissions may be associated with the group index, and where the feedback report format includes a joint feedback report for reporting the set of sidelink transmissions associated with the group index and the set of downlink transmissions associated with the group index.

In some examples of the method, apparatuses, and non-transitory computer-readable medium described herein, an order for feedback for each transmission of the set of downlink transmissions and the set of sidelink transmissions in the joint feedback report may be based on a transmission type for each transmission.

Some examples of the method, apparatuses, and non-transitory computer-readable medium described herein may further include operations, features, means, or instructions for receiving, from the base station, a second downlink control information message indicating scheduling information for the set of downlink transmissions and a group index associated with the set of downlink transmissions and receiving, with the downlink control information message, an indication of scheduling information for the set of sidelink transmissions and that the set of sidelink transmissions may be associated with the group index, and where the feedback report format includes a joint feedback report for reporting feedback information for the set of sidelink transmissions associated with the group index and the set of downlink transmissions associated with the group index.

In some examples of the method, apparatuses, and non-transitory computer-readable medium described herein, an order for feedback for each transmission of the set of downlink transmissions and the set of sidelink transmissions in the joint feedback report may be based on a transmission type for each transmission.

Some examples of the method, apparatuses, and non-transitory computer-readable medium described herein may further include operations, features, means, or instructions for receiving, from the base station, a second downlink control information message indicating scheduling information for the set of sidelink transmissions and a first group index associated with the set of sidelink transmissions and receiving, with the downlink control information message, an indication of scheduling information for the set of downlink transmissions and that the set of downlink transmissions may be associated with a second group index, and where the feedback report format includes a joint feedback report for reporting feedback information for the set of sidelink transmissions associated with the first group index and the set of downlink transmissions associated with the second group index.

In some examples of the method, apparatuses, and non-transitory computer-readable medium described herein, an order for feedback for each transmission of the set of downlink transmissions and the set of sidelink transmissions in the joint feedback report may be based on the first group index and the second group index.

Some examples of the method, apparatuses, and non-transitory computer-readable medium described herein may further include operations, features, means, or instructions for receiving, from the base station, a second downlink control information message indicating scheduling information for the set of downlink transmissions and a first group index associated with the set of downlink transmissions and receiving, with the downlink control information message, an indication of scheduling information for the set of sidelink transmissions and that the set of sidelink transmissions may be associated with a second group index, and where the feedback report format includes a joint feedback report for reporting feedback information for the set of sidelink transmissions associated with the first group index and the set of downlink transmissions associated with the second group index.

In some examples of the method, apparatuses, and non-transitory computer-readable medium described herein, an order for feedback for each transmission of the set of downlink transmissions and the set of sidelink transmissions in the joint feedback report may be based on the first group index and the second group index.

Some examples of the method, apparatuses, and non-transitory computer-readable medium described herein may further include operations, features, means, or instructions for receiving, from the base station, a third downlink control information message indicating scheduling information for a second set of sidelink transmissions and a third group index associated with the second set of sidelink transmissions, transmitting, to at least the second UE, the second set of sidelink transmissions, receiving, from the base station, a second downlink control information message indicating scheduling information for the set of downlink transmissions and a first group index associated with the set of downlink transmissions, and receiving, with the downlink control information message, an indication of scheduling information for the set of sidelink transmissions and that the set of sidelink transmissions may be associated with the first group index, and where the feedback report format includes a joint feedback report for reporting the set of downlink transmissions associated with the first group index, the set of sidelink transmissions associated with the first group index, and the second set of sidelink transmissions associated with the third group index.

Some examples of the method, apparatuses, and non-transitory computer-readable medium described herein may further include operations, features, means, or instructions for receiving, from the base station, a third downlink control information message indicating scheduling information for a second set of sidelink transmissions and a third group index associated with the second set of sidelink transmissions, transmitting, to at least the second UE, the second set of sidelink transmissions, receiving, from the base station, a second downlink control information message indicating scheduling information for the set of downlink transmissions and a first group index associated with the set of downlink transmissions, and receiving, with the downlink control information message, an indication of scheduling information for the set of sidelink transmissions and that the set of sidelink transmissions may be associated with a second group index, and where the feedback report format includes a joint feedback report for reporting the set of downlink transmissions associated with the first group index, the set of sidelink transmissions associated with the second group index, and the second set of sidelink transmissions associated with the third group index.

Some examples of the method, apparatuses, and non-transitory computer-readable medium described herein may further include operations, features, means, or instructions for receiving, from the base station, a third downlink control information message indicating scheduling information for a second set of downlink transmissions and a third group index associated with the second set of downlink transmissions, receiving, from the base station, the second set of downlink transmissions, receiving, from the base station, a second downlink control information message indicating scheduling information for the set of sidelink transmissions and a first group index associated with the set of sidelink transmissions, and receiving, with the downlink control information message, an indication of scheduling information for the set of downlink transmissions and that the set of downlink transmissions may be associated with the first group index, and where the feedback report format includes a joint feedback report for reporting the set of sidelink transmissions associated with the first group index, the set of downlink transmissions associated with the first group index, and the second set of downlink transmissions associated with the third group index.

Some examples of the method, apparatuses, and non-transitory computer-readable medium described herein may further include operations, features, means, or instructions for receiving, from the base station, a third downlink control information message indicating scheduling information for a second set of downlink transmissions and a third group index associated with the second set of downlink transmissions, receiving, from the base station, the second set of downlink transmissions, receiving, from the base station, a second downlink control information message indicating scheduling information for the set of sidelink transmissions and a first group index associated with the set of sidelink transmissions, and receiving, with the downlink control information message, an indication of scheduling information for the set of downlink transmissions and that the set of downlink transmissions may be associated with a second group index, and where the feedback report format includes a joint feedback report for reporting the set of sidelink transmissions associated with the first group index, the set of downlink transmissions associated with the second group index, and the second set of downlink transmissions associated with the third group index.

Some examples of the method, apparatuses, and non-transitory computer-readable medium described herein may further include operations, features, means, or instructions for receiving, from the base station, a third downlink control information message indicating scheduling information for a second set of downlink transmissions and a third group index associated with the second set of downlink transmissions, receiving, from the base station, the second set of downlink transmissions, receiving, from the base station, a second downlink control information message indicating scheduling information for the set of downlink transmissions and a first group index associated with the set of downlink transmissions, and receiving, with the downlink control information message, an indication of scheduling information for the set of sidelink transmissions and that the set of sidelink transmissions may be associated with the first group index, and where the feedback report format includes a joint feedback report for reporting the set of downlink transmissions associated with the first group index, the set of sidelink transmissions associated with the first group index, and the second set of downlink transmissions associated with the third group index.

Some examples of the method, apparatuses, and non-transitory computer-readable medium described herein may further include operations, features, means, or instructions for receiving, from the base station, a third downlink control information message indicating scheduling information for a second set of sidelink transmissions and a third group index associated with the second set of sidelink transmissions, transmitting, to at least the second UE, the second set of sidelink transmissions, receiving, from the base station, a second downlink control information message indicating scheduling information for the set of sidelink transmissions and a first group index associated with the set of sidelink transmissions, and receiving, with the downlink control information message, an indication of scheduling information for the set of downlink transmissions and that the set of downlink transmissions may be associated with the first group index, and where the feedback report format includes a joint feedback report for reporting the set of sidelink transmissions associated with the first group index, the set of downlink transmissions associated with the first group index, and the second set of sidelink transmissions associated with the third group index.

Some examples of the method, apparatuses, and non-transitory computer-readable medium described herein may further include operations, features, means, or instructions for receiving, from the base station, a third downlink control information message indicating scheduling information for a second set of sidelink transmissions and a third group index associated with the second set of sidelink transmissions, transmitting, to at least the second UE, the second set of sidelink transmissions, receiving, from the base station, a fourth downlink control information message indicating scheduling information for a second set of downlink transmissions and a fourth group index associated with the second set of downlink transmissions, receiving, from the base station, the second set of downlink transmissions, receiving, from the base station, a second downlink control information message indicating scheduling information for the set of downlink transmissions and a first group index associated with the set of downlink transmissions, and receiving, with the downlink control information message, an indication of scheduling information for the set of sidelink transmissions and that the set of sidelink transmissions may be associated with the first group index, and where the feedback report format includes a joint feedback report for reporting the set of downlink transmissions associated with the first group index, the set of sidelink transmissions associated with the first group index, the second set of sidelink transmissions associated with the third group index, and the second set of downlink transmissions associated with the fourth group index.

In some examples of the method, apparatuses, and non-transitory computer-readable medium described herein, an order for feedback for each transmission of the set of downlink transmissions, the set of sidelink transmissions, the second set of downlink transmissions, and the second set of sidelink transmissions in the joint feedback report may be based on the first group index, the third group index, the fourth group index, and a transmission type for each transmission.

Some examples of the method, apparatuses, and non-transitory computer-readable medium described herein may further include operations, features, means, or instructions for receiving, from the base station, a third downlink control information message indicating scheduling information for a second set of downlink transmissions and a third group index associated with the second set of downlink transmissions, receiving, from the base station, the second set of downlink transmissions, receiving, from the base station, a fourth downlink control information message indicating scheduling information for a second set of sidelink transmissions and a fourth group index associated with the second set of sidelink transmissions, transmitting, to at least the second UE, the second set of sidelink transmissions, receiving, from the base station, a second downlink control information message indicating scheduling information for the set of sidelink transmissions and a first group index associated with the set of sidelink transmissions, and receiving, with the downlink control information message, an indication of scheduling information for the set of downlink transmissions and that the set of downlink transmissions may be associated with the first group index, and where the feedback report format includes a joint feedback report for reporting the set of sidelink transmissions associated with the first group index, the set of downlink transmissions associated with the first group index, the second set of downlink transmissions associated with the third group index, and the second set of sidelink transmissions associated with the fourth group index.

In some examples of the method, apparatuses, and non-transitory computer-readable medium described herein, an order for feedback for each transmission of the set of downlink transmissions, the set of sidelink transmissions, the second set of downlink transmissions, and the second set of sidelink transmissions in the joint feedback report may be based on the first group index, the third group index, the fourth group index, and a transmission type for each transmission.

Some examples of the method, apparatuses, and non-transitory computer-readable medium described herein may further include operations, features, means, or instructions for receiving, with the downlink control information message, a set of bits indicating the feedback report format.

A method for wireless communications at a base station is described. The method may include transmitting, to a UE, a downlink control information message indicating a feedback report format for reporting hybrid automatic repeat request feedback for sidelink transmissions and downlink transmissions, transmitting, to the UE, scheduling information for a set of sidelink transmissions, transmitting, to the UE, a set of downlink transmissions, and receiving, from the UE, a feedback report for at least one of the set of sidelink transmissions or the set of downlink transmissions based on the feedback report format.

An apparatus for wireless communications at a base station is described. The apparatus may include a processor, memory coupled with the processor, and instructions stored in the memory. The instructions may be executable by the processor to cause the apparatus to transmit, to a UE, a downlink control information message indicating a feedback report format for reporting hybrid automatic repeat request feedback for sidelink transmissions and downlink transmissions, transmit, to the UE, scheduling information for a set of sidelink transmissions, transmit, to the UE, a set of downlink transmissions, and receive, from the UE, a feedback report for at least one of the set of sidelink transmissions or the set of downlink transmissions based on the feedback report format.

Another apparatus for wireless communications at a base station is described. The apparatus may include means for transmitting, to a UE, a downlink control information message indicating a feedback report format for reporting hybrid automatic repeat request feedback for sidelink transmissions and downlink transmissions, means for transmitting, to the UE, scheduling information for a set of sidelink transmissions, means for transmitting, to the UE, a set of downlink transmissions, and means for receiving, from the UE, a feedback report for at least one of the set of sidelink transmissions or the set of downlink transmissions based on the feedback report format.

A non-transitory computer-readable medium storing code for wireless communications at a base station is described. The code may include instructions executable by a processor to transmit, to a UE, a downlink control information message indicating a feedback report format for reporting hybrid automatic repeat request feedback for sidelink transmissions and downlink transmissions, transmit, to the UE, scheduling information for a set of sidelink transmissions, transmit, to the UE, a set of downlink transmissions, and receive, from the UE, a feedback report for at least one of the set of sidelink transmissions or the set of downlink transmissions based on the feedback report format.

Some examples of the method, apparatuses, and non-transitory computer-readable medium described herein may further include operations, features, means, or instructions for transmitting, to the UE, a second downlink control information message indicating scheduling information for the set of sidelink transmissions and a group index associated with the set of sidelink transmissions and transmitting, with the downlink control information message, an indication of scheduling information for the set of downlink transmissions and that the set of downlink transmissions may be associated with the group index, and where the feedback report format includes a joint feedback report for reporting the set of sidelink transmissions associated with the group index and the set of downlink transmissions associated with the group index.

In some examples of the method, apparatuses, and non-transitory computer-readable medium described herein, an order for feedback for each transmission of the set of downlink transmissions and the set of sidelink transmissions in the joint feedback report may be based on a transmission type for each transmission.

Some examples of the method, apparatuses, and non-transitory computer-readable medium described herein may further include operations, features, means, or instructions for transmitting, to the UE, a second downlink control information message indicating scheduling information for the set of downlink transmissions and a group index associated with the set of downlink transmissions and transmitting, with the downlink control information message, an indication of scheduling information for the set of sidelink transmissions and that the set of sidelink transmissions may be associated with the group index, and where the feedback report format includes a joint feedback report for reporting feedback information for the set of sidelink transmissions associated with the group index and the set of downlink transmissions associated with the group index.

In some examples of the method, apparatuses, and non-transitory computer-readable medium described herein, an order for feedback for each transmission of the set of downlink transmissions and the set of sidelink transmissions in the joint feedback report may be based on a transmission type for each transmission.

Some examples of the method, apparatuses, and non-transitory computer-readable medium described herein may further include operations, features, means, or instructions for transmitting, to the UE, a second downlink control information message indicating scheduling information for the set of sidelink transmissions and a first group index associated with the set of sidelink transmissions and transmitting, with the downlink control information message, an indication of scheduling information for the set of downlink transmissions and that the set of downlink transmissions may be associated with a second group index, and where the feedback report format includes a joint feedback report for reporting feedback information for the set of sidelink transmissions associated with the first group index and the set of downlink transmissions associated with the second group index.

In some examples of the method, apparatuses, and non-transitory computer-readable medium described herein, an order for feedback for each transmission of the set of downlink transmissions and the set of sidelink transmissions in the joint feedback report may be based on the first group index and the second group index.

Some examples of the method, apparatuses, and non-transitory computer-readable medium described herein may further include operations, features, means, or instructions for transmitting, to the UE, a second downlink control information message indicating scheduling information for the set of downlink transmissions and a first group index associated with the set of downlink transmissions and transmitting, with the downlink control information message, an indication of scheduling information for the set of sidelink transmissions and that the set of sidelink transmissions may be associated with a second group index, and where the feedback report format includes a joint feedback report for reporting feedback information for the set of sidelink transmissions associated with the first group index and the set of downlink transmissions associated with the second group index.

In some examples of the method, apparatuses, and non-transitory computer-readable medium described herein, an order for feedback for each transmission of the set of downlink transmissions and the set of sidelink transmissions in the joint feedback report may be based on the first group index and the second group index.

Some examples of the method, apparatuses, and non-transitory computer-readable medium described herein may further include operations, features, means, or instructions for transmitting, to the UE, a third downlink control information message indicating scheduling information for a second set of sidelink transmissions and a third group index associated with the second set of sidelink transmissions, transmitting, to the UE, a second downlink control information message indicating scheduling information for the set of downlink transmissions and a first group index associated with the set of downlink transmissions, and transmitting, with the downlink control information message, an indication of scheduling information for the set of sidelink transmissions and that the set of sidelink transmissions may be associated with the first group index, and where the feedback report format includes a joint feedback report for reporting the set of downlink transmissions associated with the first group index, the set of sidelink transmissions associated with the first group index, and the second set of sidelink transmissions associated with the third group index.

Some examples of the method, apparatuses, and non-transitory computer-readable medium described herein may further include operations, features, means, or instructions for transmitting, to the UE, a third downlink control information message indicating scheduling information for a second set of sidelink transmissions and a third group index associated with the second set of sidelink transmissions, transmitting, to the UE, a second downlink control information message indicating scheduling information for the set of downlink transmissions and a first group index associated with the set of downlink transmissions, and transmitting, with the downlink control information message, an indication of scheduling information for the set of sidelink transmissions and that the set of sidelink transmissions may be associated with a second group index, and where the feedback report format includes a joint feedback report for reporting the set of downlink transmissions associated with the first group index, the set of sidelink transmissions associated with the second group index, and the second set of sidelink transmissions associated with the third group index.

Some examples of the method, apparatuses, and non-transitory computer-readable medium described herein may further include operations, features, means, or instructions for transmitting, to the UE, a third downlink control information message indicating scheduling information for a second set of downlink transmissions and a third group index associated with the second set of downlink transmissions, transmitting, to the UE, the second set of downlink transmissions, transmitting, to the UE, a second downlink control information message indicating scheduling information for the set of sidelink transmissions and a first group index associated with the set of sidelink transmissions, and transmitting, with the downlink control information message, an indication of scheduling information for the set of downlink transmissions and that the set of downlink transmissions may be associated with the first group index, and where the feedback report format includes a joint feedback report for reporting the set of sidelink transmissions associated with the first group index, the set of downlink transmissions associated with the first group index, and the second set of downlink transmissions associated with the third group index.

Some examples of the method, apparatuses, and non-transitory computer-readable medium described herein may further include operations, features, means, or instructions for transmitting, to the UE, a third downlink control information message indicating scheduling information for a second set of downlink transmissions and a third group index associated with the second set of downlink transmissions, transmitting, to the UE, the second set of downlink transmissions, transmitting, to the UE, a second downlink control information message indicating scheduling information for the set of sidelink transmissions and a first group index associated with the set of sidelink transmissions, and transmitting, with the downlink control information message, an indication of scheduling information for the set of downlink transmissions and that the set of downlink transmissions may be associated with a second group index, and where the feedback report format includes a joint feedback report for reporting the set of sidelink transmissions associated with the first group index, the set of downlink transmissions associated with the second group index, and the second set of downlink transmissions associated with the third group index.

Some examples of the method, apparatuses, and non-transitory computer-readable medium described herein may further include operations, features, means, or instructions for transmitting, to the UE, a third downlink control information message indicating scheduling information for a second set of downlink transmissions and a third group index associated with the second set of downlink transmissions, transmitting, to the UE, the second set of downlink transmissions, transmitting, to the UE, a second downlink control information message indicating scheduling information for the set of downlink transmissions and a first group index associated with the set of downlink transmissions, and transmitting, with the downlink control information message, an indication of scheduling information for the set of sidelink transmissions and that the set of sidelink transmissions may be associated with the first group index, and where the feedback report format includes a joint feedback report for reporting the set of downlink transmissions associated with the first group index, the set of sidelink transmissions associated with the first group index, and the second set of downlink transmissions associated with the third group index.

Some examples of the method, apparatuses, and non-transitory computer-readable medium described herein may further include operations, features, means, or instructions for transmitting, to the UE, a third downlink control information message indicating scheduling information for a second set of sidelink transmissions and a third group index associated with the second set of sidelink transmissions, transmitting, to the UE, a second downlink control information message indicating scheduling information for the set of sidelink transmissions and a first group index associated with the set of sidelink transmissions, and transmitting, with the downlink control information message, an indication of scheduling information for the set of downlink transmissions and that the set of downlink transmissions may be associated with the first group index, and where the feedback report format includes a joint feedback report for reporting the set of sidelink transmissions associated with the first group index, the set of downlink transmissions associated with the first group index, and the second set of sidelink transmissions associated with the third group index.

Some examples of the method, apparatuses, and non-transitory computer-readable medium described herein may further include operations, features, means, or instructions for transmitting, to the UE, a third downlink control information message indicating scheduling information for a second set of sidelink transmissions and a third group index associated with the second set of sidelink transmissions, transmitting, to the UE, a fourth downlink control information message indicating scheduling information for a second set of downlink transmissions and a fourth group index associated with the second set of downlink transmissions, transmitting, to the UE, the second set of downlink transmissions, transmitting, to the UE, a second downlink control information message information indicating scheduling information for the set of downlink transmissions and a first group index associated with the set of downlink transmissions, and transmitting, with the downlink control information message, an indication of scheduling information for the set of sidelink transmissions and that the set of sidelink transmissions may be associated with the first group index, and where the feedback report format includes a joint feedback report for reporting the set of downlink transmissions associated with the first group index, the set of sidelink transmissions associated with the first group index, the second set of sidelink transmissions associated with the third group index, and the second set of downlink transmissions associated with the fourth group index.

In some examples of the method, apparatuses, and non-transitory computer-readable medium described herein, an order for feedback for each transmission of the set of downlink transmissions, the set of sidelink transmissions, the second set of downlink transmissions, and the second set of sidelink transmissions in the joint feedback report may be based on the first group index, the third group index, the fourth group index, and a transmission type for each transmission.

Some examples of the method, apparatuses, and non-transitory computer-readable medium described herein may further include operations, features, means, or instructions for transmitting, to the UE, a third downlink control information message indicating scheduling information for a second set of downlink transmissions and a third group index associated with the second set of downlink transmissions, transmitting, to the UE, the second set of downlink transmissions, transmitting, to the UE, a fourth downlink control information message indicating scheduling information for a second set of sidelink transmissions and a fourth group index associated with the second set of sidelink transmissions, transmitting, to the UE, a second downlink control information message indicating scheduling information for the set of sidelink transmissions and a first group index associated with the set of sidelink transmissions, and transmitting, with the downlink control information message, an indication of scheduling information for the set of downlink transmissions and that the set of downlink transmissions may be associated with the first group index, and where the feedback report format includes a joint feedback report for reporting the set of sidelink transmissions associated with the first group index, the set of downlink transmissions associated with the first group index, the second set of downlink transmissions associated with the third group index, and the second set of sidelink transmissions associated with the fourth group index.

In some examples of the method, apparatuses, and non-transitory computer-readable medium described herein, an order for feedback for each transmission of the set of downlink transmissions, the set of sidelink transmissions, the second set of downlink transmissions, and the second set of sidelink transmissions in the joint feedback report may be based on the first group index, the third group index, the fourth group index, and a transmission type for each transmission.

Some examples of the method, apparatuses, and non-transitory computer-readable medium described herein may further include operations, features, means, or instructions for transmitting, with the downlink control information message, a set of bits indicating the feedback report format.

### BRIEF DESCRIPTION OF THE DRAWINGS

FIG. 1 illustrates an example of a wireless communications system that supports a joint type-2 hybrid automatic repeat request (HARQ) codebook for downlink and sidelink communications in accordance with aspects of the present disclosure.

FIG. 2 illustrates an example of a wireless communications system that supports a joint type-2 HARQ codebook for downlink and sidelink communications in accordance with aspects of the present disclosure.

FIG. 3 illustrates an example of a timing diagram that supports a joint type-2 HARQ codebook for downlink and sidelink communications in accordance with aspects of the present disclosure.

FIG. 4 illustrates an example of a timing diagram that supports a joint type-2 HARQ codebook for downlink and sidelink communications in accordance with aspects of the present disclosure.

FIG. 5 illustrates an example of a timing diagram that supports a joint type-2 HARQ codebook for downlink and sidelink communications in accordance with aspects of the present disclosure.

FIG. 6 illustrates an example of a timing diagram that supports a joint type-2 HARQ codebook for downlink and sidelink communications in accordance with aspects of the present disclosure.

FIG. 7 illustrates an example of a timing diagram that supports a joint type-2 HARQ codebook for downlink and sidelink communications in accordance with aspects of the present disclosure.

FIG. 8 illustrates an example of a timing diagram that supports a joint type-2 HARQ codebook for downlink and sidelink communications in accordance with aspects of the present disclosure.

FIG. 9 illustrates an example of a timing diagram that supports a joint type-2 HARQ codebook for downlink and sidelink communications in accordance with aspects of the present disclosure.

FIG. 10 illustrates an example of a timing diagram that supports a joint type-2 HARQ codebook for downlink and sidelink communications in accordance with aspects of the present disclosure.

FIG. 11 illustrates an example of a timing diagram that supports a joint type-2 HARQ codebook for downlink and sidelink communications in accordance with aspects of the present disclosure.

FIG. 12 illustrates an example of a timing diagram that supports a joint type-2 HARQ codebook for downlink and sidelink communications in accordance with aspects of the present disclosure.

FIG. 13 illustrates an example of a timing diagram that supports a joint type-2 HARQ codebook for downlink and sidelink communications in accordance with aspects of the present disclosure.

FIG. 14 illustrates an example of a process flow that supports a joint type-2 HARQ codebook for downlink and sidelink communications in accordance with aspects of the present disclosure.

FIG. 15 illustrates an example of a process flow that supports a joint type-2 HARQ codebook for downlink and sidelink communications in accordance with aspects of the present disclosure.

FIGS. 16 and 17 show block diagrams of devices that support a joint type-2 HARQ codebook for downlink and sidelink communications in accordance with aspects of the present disclosure.

FIG. 18 shows a block diagram of a communications manager that supports a joint type-2 HARQ codebook for downlink and sidelink communications in accordance with aspects of the present disclosure.

FIG. 19 shows a diagram of a system including a device that supports a joint type-2 HARQ codebook for downlink and sidelink communications in accordance with aspects of the present disclosure.

FIGS. 20 and 21 show block diagrams of devices that support a joint type-2 HARQ codebook for downlink and sidelink communications in accordance with aspects of the present disclosure.

FIG. 22 shows a block diagram of a communications manager that supports a joint type-2 HARQ codebook for downlink and sidelink communications in accordance with aspects of the present disclosure.

FIG. 23 shows a diagram of a system including a device that supports a joint type-2 HARQ codebook for downlink and sidelink communications in accordance with aspects of the present disclosure.

FIGS. 24 through 28 show flowcharts illustrating methods that support a joint type-2 HARQ codebook for downlink and sidelink communications in accordance with aspects of the present disclosure.

### DETAILED DESCRIPTION

In some wireless communications systems, a user equipment (UE) may receive scheduled downlink transmissions from a base station (e.g., via a physical downlink shared channel (PDSCH)) and scheduling for sidelink transmissions one or more other UEs (e.g., via a physical sidelink shared channel (PSSCH)). In some examples, the downlink and sidelink transmissions may be scheduled in downlink control information received from a base station, and the downlink control information (DCI) may schedule feedback for each of the transmissions (e.g., hybrid automatic repeat request (HARQ) feedback). In some examples, HARQ feedback may be transmitted by the UE on a physical uplink control channel (PUCCH) scheduled via DCI. In some examples, if a HARQ feedback transmission fails, the UE may attempt to repeat the HARQ feedback transmission on a next available PUCCH occasion. The next available PUCCH occasion may be scheduled to transmit HARQ feedback for another downlink or sidelink transmission. For example, if a HARQ feedback transmission for a set of downlink transmissions fails, the UE may attempt to transmit the HARQ feedback transmission for the set of downlink transmissions on the next PUCCH occasion, but the next PUCCH occasion may be scheduled for transmitting HARQ feedback for a set of sidelink transmissions, which may result in a collision. If a collision occurs, a HARQ feedback transmission may be dropped. Currently, there is no configuration for joint HARQ feedback for sidelink transmissions and downlink transmissions.

The present disclosure relates to joint HARQ feedback for sidelink transmissions and downlink transmissions. In some examples, a base station may transmit control signaling to a UE indicating a configuration for a joint HARQ codebook. The UE may transmit a set of sidelink transmissions and receive a set of downlink transmissions, generate a joint HARQ codebook based on a downlink counter (e.g., a counter downlink assignment index (C-DAI)) for the downlink transmissions and a sidelink counter (e.g., a counter sidelink assignment index (C-SAI)) for the sidelink transmissions, where the downlink counter and the sidelink counter are jointly summed, and transmit a feedback message to the base station for the downlink transmissions and the sidelink transmissions based on the joint HARQ codebook. In some examples, the UE may use and generate the joint HARQ codebook based on either a scheduled sidelink HARQ report or a scheduled downlink HARQ report failing. In some examples, the later received DCI scheduling either the sidelink transmissions or the downlink transmissions may indicate to use and generate the joint HARQ codebook based on either a scheduled sidelink HARQ report or a scheduled downlink HARQ report failing. In some examples, the downlink transmissions and sidelink transmissions may be associated with either the same or different HARQ group indices.

In some examples, the base station may transmit DCI indicating a feedback report format for HARQ feedback for at least one set of sidelink transmissions and at least one set of downlink transmissions, and the UE may transmit a feedback report based on the indicated feedback report format. The formats may include, for example, transmitting HARQ feedback for a scheduled set of sidelink transmissions; transmitting HARQ feedback for a scheduled set of downlink transmissions; transmitting HARQ feedback for a scheduled set of sidelink transmissions having a first HARQ group index and an unscheduled set of sidelink transmissions having a different HARQ group index; transmitting HARQ feedback for a scheduled set of downlink transmissions having a first HARQ group index and an unscheduled set of downlink transmissions having a different HARQ group index; transmitting HARQ feedback for a scheduled set of sidelink transmissions and an unscheduled (e.g., not scheduled by the DCI indicating the feedback report format) set of downlink transmissions (where the set of sidelink transmissions and the set of downlink transmissions may be associated with the same or different HARQ group indices); transmitting HARQ feedback for a scheduled set of downlink transmissions and an unscheduled set of sidelink transmissions (where the set of sidelink transmissions and the set of downlink transmissions may be associated with the same or different HARQ group indices); transmitting HARQ feedback for a scheduled set of sidelink transmissions, an unscheduled set of downlink transmissions (where the set of sidelink transmissions and the set of downlink transmissions may be associated with the same or different HARQ group indices), and a set of unscheduled sidelink transmissions having a different HARQ group index; transmitting HARQ feedback for a scheduled set of downlink transmissions, an unscheduled set of sidelink transmissions (where the set of sidelink transmissions and the set of downlink transmissions may be associated with the same or different HARQ group indices), and a set of unscheduled downlink transmissions having a different HARQ group index; transmitting HARQ feedback for a scheduled set of sidelink transmissions having a first HARQ group index, an unscheduled set of downlink transmissions having the same HARQ group index and an unscheduled set of downlink transmissions having a different HARQ group index; transmitting HARQ feedback for a scheduled set of downlink transmissions having a first HARQ group index, an unscheduled set of sidelink transmissions having the same HARQ group index and an unscheduled set of sidelink transmissions having a different HARQ group index; transmitting HARQ feedback for a scheduled set of sidelink transmissions having a first HARQ group index, a set of unscheduled downlink transmissions having the same group index, a set of unscheduled downlink transmissions having a different HARQ group index, and an unscheduled set of sidelink transmissions having a different HARQ group index; and transmitting HARQ feedback for a scheduled set of downlink transmissions having a first HARQ group index, a set of unscheduled sidelink transmissions having the same group index, a set of unscheduled sidelink transmissions having a different HARQ group index, and an unscheduled set of downlink transmissions having a different HARQ group index.

Aspects of the disclosure are initially described in the context of wireless communications systems. Aspects of the disclosure are further illustrated by and described with reference to wireless communication systems, timing diagrams, and process flows. Aspects of the disclosure are further illustrated by and described with reference to apparatus diagrams, system diagrams, and flowcharts that relate to joint type-2 HARQ codebooks for downlink and sidelink communications.

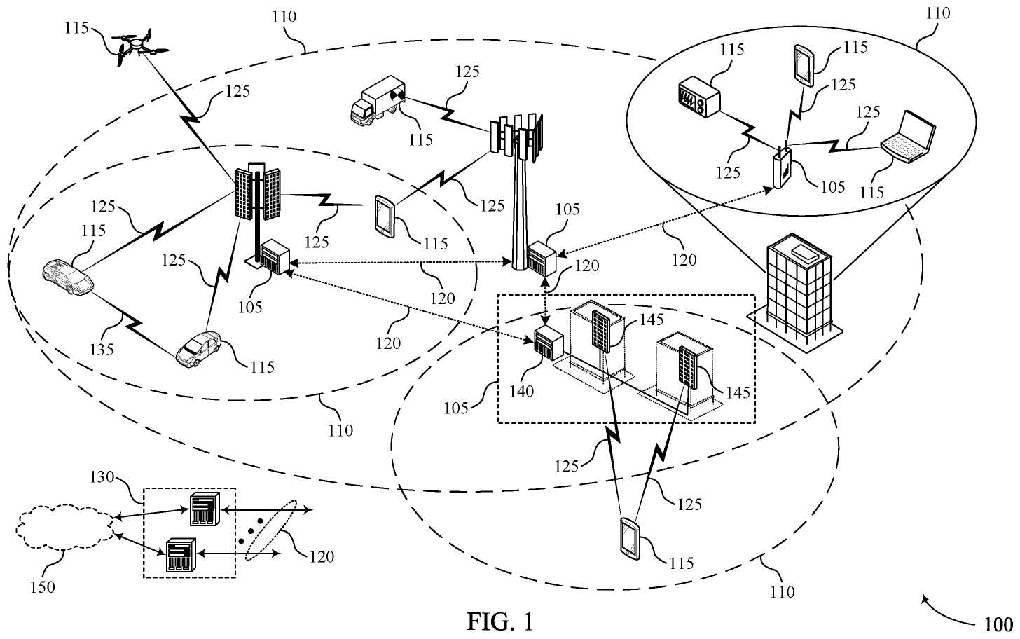

FIG. 1 illustrates an example of a wireless communications system 100 that supports a joint type-2 HARQ codebook for downlink and sidelink communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may receive scheduled downlink transmissions from a base station 105 (e.g., via the PDSCH) and scheduling for sidelink transmissions one or more other UEs 115 (e.g., via a PSSCH). In some examples, the downlink and sidelink transmissions may be scheduled in downlink control information received from a base station 105, and the DCI may schedule feedback for each of the transmissions (e.g., HARQ feedback). In some examples, HARQ feedback may be transmitted by the UE 115 on a PUCCH scheduled via DCI. In some examples, if a HARQ feedback transmission fails, the UE 115 may attempt to repeat the HARQ feedback transmission on a next available PUCCH occasion. The next available PUCCH occasion may be scheduled to transmit HARQ feedback for another downlink or sidelink transmission. For example, if a HARQ feedback transmission for a set of downlink transmissions fails, the UE 115 may attempt to transmit the HARQ feedback transmission for the set of downlink transmissions on the next PUCCH occasion, but the next PUCCH occasion may be scheduled for transmitting HARQ feedback for a set of sidelink transmissions, which may result in a collision. In some examples, if a collision occurs, a HARQ feedback transmission may be dropped.

In some examples, a base station 105 may transmit control signaling to a UE 115 indicating a configuration for a joint HARQ codebook. The UE 115 may transmit a set of sidelink transmissions and receive a set of downlink transmissions, generate a joint HARQ codebook based on a downlink counter (e.g., a C-DAI) for the downlink transmissions and a sidelink counter (e.g., a C-SAI) for the sidelink transmissions, where the downlink counter and the sidelink counter are jointly summed, and transmit a feedback message to the base station 105 for the downlink transmissions and the sidelink transmissions based on the joint HARQ codebook. In some examples, the UE 115 may use and generate the joint HARQ codebook based on either a scheduled sidelink HARQ report or a scheduled downlink HARQ report failing. In some examples, the later received DCI scheduling either the sidelink transmissions or the downlink transmissions may indicate to use and generate the joint HARQ codebook based on either a scheduled sidelink HARQ report or a scheduled downlink HARQ report failing. In some examples, the downlink transmissions and sidelink transmissions may be associated with either the same or different HARQ group indices.

In some examples, the base station 105 may transmit DCI indicating a feedback report format for HARQ feedback for at least one set of sidelink transmissions and at least one set of downlink transmissions, and the UE 115 may transmit a feedback report based on the indicated feedback report format. The formats may include, for example, transmitting HARQ feedback for a scheduled set of sidelink transmissions; transmitting HARQ feedback for a scheduled set of downlink transmissions; transmitting HARQ-ACK feedback for a scheduled set of sidelink transmissions having a first HARQ group index and an unscheduled set of sidelink transmissions having a different HARQ group index; transmitting HARQ-ACK feedback for a scheduled set of downlink transmissions having a first HARQ group index and an unscheduled set of downlink transmissions having a different HARQ group index; transmitting HARQ feedback for a scheduled set of sidelink transmissions and an unscheduled (e.g., not scheduled by the DCI indicating the feedback report format) set of downlink transmissions (where the set of sidelink transmissions and the set of downlink transmissions may be associated with the same or different HARQ group indices); transmitting HARQ feedback for a scheduled set of downlink transmissions and an unscheduled set of sidelink transmissions (where the set of sidelink transmissions and the set of downlink transmissions may be associated with the same or different HARQ group indices); transmitting HARQ feedback for a scheduled set of sidelink transmissions, an unscheduled set of downlink transmissions (where the set of sidelink transmissions and the set of downlink transmissions may be associated with the same or different HARQ group indices), and a set of unscheduled sidelink transmissions having a different HARQ group index; transmitting HARQ feedback for a scheduled set of downlink transmissions, an unscheduled set of sidelink transmissions (where the set of sidelink transmissions and the set of downlink transmissions may be associated with the same or different HARQ group indices), and a set of unscheduled downlink transmissions having a different HARQ group index; transmitting HARQ feedback for a scheduled set of sidelink transmissions having a first HARQ group index, an unscheduled set of downlink transmissions having the same HARQ group index and an unscheduled set of downlink transmissions having a different HARQ group index; transmitting HARQ feedback for a scheduled set of downlink transmissions having a first HARQ group index, an unscheduled set of sidelink transmissions having the same HARQ group index and an unscheduled set of sidelink transmissions having a different HARQ group index; transmitting HARQ feedback for a scheduled set of sidelink transmissions having a first HARQ group index, a set of unscheduled downlink transmissions having the same group index, a set of unscheduled downlink transmissions having a different HARQ group index, and an unscheduled set of sidelink transmissions having a different HARQ group index; and transmitting HARQ feedback for a scheduled set of downlink transmissions having a first HARQ group index, a set of unscheduled sidelink transmissions having the same group index, a set of unscheduled sidelink transmissions having a different HARQ group index, and an unscheduled set of downlink transmissions having a different HARQ group index.

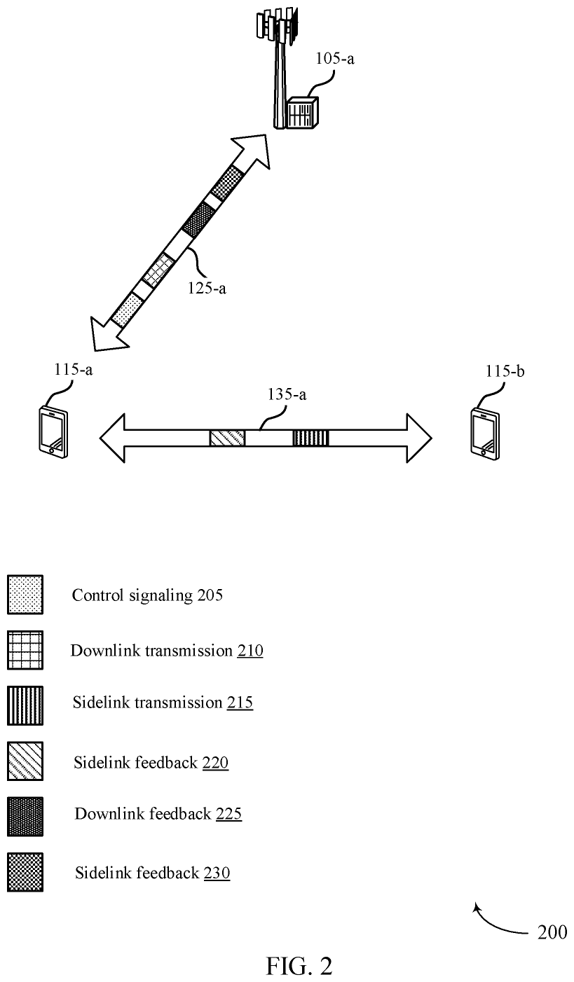

FIG. 2 illustrates an example of a wireless communication system 200 that supports a joint type-2 HARQ codebook for downlink and sidelink communications in accordance with aspects of the present disclosure. The wireless communications system 200 may include UEs 115-a and 115-b, which may be examples of UEs 115 as described herein. The wireless communications system 200 may include a base stations 105-a, which may be an example of a base station 105 as described herein.

The first UE 115-a may communicate with the base station 105-a using a communication link 125-a, which may be an example of an NR or LTE link between the first UE 115-a and the base station 105-a. The communication link 125-a may include a bi-directional link that enables both uplink and downlink communication. For example, the first UE 115-a may transmit uplink signals, such as uplink control signals or uplink data signals, to the base station 105-a using the communication link 125-a and the base station 105-a may transmit downlink signals, such as downlink control signals or downlink data signals, to the first UE 115-a using the communication link 125-a. In some examples, the base station 105-a may communicate with the UE 115-a over the communication link 125-a using directional communications techniques (e.g., beamforming techniques). For example, the base station 105-a may communicate with the UE 115-a via one or more beams. The base station 105-a may schedule downlink transmissions via a DCI message (e.g., DCI format 1_1). The DCI format 1_1 message may also schedule HARQ feedback for the downlink transmissions.

The first UE 115-a may communicate with the second UE 115-b using a sidelink communication link 135-a. The sidelink communication link 135-a may include a bi-directional link that enable the UE 115-a to transmit signals to and receive signals from the UE 115-b. In some examples, the base station 105-a may configure resources for the sidelink communication link 135-a. In some examples, the UE 115-a may communicate with the UE 115-b over the sidelink communication link 135-a using directional communications techniques (e.g., beamforming techniques). For example, the UE 115-a may communicate with the UE 115-b via one or more beams.

In some wireless communications systems, such as wireless communications system 200, the UEs 115 may communicate in sidelink mode 1. In sidelink mode 1, sidelink transmissions between the UEs 115 may be scheduled by a base station 105-a. The UE 115-a, may receive a DCI message (e.g., DCI format 3_0) which schedules sidelink transmissions. The DCI format 3_0 message may also schedule HARQ feedback for the scheduled sidelink transmissions.

The UE 115-a may receive control signaling 205 from the base station 105-a scheduling downlink transmissions 210 (e.g., via PDSCH) and sidelink transmissions 215 (e.g., via PSSCH) for transmission to the UE 115-b. The control signaling 205 may include a DCI format 1_1 message and a DCI format 3_0 message. The control signaling 205 including scheduling information for the downlink transmissions 210 and sidelink transmissions 215 may schedule feedback for each of the transmissions (e.g., HARQ feedback). The UE 115-a may receive downlink transmissions 210 and transmit sidelink transmissions 215 according to the scheduling information in the control signaling 205. In some examples, the UE 115-a may receive feedback 220 (e.g., HARQ feedback) from the UE 115-b indicating whether the sidelink transmissions 215 were successfully received at the UE 115-b. For example, the UE 115-a may receive a physical sidelink feedback channel (PSFCH) from the UE 115-b indicating whether the sidelink transmissions were successfully received at the UE 115-b.

In some examples, the UE 115-a may transmit downlink feedback 225 for the downlink transmissions 210 and sidelink feedback 230 for the sidelink transmissions 215 on a PUCCH scheduled via the control signaling 205 (e.g., via the respective DCI). In some examples, if a HARQ feedback transmission (e.g., downlink feedback 225 or sidelink feedback 230) fails, the UE 115-a may attempt to repeat the HARQ feedback transmission on a next available PUCCH occasion. The next available PUCCH occasion may be scheduled to transmit HARQ feedback for the other of the downlink transmissions 210 or the sidelink transmissions 215. For example, if a HARQ feedback transmission 225 for the set of downlink transmissions 210 fails, the UE 115-a may attempt to transmit the HARQ feedback transmission 225 for the set of downlink transmissions 210 on the next PUCCH occasion, but the next PUCCH occasion may be scheduled for transmitting HARQ feedback 230 for the set of sidelink transmissions 215, which may result in a collision. In some examples, if a collision occurs, a HARQ feedback transmission may be dropped.

In some examples, the base station 105-a may transmit control signaling 205 to a UE 115 indicating a configuration for a joint HARQ codebook. The UE 115 may transmit a set of sidelink transmissions 215 and receive a set of downlink transmissions 210, generate a joint HARQ codebook based on a downlink counter (e.g., a C-DAI) for the downlink transmissions 210 and a sidelink counter (e.g., C-SAI) for the sidelink transmissions 215, where the downlink counter and the sidelink counter are jointly summed, and transmit a feedback message to the base station 105 for the downlink transmissions 210 and the sidelink transmissions 215 based on the joint HARQ codebook. For example, the downlink feedback message 225 or the sidelink feedback message 230 may be a joint feedback message. In some examples, the UE 115-a may use and generate the joint HARQ codebook based on either a scheduled sidelink HARQ report 230 or a scheduled downlink HARQ report 225 failing. In some examples, the later received DCI scheduling either the sidelink transmissions 215 or the downlink transmissions 210 may indicate to use and generate the joint HARQ codebook based on either a scheduled sidelink HARQ report 230 or a scheduled downlink HARQ report failing 225. In some examples, the downlink transmissions 210 and sidelink transmissions 215 may be associated with either the same or different HARQ group indices.

In some examples, the base station 105 may transmit DCI (e.g., in the control signaling 205) indicating a feedback report format for HARQ feedback for at least one set of sidelink transmissions 215 and at least one set of downlink transmissions 210, and the UE 115-a may transmit a feedback report (e.g., the downlink feedback message 225 or the sidelink feedback message 230) based on the indicated feedback report format. The formats may include, for example, transmitting HARQ feedback for a scheduled set of sidelink transmissions 215; transmitting HARQ feedback for a scheduled set of downlink transmissions 210; transmitting HARQ-ACK feedback for a scheduled set of sidelink transmissions 215 having a first HARQ group index and an unscheduled set of sidelink transmissions 215 having a different HARQ group index; transmitting HARQ-ACK feedback for a scheduled set of downlink transmissions 210 having a first HARQ group index and an unscheduled set of downlink transmissions 210 having a different HARQ group index; transmitting HARQ feedback for a scheduled set of sidelink transmissions 215 and an unscheduled (e.g., not scheduled by the DCI indicating the feedback report format) set of downlink transmissions 210 (where the set of sidelink transmissions 215 and the set of downlink transmissions 210 may be associated with the same or different HARQ group indices); transmitting HARQ feedback for a scheduled set of downlink transmissions 210 and an unscheduled set of sidelink transmissions 215 (where the set of sidelink transmissions 215 and the set of downlink transmissions 210 may be associated with the same or different HARQ group indices); transmitting HARQ feedback for a scheduled set of sidelink transmissions 215, an unscheduled set of downlink transmissions 210 (where the set of sidelink transmissions 215 and the set of downlink transmissions 210 may be associated with the same or different HARQ group indices), and a set of unscheduled sidelink transmissions 215 having a different HARQ group index; transmitting HARQ feedback for a scheduled set of downlink transmissions 210, an unscheduled set of sidelink transmissions 215 (where the set of sidelink transmissions 215 and the set of downlink transmissions 210 may be associated with the same or different HARQ group indices), and a set of unscheduled downlink transmissions 210 having a different HARQ group index; transmitting HARQ feedback for a scheduled set of sidelink transmissions 215 having a first HARQ group index, an unscheduled set of downlink transmissions 210 having the same HARQ group index and an unscheduled set of downlink transmissions 210 having a different HARQ group index; transmitting HARQ feedback for a scheduled set of downlink transmissions 210 having a first HARQ group index, an unscheduled set of sidelink transmissions 215 having the same HARQ group index and an unscheduled set of sidelink transmissions 215 having a different HARQ group index; transmitting HARQ feedback for a scheduled set of sidelink transmissions 215 having a first HARQ group index, a set of unscheduled downlink transmissions 210 having the same group index, a set of unscheduled downlink transmissions 210 having a different HARQ group index, and an unscheduled set of sidelink transmissions 215 having a different HARQ group index; and transmitting HARQ feedback for a scheduled set of downlink transmissions 210 having a first HARQ group index, a set of unscheduled sidelink transmissions 215 having the same group index, a set of unscheduled sidelink transmissions 215 having a different HARQ group index, and an unscheduled set of downlink transmissions 210 having a different HARQ group index.

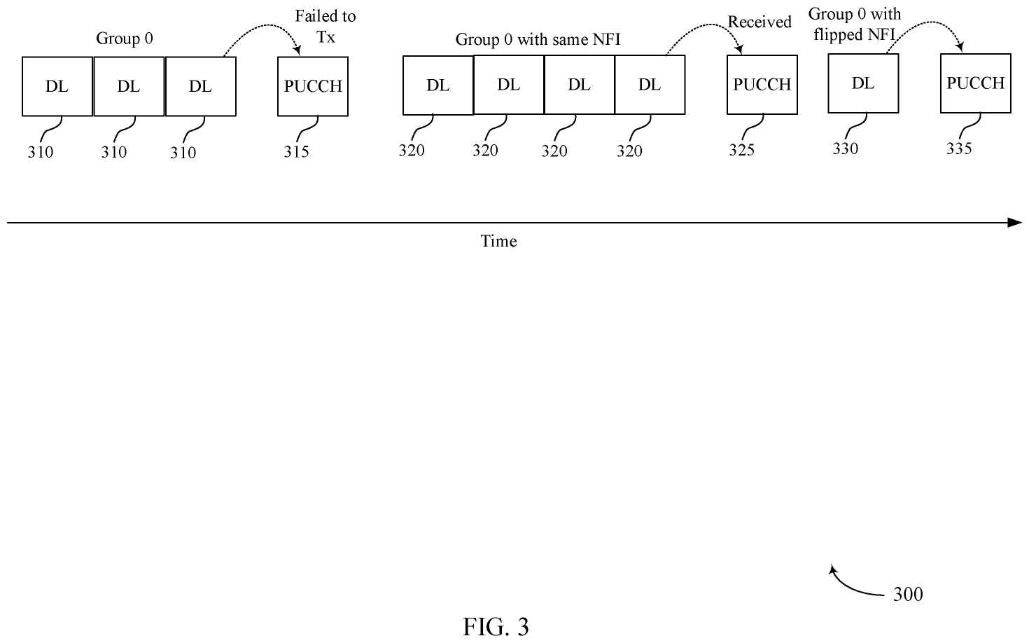

FIG. 3 illustrates an example of a timing diagram 300 that supports a joint type-2 HARQ codebook for downlink and sidelink communications in accordance with aspects of the present disclosure. In some examples, the timing diagram 300 may be implemented by or may implement aspects of the wireless communications system 100 or 200.

In some communications systems, HARQ feedback may be retransmitted for a group of downlink transmissions (e.g., PDSCHs) if the HARQ feedback transmission fails for the group of downlink transmissions. For example, a UE 115 may transmit a HARQ feedback message for the group of downlink transmissions 310 at a PUCCH occasion 315. The group of downlink transmissions 310 may have a group index of 0 and a given new feedback indicator (NFI) value. Each downlink group may be associated with an NFI, which may operate as a toggle bit similar to a new data indicator. If the feedback message transmitted over the PUCCH occasion 315 fails (e.g., fails to transmit), the UE 115 may be configured to transmit the feedback (e.g., the HARQ acknowledgment (ACK) and negative acknowledgment (NACK)) for the group of downlink transmissions 310 along with the feedback for a second group of downlink transmissions 320 at a second PUCCH occasion 325. The size of a group may increase when more downlink transmissions of the same group are granted until the NFI for the group flips. In some examples, the size of the group may increase after HARQ feedback for the group is transmitted. The second group of downlink transmissions may be associated with a same group index of 0 and a same NFI. Accordingly, the feedback transmitted at the PUCCH occasion 325 may include a HARQ ACK/NACK for the seven downlink transmissions 310 and 320. Total downlink assignment index (T-DAI) and C-DAI may be associated with a group and may count upwards until an NFI flips.

For example, if the feedback transmitted at the PUCCH occasion 325 is successfully received by the base station 105, the NFI may flip and the downlink transmission 330 may be associated with a flipped NFI. The UE 115 may transmit feedback for the downlink transmission 330 in a PUCCH occasion 335, which may include HARQ ACK/NACK information for the downlink transmission 330.

As described herein, downlink transmissions may be scheduled by DCI format 1_1. In DCI format 1_1, one bit may trigger HARQ ACK/NACK, where a “0” indicates triggering for the scheduled group, and a “1” indicates triggering for the scheduled group and an unscheduled group (e.g., a group of downlink transmissions not scheduled by the DCI triggering the HARQ-ACK). In some examples, when HARQ ACK/NACK for both downlink transmission groups is triggered, the placement of HARQ ACK/NACK feedback for the two groups may be ordered based on an increasing group index. For the scheduled group, the T-DAI and C-DAI may be included and the NFI may be included. In some examples, C-DAI and T-DAI may be accumulated within a PDSCH group until the NFI for the PDSCH is toggled. The C-DAI and the T-DAI may be reset when the NFI is toggled. The C-DAI and the T-DAI may not be reset by PUCCH transmission occasions.

In some examples, RRC may configure whether NFI and T-DAI (which may include 2 bits) for a non-scheduled group are included. RRC configuring whether NFI and T-DAI (which may include 2 bits) for a non-scheduled group are included may protect against some error cases if present. Table 1 below indicates triggering information within DCI format 1_1 for HARQ ACK/NACK feedback.

TABLE 1

| | Number of bits | Number of bit for | |
|---|---|---|---|
| | for scheduled | non-scheduled | |
| Field | group | group | Notes |
| Trigger | 1 | | 0: Only report scheduled |
| | | | group |
| | | | 1: Also report the non- |
| | | | scheduled group |
| NFI | 1 | 1 | The field for non- |
| | | | scheduled group is |
| | | | configurable |
| T-DAI | 2 | 2 | The field for non- |
| | | | scheduled group is |
| | | | configurable |

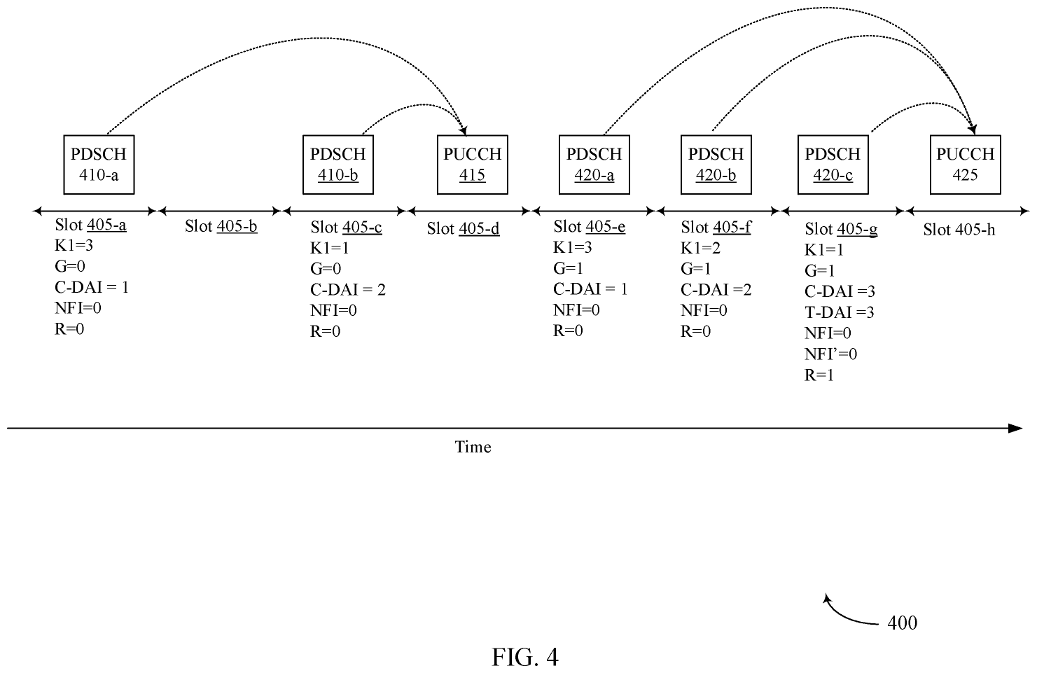

FIG. 4 illustrates an example of a timing diagram 400 that supports a joint type-2 HARQ codebook for downlink and sidelink communications in accordance with aspects of the present disclosure. In some examples, the timing diagram 400 may be implemented by or may implement aspects of the wireless communications system 100 or 200.

In some examples, in sidelink communications, a transmitting UE 115 may send HARQ ACK/NACK for sidelink communications to the base station 105. The base station 105 may transmit a DCI format 3_0 to the UE 115 to schedule a sidelink transmission and indicate a HARQ ACK/NACK reporting timing and a physical resource indicator (PRI). The HARQ ACK/NACK may depend on the PSFCH the transmitting UE 115 received from the receiving UE 115. In some examples, the base station 105 may configure a Type 1 sidelink configured grant (CG), and the RRC parameter sl-ACKToUL-ACK may indicate the HARQ ACK/NACK timing. In some examples, the base station 105 may configure Type 2 sidelink CG, and the activation DCI 3_0 can provide HARQ ACK/NACK reporting timing and PRI. HARQ ACK/NACK may be multiplexed into a codebook and reported in a PUCCH or a physical uplink shared channel (PUSCH).

In some examples, HARQ ACK/NACK may be retransmitted for a group of sidelink transmissions (e.g., PSSCHs) if the HARQ ACK/NACK transmission fails for the group of sidelink transmissions, similarly to the retransmissions for failed HARQ ACK/NACK for downlink transmissions as described with reference to FIG. 3.

As shown in FIGS. 4-13, G refers to a group index, R refers to a number of requested groups, C-DAI refers to a counter downlink assignment index (DAI), T-DAI refers to a total DAI for a scheduled group, T′-DAI refers to a total DAI for a non-scheduled group, C-SAI refers to a counter sidelink assignment index (SAI), T-SAI refers to a total SAI for the scheduled group, T′-SAI refers to a total SAI for a non-scheduled group, NFI refers to a new feedback indicator for the scheduled group, NFI′ refers to a new feedback indicator for the unscheduled group, NSFI refers to a new sidelink feedback indicator for the scheduled group, NSFI′ refers to a new sidelink feedback indicator for the unscheduled group, K1 refers to the timing (e.g., number of slots) from the PSSCH to the PUCCH, and sl-K1 refers to the timing (e.g., number of slots) from the PSFCH to the PUCCH.

As described herein, an enhanced dynamic HARQ ACK/NACK codebook may be supported to allow retransmission of failed HARQ ACK/NACK (e.g., failed to transmit due to listen before talk failure).

In the timing diagram 400, the HARQ ACK/NACK at PUCCH 415 within slot 405-d for PDSCH 410-a within slot 405-a and PDSCH 410-b within slot 405-c may fail. PDSCH 410-a and PDSCH 410-b may be associated with a first group (e.g., group index equal to 0). A second PUCCH 425 in slot 405-h may be used to transmit the HARQ ACK/NACK for PDSCH 410-a, PDSCH 410-b, PDSCH 420-a within slot 405-e, PDSCH 420-b within slot 405-f, and PDSCH 420-c within slot 405-g. PDSCH 420-a, PDSCH 420-b, and PDSCH 420-c may be associated with a second group (group index equal to 1). An example of the order of the HARQ ACK/NACK feedback transmitted at PUCCH occasion 425 is shown below in table 2.

TABLE 2

| PDSCH | PDSCH | PDSCH | PDSCH | PDSCH |
|---|---|---|---|---|
| 410-a | 410-b | 420-a | 420-b | 420-c |
| C-DAI = 1 | C-DAI = 2 | C-DAI = 1 | C-DAI = 2 | C-DAI = 3 |
| G = 0 | G = 0 | G = 1 | G = 1 | G = 1 |
| ACK/NACK | ACK/NACK | ACK/NACK | ACK/NACK | ACK/NACK |

In an enhanced dynamic HARQ ACK/NACK codebook, if a single PSSCH group is supported, a new sidelink feedback indicator (NSFI) may be indicated in DCI format 3_0. If two PSSCH groups are supported, DCI format 3_0 may indicate a group index associated with each PSSCH group. In DCI format 30, one bit may be used for triggering HARQ ACK/NACK feedback, where a “0” schedules HARQ ACK/NACK for the scheduled group only and a “1” schedules HARQ ACK/NACK feedback for the scheduled group and the unscheduled group. Total SAI (T-SAI) may be included in DCI format 3_0 (e.g., when sidelink carrier aggregation is configured).

A NSFI for each group may be included in DCI format 3_0. For non-scheduled groups, the NSFI may be configurable. A T-SAI may be included for each group, where the T-SAI may be configurable for a non-scheduled group. T-SAI and C-SAI may be counted per group until the NSFI flips.

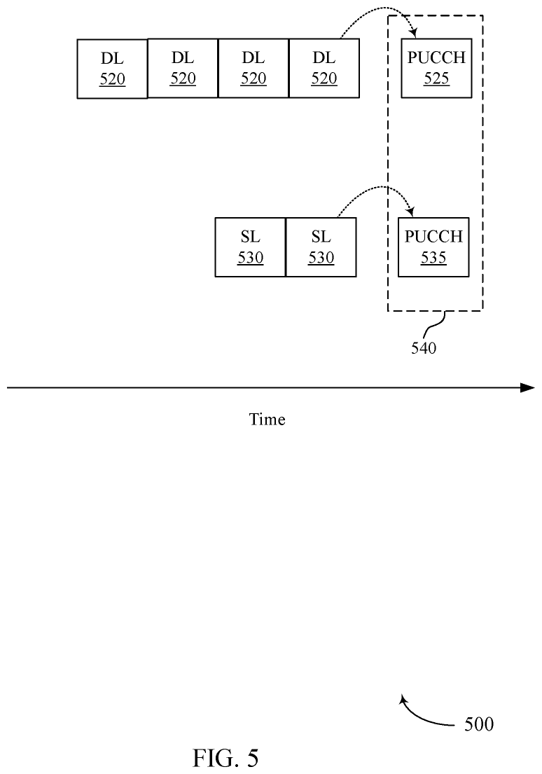

FIG. 5 illustrates an example of a timing diagram 500 that supports a joint type-2 HARQ codebook for downlink and sidelink communications in accordance with aspects of the present disclosure. In some examples, the timing diagram 500 may be implemented by or may implement aspects of the wireless communications system 100 or 200.

As described herein, in some examples, if the UE 115 is indicated to transmit the HARQ-ACK feedback information for a set of downlink transmission in a PUCCH occasion 525 in a slot 540 and transmit the HARQ-ACK feedback information for a set of sidelink transmission in another PUCCH occasion 535 in the same slot, and PUCCH occasion 525 is overlapped with PUCCH occasion 535 in time domain, one PUCCH occasion may be dropped.

For example, a set of downlink transmissions 520 may be scheduled for HARQ ACK/NACK feedback at PUCCH occasion 525 in a slot 540, and a set of sidelink transmissions 530 may be scheduled for HARQ ACK/NACK feedback at PUCCH occasion 535 in a slot 540, which may result in a collision.

In some examples, the PUCCH 525 or the PUCCH 535 with a higher priority may be transmitted. For example, if a PUCCH with a priority of 1 (e.g., for URLLC) is to be transmitted, if the parameter sl-PriorityThresholdULURLLC is provided, the UE 115 may transmit the PUCCH 535 carrying the sidelink HARQ ACK/NACK if the priority value of the HARQ ACK/NACK is smaller than the provided sl-PriorityThresholdULURLLC, otherwise the UE 115 may transmit the PUCCH 525 carrying the downlink HARQ ACK/NACK. In some examples, sl-PriorityThresholdULURLLC may not be provided (e.g., by default the PUCCH 525 carrying the downlink HARQ ACK/NACK may have a higher priority than the PUCCH 535 carrying the sidelink HARQ ACK/NACK), and the UE 115 may transmit the PUCCH 525 carrying the downlink HARQ ACK/NACK.

In some examples, the PUCCH 525 carrying the downlink HARQ ACK/NACK may have a priority 0 (e.g., for eMBB). If the parameter sl-PriorityThreshold is provided, the UE 115 may transmit the PUCCH 535 carrying the sidelink HARQ ACK/NACK if the priority value for the PUCCH 535 is smaller than the value provided by sl-PriorityThreshold, otherwise the UE 115 may transmit the PUCCH 525 carrying the downlink HARQ ACK/NACK.

Prioritization between the PUCCH 525 (e.g., for URLLC or eMBB) and the PUCCH 535 may be configured via RRC.

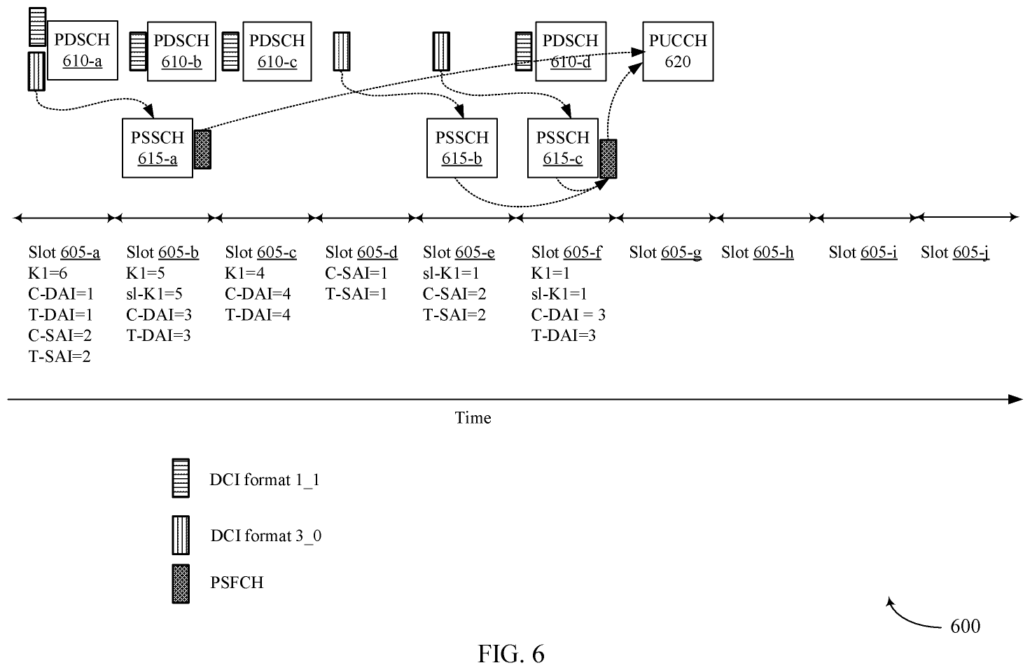

FIG. 6 illustrates an example of a timing diagram 600 that supports a joint type-2 HARQ codebook for downlink and sidelink communications in accordance with aspects of the present disclosure. In some examples, the timing diagram 600 may be implemented by or may implement aspects of the wireless communications system 100 or 200.

To resolve collisions between a PUCCH used to transmit HARQ ACK/NACK for sidelink and a PUCCH used to transmit HARQ ACK/NACK for downlink, a joint HARQ codebook for sidelink and downlink transmissions may be configured. In some examples, the joint HARQ codebook may be configured by an RRC parameter. In some examples, the C-DAI and C-SAI may be counted jointly for the joint HARQ codebook. In some examples, the T-DAI and the T-SAI may be counted jointly for the joint HARQ codebook. The value of T-DAI and the T-SAI may count, for the serving base station 105, the physical downlink control channel (PDCCH) monitoring occasions for both downlink and sidelink. The value of T-DAI or T-SAI, when present in a DCI format (e.g., format 1_1 or 3_0) denotes a cumulative number, for the serving base station 105, of downlink transmissions and sidelink transmissions up to a current PDCCH monitoring occasion. For example, T-DAI or T-SAI may indicate, from the UE perspective, a cumulative number of: PSSCH transmissions with associated PSFCH receptions and PDSCH receptions, up to the current PDCCH monitoring occasion m, where 0≤m<M and is updated each PDCCH monitoring occasion.

The PUCCH resource used for reporting a joint HARQ feedback report for sidelink and downlink transmissions may be determined based on the last DCI scheduling a downlink or sidelink transmission reported in the joint HARQ feedback report (e.g., scheduling a sidelink or downlink transmission).

For example, as shown in timing diagram 600, DCI format 1_1 in slot 605-a may schedule a PDSCH 610-a and a DCI format 3_0 in slot 605-a may schedule a PSSCH 615-a in slot 605-b. A DCI format 1_1 in slot 605-b may schedule a PDSCH 610-b, and a DCI format 1_1 in slot 605-c may schedule a PDSCH 610-c. The UE 115 may receive a PSFCH in slot 605-b indicating feedback for the PSSCH 615-a. A DCI format 3_0 in slot 605-d may schedule a PSSCH 615-b in slot 605-e. The UE 115 may receive a PSFCH in slot 605-f indicating feedback for the PSSCH 615-b. A DCI format 3_0 in slot 605-e may schedule a PSSCH 615-c in slot 605-f. The UE 115 may receive a PSFCH in slot 605-f indicating feedback for the PSSCH 615-c. A DCI format 1_1 in slot 605-e may schedule a PDSCH 610-d in slot 605-f. HARQ ACK/NACK feedback for the PDSCH 610-a, the PDSCH 610-b, the PDSCH 610-c, the PDSCH 610-d, the PSSCH 615-a, the PSSCH 615-b, and the PSSCH 615-c may be generated according to the joint HARQ ACK/NACK codebook and transmitted to the base station 105 via the PUCCH 620 in slot 605-g. For example, the ACK/NACK for the PDSCHs and PSSCHs may be ordered according to the values of the C-DAI and C-SAI as shown in Table 3 below.

TABLE 3

| PDSCH | PSSCH | PDSCH | PDSCH | PSSCH | PSSCH | PDSCH |
|---|---|---|---|---|---|---|
| 610-a | 615-a | 610-b | 610-c | 615-b | 615-c | 610-d |
| C-DAI = 1 | C-SAI = 2 | C-DAI = 3 | C-DAI = 4 | C-SAI = 1 | C-SAI = 2 | C-DAI = 3 |
| ACK/NACK | ACK/NACK | ACK/NACK | ACK/NACK | ACK/NACK | ACK/NACK | ACK/NACK |

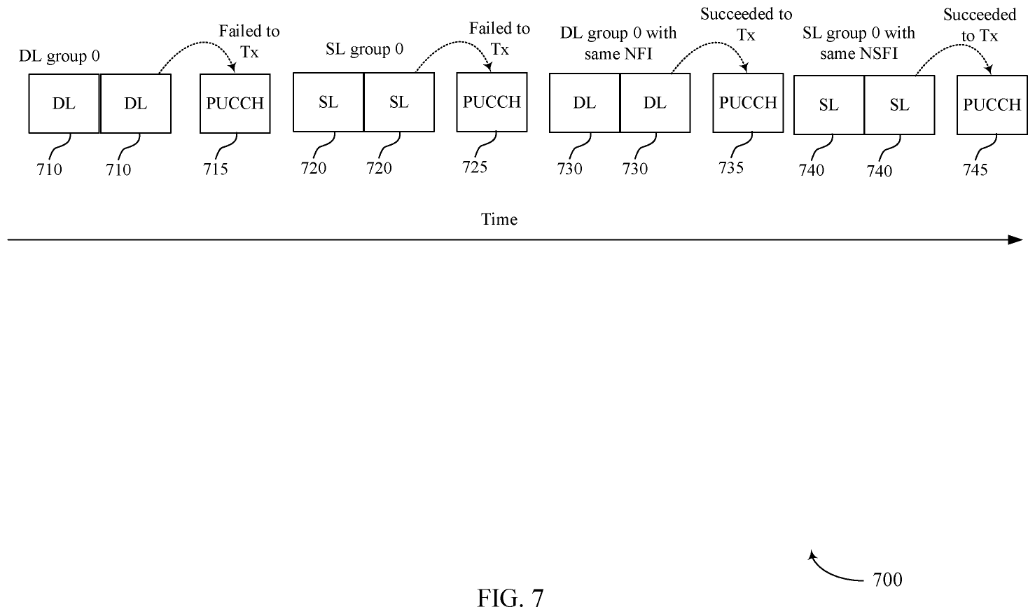

FIG. 7 illustrates an example of a timing diagram 700 that supports a joint type-2 HARQ codebook for downlink and sidelink communications in accordance with aspects of the present disclosure. In some examples, the timing diagram 700 may be implemented by or may implement aspects of the wireless communications system 100 or 200.

In unlicensed frequency bands, some example wireless systems may use separate HARQ ACK/NACK codebooks for sidelink and downlink transmissions. For example, a UE 115 may report HARQ ACK/NACK feedback for a set of downlink transmissions 710 via a PUCCH 715 and a UE 115 may report HARQ ACK/NACK feedback for a set of sidelink transmissions 720 via a PUCCH 725. If the PUCCH 715 and the PUCCH 725 fail (e.g., fail to transmit), the HARQ ACK/NACK feedback for the downlink transmissions 710 may be combined with the HARQ ACK/NACK feedback for subsequent downlink transmissions 730 and reported at PUCCH 735, and the HARQ ACK/NACK feedback for the sidelink transmissions 720 may be combined with the HARQ ACK/NACK feedback for subsequent sidelink transmissions 740 and reported at PUCCH 745. Accordingly, the PUCCH 735 may report 4 HARQ ACK/NACKs for the downlink transmissions 710 and 730 and the PUCCH 745 may report 4 HARQ ACK/NACKs for the sidelink transmissions 720 and 740.

As described herein, in some examples, joint HARQ ACK/NACK feedback may be used for downlink and sidelink transmissions. For example, using a joint HARQ ACK/NACK feedback codebook may support transmitting feedback for the downlink transmissions 710, the sidelink transmissions 720, and the downlink transmissions 730 using the PUCCH 735 (e.g., not waiting to transmit the HARQ ACK/NACK feedback for the sidelink transmissions 720 until the next PUCCH reporting HARQ ACK/NACK feedback for another set of sidelink transmissions).

For example, a RRC parameter may configure a joint enhanced dynamic HARQ ACK/NACK codebook for downlink and sidelink transmissions. In some examples, the one bit in the HARQ ACK/NACK triggering field in DCI format 1_1 or the DCI format 3_0 may be extended to trigger joint HARQ ACK/NACK reporting for both sidelink and downlink transmissions. In some examples, a “0” may indicate to provide HARQ ACK/NACK for the scheduled group (e.g., the downlink and sidelink group with a same group index as indicated in the triggering DCI), and a “1” may indicate to provide HARQ ACK/NACK for the scheduled group and a non-scheduled group. If the scheduled group is a downlink group, then the non-scheduled group includes a downlink group having a different group index than the group index indicated in the triggering DCI, a sidelink group having a same group index as the group index indicated in the triggering DCI and a sidelink group having a different group index than the group index indicated in the triggering DCI. If the scheduled group is a sidelink group, then the non-scheduled group includes a sidelink group having a different group index than the group index indicated in the triggering DCI, a downlink group having a same group index as the group index indicated in the triggering DCI and a downlink group having a different group index than the group index indicated in the triggering DCI.

In some examples, the C-DAI and C-SAI may be count per group and counted jointly for downlink and sidelink transmissions having a same group index for the joint HARQ codebook. For a same PDCCH monitoring occasion, the value of C-DAI and C-SAI may be ordered with C-DAI first and C-SAI second or ordered with C-SAI first and C-DAI second (e.g., similar to as if a sidelink HARQ ACK/NACK is treated as a different downlink interface component carrier in a carrier aggregation case). In some examples, sidelink component carriers may be ordered before or after downlink component carriers in the joint HARQ codebook.

In some examples, the T-DAI and the T-SAI may be counted per group and counted jointly for downlink and sidelink transmissions having a same group index for the joint HARQ codebook. The value of T-DAI and the T-SAI may count, for the serving base station 105, the PDCCH monitoring occasions for both downlink and sidelink. The value of T-DAI or T-SAI, when present in a DCI format (e.g., format 1_1 or 3_0) denotes a cumulative number, for the serving base station 105, of downlink transmissions and sidelink transmissions up to a current PDCCH monitoring occasion. For example, T-DAI or T-SAI may indicate, from the UE perspective, a cumulative number of: PSSCH transmissions with associated PSFCH receptions and PDSCH receptions, up to the current PDCCH monitoring occasion m, where 0≤m<M and is updated in each PDCCH monitoring occasion.

NFI and NSFI may be applied to both downlink and sidelink transmissions. The NFI and NSFI field for the scheduled group may apply to the downlink and sidelink group with the same group index as indicated in the triggering DCI. The NFI and NSFI field for the non-scheduled group may apply to the downlink and sidelink group with a different group index as indicated in the triggering DCL The C-DAI and C-SAI may be reset when either the NH or the NSFI for the corresponding group are flipped. The PUCCH resource used for reporting the joint HARQ ACK/NACK feedback may be determined by the last DCI scheduling a downlink or sidelink transmission reported in the joint HARQ feedback report (e.g., scheduling a sidelink or downlink transmission). Table 4 below indicates triggering information within DC format 1_1 for HARQ ACK/NACK feedback

TABLE 4

| | | # of bit | |
|---|---|---|---|
| | # of bits | for non- | |
| | for scheduled | scheduled | |
| Field | group | group | Notes |
| Trigger | 1 | | 0: report downlink group |
| | | | and sidelink group with |
| | | | the same group index as |
| | | | indicated in downlink DCI |
| | | | 1: report the downlink and |
| | | | sidelink group with the |
| | | | same and different group |
| | | | index as indicated in |
| | | | downlink DCI. |
| NFI | 1 | 1 | The field for non- |
| | | | scheduled group may be |
| | | | configurable and may |
| | | | apply to the downlink and |
| | | | sidelink group other than |
| | | | the scheduled group. |
| T-DAI | 2 | 2 | The field for non- |
| | | | scheduled group may be |
| | | | configurable and may |
| | | | apply to the downlink and |
| | | | sidelink group other than |
| | | | the scheduled group. |

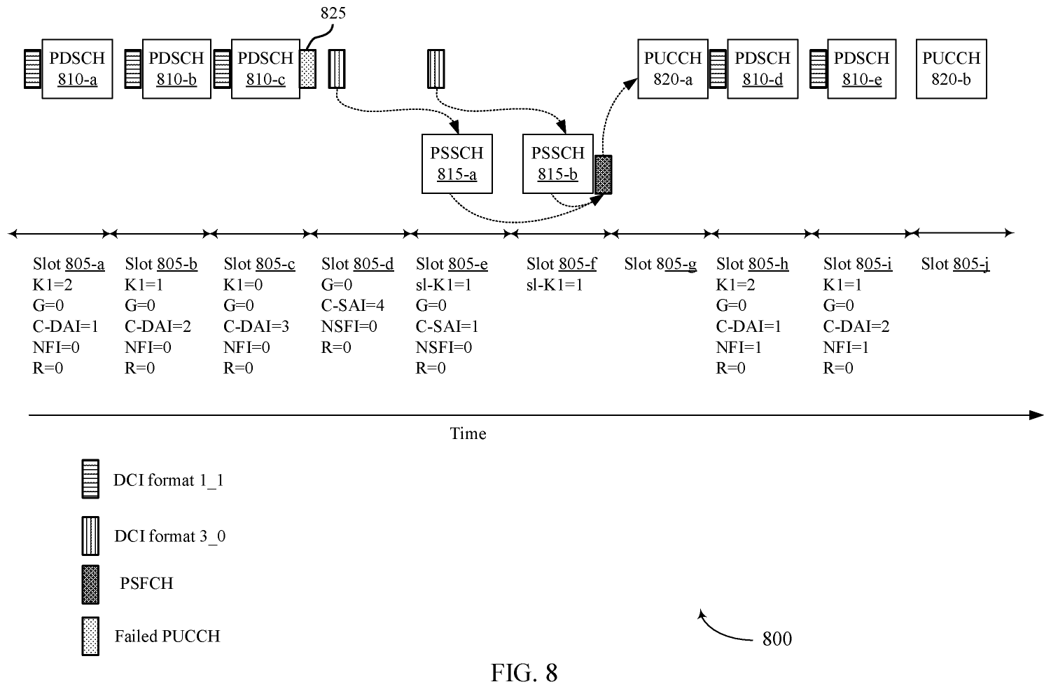

FIG. 8 illustrates an example of a timing diagram 800 that supports a joint type-2 HARQ codebook for downlink and sidelink communications in accordance with aspects of the present disclosure. In some examples, the timing diagram 800 may be implemented by or may implement aspects of the wireless communications system 100 or 200.

As shown in timing diagram 800, a DCI format 1_1 in slot 805-a may schedule a PDSCH 810-a, a DCI format 1_1 in slot 805-b may schedule a PDSCH 810-b, and a DCI format 1_1 in slot 805-c may schedule a PDSCH 810-c. The PDSCH 810-a, the PDSCH 810-b, and the PDSCH 810-c may be associated with a same group index (e.g., group index 0). A PUCCH 825 in slot 805-c with HARQ ACK/NACK feedback for the PDSCH 810-a, the PDSCH 810-b, and the PDSCH 810-c may fail.

A DCI format 3_0 in slot 805-d may schedule a PSSCH 815-a in slot 805-e, and a DCI format 3_0 in slot 805-e may schedule a PSSCH 815-b in slot 805-f. The transmitting UE 115 may receive a PSFCH in slot 805-f from the receiving UE 115 indicating feedback for the PSSCH 815-a and the PSSCH 815-b. The PSSCH 815-a and the PSSCH 815-b may be associated with a same group index (e.g., group index 0) as the PDSCH 810-a, the PDSCH 810-b, and the PDSCH 810-c. In this example, the NSFI indicated by DCI 3_0 in slot 805-d, slot 805-e have a same value as the NFI indicated by DCI 1_1 in slot 805-a, 805-b and 8005-c, i.e., the NSFI is not toggled. Therefore, the UE 115 may transmit HARQ ACK/NACK feedback for the PDSCH 810-a, the PDSCH 810-b, the PDSCH 810-c, PSSCH 815-a, and the PSSCH 815-b using the PUCCH 820-a in slot 805-g.

HARQ ACK/NACK feedback for the PDSCH 810-a, the PDSCH 810-b, the PDSCH 810-c, PSSCH 815-a, and the PSSCH 815-b may be generated according to the joint HARQ ACK/NACK codebook and transmitted to the base station 105 via the PUCCH 820-a. For example, the ACK/NACK for the PDSCHs and PSSCHs may be ordered according to the values of the C-DAI and C-SAI as shown in Table 5 below.

TABLE 5

| PDSCH | PDSCH | PDSCH | PSSCH | PSSCH |
|---|---|---|---|---|
| 810-a | 810-b | 810-c | 815-a | 815-b |
| C-DAI = 1 | C-DAI = 2 | C-DAI = 3 | C-SAI = 4 | C-SAI = 1 |
| ACK/NACK | ACK/NACK | ACK/NACK | ACK/NACK | ACK/NACK |

A DCI format 1_1 in slot 805-h may schedule a PDSCH 810-d and a DCI format 1_1 in slot 805-i may schedule a PDSCH 810-e. The UE 115 may transmit HARQ ACK/NACK feedback for the PDSCH 810-d and the PDSCH 810-e using the PUCCH 820-b in slot 805-j. And the NFI indicated in DCI format 1_1 in slot 805-h has a different value than NSFI indicated in DCI format 3_0 in slot 805-e, (e.g., NFI is toggled). Therefore, the HARQ ACK/NACK feedback for the PDSCH 810-a, the PDSCH 810-b, the PDSCH 810-c, PSSCH 815-a, and the PSSCH 815-b are not transmitted in PUCCH 820-b in slot 805-j. In addition, counter DAI indicated in the DCI format 1_1 in slot 805-h is reset as NFI is toggled. The C-DAIs for the PDSCH 810-a and the PDSCH 810-b may be 1 and 2, respectively.

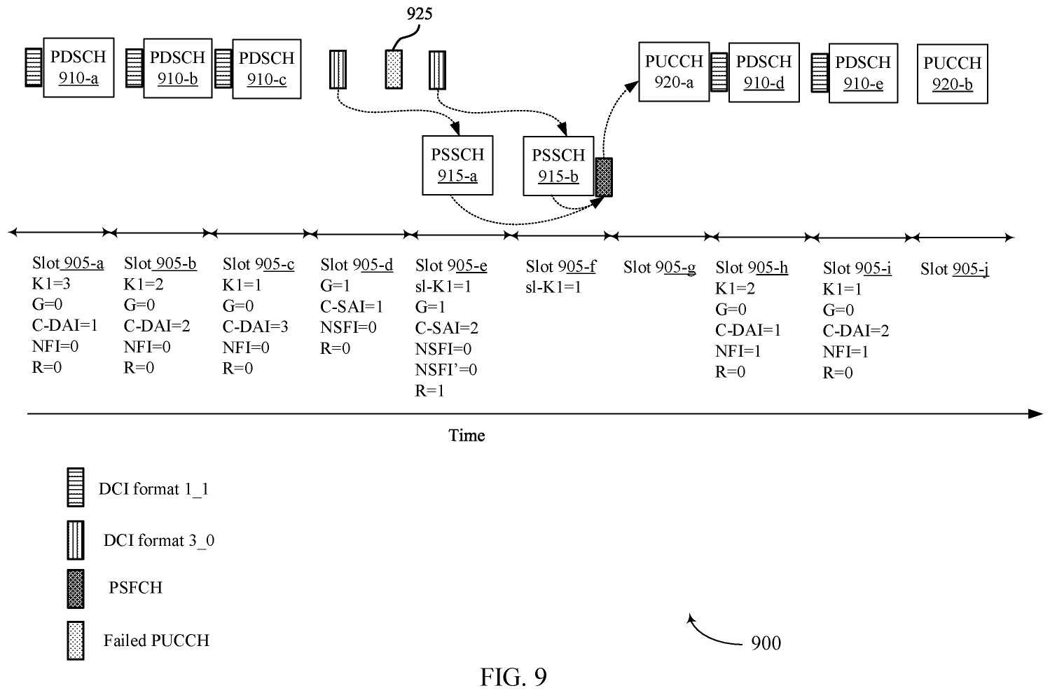

FIG. 9 illustrates an example of a timing diagram 900 that supports a joint type-2 HARQ codebook for downlink and sidelink communications in accordance with aspects of the present disclosure. In some examples, the timing diagram 900 may be implemented by or may implement aspects of the wireless communications system 100 or 200.

As shown in timing diagram 900, a DCI format 1_1 in slot 905-a may schedule a PDSCH 910-a, a DCI format 1_1 in slot 905-b may schedule a PDSCH 910-b, and a DCI format 1_1 in slot 905-c may schedule a PDSCH 910-c. The PDSCH 910-a, the PDSCH 910-b, and the PDSCH 910-c may be associated with a same group index (e.g., group index 0). A PUCCH 925 in slot 905-d with HARQ ACK/NACK feedback for the PDSCH 910-a, the PDSCH 910-b, and the PDSCH 910-c may fail.

A DCI format 3_0 in slot 905-d may schedule a PSSCH 915-a in slot 905-e, and a DCI format 3_0 in slot 905-e may schedule a PSSCH 915-b in slot 905-f. The transmitting UE 115 may receive a PSFCH in slot 905-f from the receiving UE 115 indicating feedback for the PSSCH 915-a and the PSSCH 915-b. The PSSCH 915-a and the PSSCH 915-b may be associated with a different group index (e.g., group index 1) than the PDSCH 910-a, the PDSCH 910-b, and the PDSCH 910-c. In this case, the counter DAI in the DCI format 1_1 in slot 905-a, 905-b and 905-c and the counter SAI in the DCI format 3_0 in slot 905-d and 905-e are counted separately. The counter DAI in the DCI format 1_1 in slot 905-a, 905-b and 905-c may be 1, 2 and 3 respectively. The counter SAI in the DCI format 3_0 in slot 905-d and 905-e may be 1 and 2 respectively. In the last DCI (i.e., DCI format 3_0 in slot 905-e) among the DCI format 1_1 in slot 905-a, 905-b and 905-c and DCI format 3_0 in slot 905-d and 905-e, the HARQ-ACK triggering field R is set to 1, therefore, the UE 115 may transmit HARQ ACK/NACK feedback for the PDSCH 910-a, the PDSCH 910-b, the PDSCH 910-c, PSSCH 915-a, and the PSSCH 915-b using the PUCCH 920-a in slot 905-g.

HARQ ACK/NACK feedback for the PDSCH 910-a, the PDSCH 910-b, the PDSCH 910-c, PSSCH 915-a, and the PSSCH 915-b may be generated according to the joint HARQ ACK/NACK codebook and transmitted to the base station 105 via the PUCCH 920-a. For example, the ACK/NACK for the PDSCHs and PSSCHs may be ordered according to the values of the C-DAI and C-SAI as shown in Table 6 below.

TABLE 6

| PDSCH | PDSCH | PDSCH | PSSCH | PSSCH |
|---|---|---|---|---|
| 910-a | 910-b | 910-c | 915-a | 915-b |
| C-DAI = 1 | C-DAI = 2 | C-DAI = 3 | C-SAI = 1 | C-SAI = 2 |
| ACK/NACK | ACK/NACK | ACK/NACK | ACK/NACK | ACK/NACK |

A DCI format 1_1 in slot 905-h may schedule a PDSCH 910-d and a DCI format 1_1 in slot 905-i may schedule a PDSCH 910-e. The PDSCH 910-d and the PDSCH 910-e may be associated with a group index 0 (which is the same as the group index of PDSCH 910-a, PDSCH 910-b and PDSCH 910-c). However, the NFI indicated in the DCI format 1_1 in slot 905-h and in slot 905-i may indicate a different value as the NFI indicated in the DCI format 1_1 in slot 905-a, slot 905-b and slot 905-c, (e.g., NFI for group 0 is toggled). Therefore, the UE 115 may only transmit HARQ ACK/NACK feedback for the PDSCH 910-d and the PDSCH 910-e using the PUCCH 920-b in slot 905-j and not transmit the HARQ ACK/NACK feedback for the PDSCH 910-a, the PDSCH 910-b and the PDSCH 910-c in the PUCCH 920-b in slot 905-j. In addition, the C-DAIs for the PDSCH 910-d and the PDSCH 910-e may be reset as the NFI is toggled. The C-DAIs for the PDSCH 910-d and the PDSCH 910-e may be 1 and 2, respectively.

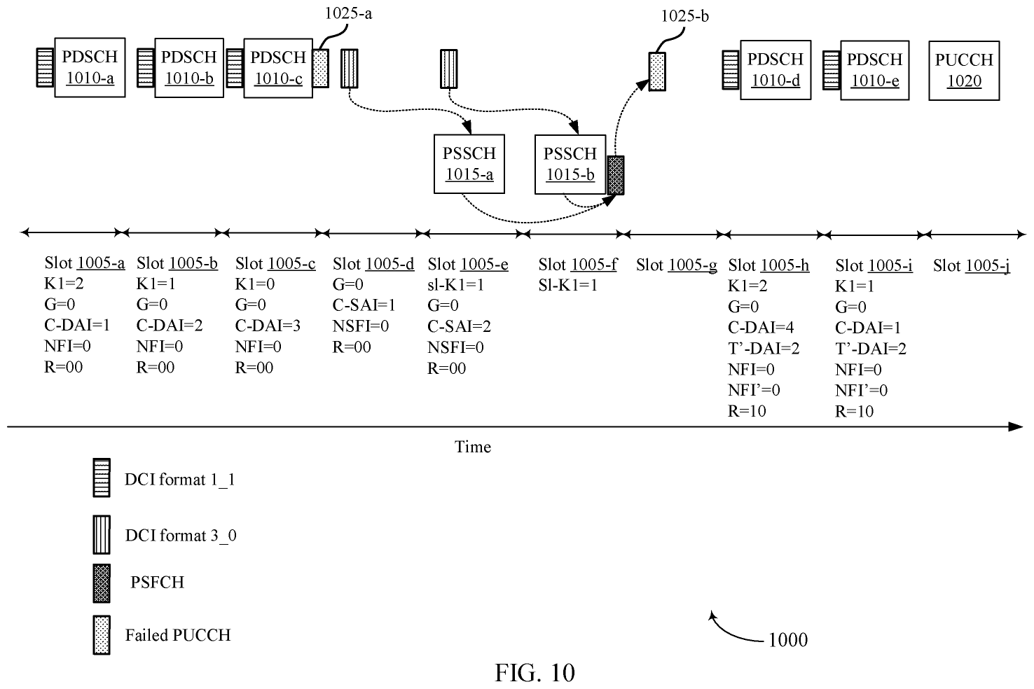

FIG. 10 illustrates an example of a timing diagram 1000 that supports a joint type-2 HARQ codebook for downlink and sidelink communications in accordance with aspects of the present disclosure. In some examples, the timing diagram 1000 may be implemented by or may implement aspects of the wireless communications system 100 or 200.

In some examples, for a joint HARQ ACK/NACK codebook, a crossed HARQ ACK/NACK report between downlink and sidelink transmissions may be triggered by DCI. In some examples, the HARQ ACK/NACK triggering field in DCI format 1_1 or DCI format 3_0 may be used to trigger a crossed HARQ ACK/NACK report between downlink and sidelink transmissions. The number of bits used for the HARQ ACK/NACK triggering field may be predefined or may be configured by an RRC. The number of downlink and sidelink groups may be predefined or configured by RRC according to the following combinations: Case 1) 1 PDSCH group and 1 PSSCH group; Case 2) 2 PDSCH groups and 1 PSSCH group; Case 3) 1 PDSCH group and 2 PSSCH groups; Case 4) 2 PDSCH groups and 2 PSSCH groups.

For case 1, HARQ ACK/NACK triggering field in DCI format 1_1 may indicate whether the UE 115 should report HARQ ACK/NACK for the scheduled downlink group only or for both the scheduled downlink group and the sidelink group with a same group index as the scheduled downlink group. For example, a “0” may indicate to report HARQ ACK/NACK for the scheduled downlink group only and a “1” may indicate to report HARQ ACK/NACK for the scheduled downlink group and the sidelink group with a same group index as the scheduled downlink group.

For case 1, HARQ ACK/NACK triggering field in DCI format 3_0 may indicate whether the UE 115 should report HARQ ACK/NACK for the scheduled sidelink group only or for both the scheduled sidelink group and the downlink group with a same group index as the scheduled sidelink group. For example, a “0” may indicate to report HARQ ACK/NACK for the scheduled sidelink group only and a “1” may indicate to report HARQ ACK/NACK for the scheduled sidelink group and the downlink group with a same group index as the scheduled sidelink group.

For case 2, the HARQ ACK/NACK triggering field in DCI format 1_1 may indicate whether the UE 115 should report HARQ ACK/NACK for: 1) the scheduled downlink group only; 2) both the scheduled downlink group and a non-scheduled downlink group; 3) both the scheduled downlink group and the sidelink group with the same group index as the scheduled downlink group; 4) both the scheduled downlink group and a sidelink group with a different group index as the scheduled downlink group; 5) the scheduled downlink group, a non-scheduled downlink group, and a sidelink group with the same group index as the scheduled downlink group; 6) the scheduled downlink group, a non-scheduled downlink group, and a sidelink group with a different group index as the scheduled downlink group.

For case 2, the HARQ ACK/NACK triggering field in DCI format 3_0 may indicate whether the UE 115 should report HARQ ACK/NACK for: 1) the scheduled sidelink group only; 2) both the scheduled sidelink group and the downlink group with the same group index as the scheduled sidelink group; 3) both the scheduled sidelink group and a downlink group with a different group index as the scheduled sidelink group; or 4) the scheduled sidelink group, the downlink group with the same group index as the scheduled sidelink group, and a downlink group with a different group index as the scheduled sidelink group.

For case 3, the HARQ ACK/NACK triggering field in DCI format 1_1 may indicate whether the UE 115 should report HARQ ACK/NACK for: 1) the scheduled downlink group only; 2) both the scheduled downlink group and a sidelink group with the same group index as the scheduled downlink group; 3) both the scheduled downlink group and a sidelink group with a different group index as the scheduled downlink group; or 4) the scheduled downlink group, a sidelink group with the same group index as the scheduled downlink group, and a sidelink group with a different group index as the scheduled downlink group.

For case 3, the HARQ ACK/NACK triggering field in DCI format 3_0 may indicate whether the UE 115 should report HARQ ACK/NACK for: 1) the scheduled sidelink group only; 2) both the scheduled sidelink group and a non-scheduled sidelink group; 3) both the scheduled sidelink group and a downlink group with the same group index as the scheduled sidelink group; 4) both the scheduled sidelink group and a downlink group with a different group index as the scheduled sidelink group; 5) the scheduled sidelink group, a non-scheduled sidelink group, and a downlink group with the same group index as the scheduled sidelink group; or 6) the scheduled sidelink group, a non-scheduled sidelink group, and a downlink group with a different group index as the scheduled sidelink group.

For case 4, the HARQ ACK/NACK triggering field in DCI format 1_1 may indicate whether the UE 115 should report HARQ ACK/NACK for: 1) the scheduled downlink group only; 2) both the scheduled downlink group and a sidelink group with the same group index as the scheduled downlink group; 3) both the scheduled downlink group and a sidelink group with a different group index as the scheduled downlink group; or 4) the scheduled downlink group, a sidelink group with the same group index as the scheduled downlink group, and a sidelink group with a different group index as the scheduled downlink group; 7) the scheduled downlink group, a sidelink group with the same group index as the scheduled downlink group, and a sidelink group with a different group index as the scheduled downlink group; or 8) the scheduled downlink group, a non-scheduled downlink group, a sidelink group with the same group index as the scheduled downlink group, and a sidelink group with a different group index as the scheduled downlink group.

For case 4, the HARQ ACK/NACK triggering field in DCI format 3_0 may indicate whether the UE 115 should report HARQ ACK/NACK for: 1) the scheduled sidelink group only; 2) both the scheduled sidelink group and a non-scheduled sidelink group; 3) both the scheduled sidelink group and a downlink group with the same group index as the scheduled sidelink group; 4) both the scheduled sidelink group and a downlink group with a different group index as the scheduled sidelink group; 5) the scheduled sidelink group, a non-scheduled sidelink group, and a downlink group with the same group index as the scheduled sidelink group; or 6) the scheduled sidelink group, a non-scheduled sidelink group, and a downlink group with a different group index as the scheduled sidelink group; 7) the scheduled sidelink group, a downlink group with the same group index as the scheduled sidelink group, and a downlink group with a different group index as the scheduled sidelink group; or 8) the scheduled sidelink group, a non-scheduled sidelink group, a downlink group with the same group index as the scheduled sidelink group, and a downlink group with a different group index as the scheduled sidelink group.

Table 7 below shows an example HARQ ACK/NACK trigger field format in DCI format 1_1.

TABLE 7

| HARQ-ACK | | | |
|---|---|---|---|
| trigger field | | | |
| 1 | 2 | 3 | |
| bit | bits | bits | HARQ-ACK report |
| 0 | 00 | 000 | scheduled downlink group only |
| 1 | 01 | 001 | scheduled downlink group and non-scheduled |
| | | | downlink group |
| | 10 | 010 | scheduled downlink group and sidelink group with |
| | | | the same group index as scheduled downlink group |
| | 11 | 011 | scheduled downlink group and sidelink group with |
| | | | different group index as scheduled downlink group |
| | | 100 | scheduled downlink group, non-scheduled downlink |
| | | | group and sidelink group with the same group index |
| | | | as scheduled downlink group |
| | | 101 | scheduled downlink group, non-scheduled downlink |
| | | | group, and sidelink group with different group |
| | | | index as scheduled downlink group |
| | | 110 | scheduled downlink group, sidelink group with the |
| | | | same group index as scheduled downlink group, and |
| | | | sidelink group with different group index as |
| | | | scheduled downlink group |
| | | 111 | scheduled downlink group, non-scheduled downlink |
| | | | group, sidelink group with the same group index as |
| | | | scheduled downlink group, and sidelink group with |
| | | | different group index as scheduled downlink group |

Table 8 below shows an example HARQ ACK/NACK trigger field format in DCI format 3_0.

TABLE 8

| HARQ-ACK | | | |
|---|---|---|---|
| trigger field | | | |
| 1 | 2 | 3 | |
| bit | bits | bits | HARQ-ACK report |
| 0 | 00 | 000 | scheduled sidelink group only |
| 1 | 01 | 001 | scheduled sidelink group and non-scheduled |
| | | | sidelink group |
| | 10 | 010 | scheduled sidelink group and downlink group with |
| | | | the same group index as scheduled sidelink group |
| | 11 | 011 | scheduled sidelink group and downlink group with |
| | | | different group index as scheduled sidelink group |
| | | 100 | scheduled sidelink group, non-scheduled sidelink |
| | | | group and downlink group with the same group |
| | | | index as scheduled sidelink group |
| | | 101 | scheduled sidelink group, non-scheduled sidelink |
| | | | group, and downlink group with different group |
| | | | index as scheduled sidelink group |
| | | 110 | scheduled sidelink group, downlink group with the |
| | | | same group index as scheduled sidelink group, and |
| | | | downlink group with different group index as |
| | | | scheduled sidelink group |
| | | 111 | scheduled sidelink group, non-scheduled sidelink |
| | | | group, downlink group with the same group index |
| | | | as scheduled sidelink group, and downlink group |
| | | | with different group index as scheduled sidelink |
| | | | group |

In some examples, for DCI format 1_1, if the number of requested group is equal to or less than 2: the T-DAI field for the non-scheduled downlink group may be reused to indicate the T-DAI for the non-scheduled group; the NFI field for the non-scheduled downlink group may be reused to indicate the NFI for the non-scheduled group; and/or C-DAI and C-SAI may be counted per group and separately counted for downlink transmissions and sidelink transmissions with the same group index. In some examples, the placement of HARQ-ACK feedback for the two groups may be ordered based on increasing group index. Within the same group index, the downlink group may be first followed by the sidelink group or the sidelink group may be first followed by the downlink group.

In some examples, for DCI format 1_1, if the number of requested group is greater than 2: the T-DAI (which may include 2 bits) and the NFI (which may include 1 bit) for each of the non-scheduled groups may be configurable by RRC; and C-DAI and C-SAI may be counted per group and separately counted for downlink transmissions and sidelink transmissions with the same group index. In some examples, the placement of HARQ-ACK feedback for the two groups may be ordered based on increasing group index. Within the same group index, the downlink group may be first followed by the sidelink group or the sidelink group may be first followed by the downlink group.

In some examples, for DCI format 3_0, if the number of requested group is equal to or less than 2: the T-DAI field for the non-scheduled sidelink group may be reused to indicate the T-DAI for the non-scheduled group; the NSFI field for the non-scheduled sidelink group may be reused to indicate the NSFI for the non-scheduled group; and/or C-DAI and C-SAI may be counted per group and separately counted for downlink transmissions and sidelink transmissions with the same group index. In some examples, the placement of HARQ-ACK feedback for the two groups may be ordered based on increasing group index. Within the same group index, the downlink group may be first followed by the sidelink group or the sidelink group may be first followed by the downlink group.

In some examples, for DCI format 3_0, if the number of requested group is greater than 2: the T-DAI (which may include 2 bits) and the NSFI (which may include 1 bit) for each of the non-scheduled groups may be configurable by RRC; and C-DAI and C-SAI may be counted per group and separately counted for downlink transmissions and sidelink transmissions with the same group index. In some examples, the placement of HARQ-ACK feedback for the two groups may be ordered based on increasing group index. Within the same group index, the downlink group may be first followed by the sidelink group or the sidelink group may be first followed by the downlink group.

In the timing diagram 1000, the HARQ ACK/NACK triggering field may include 2 bits, and the and HARQ ACK/NACK trigger field in DCI format 1_1 (the last DCI) may be set to “10.” As shown in timing diagram 1000, a DCI format 1_1 in slot 1005-a may schedule a PDSCH 1010-a, a DCI format 1_1 in slot 1005-b may schedule a PDSCH 1010-b, and a DCI format 1_1 in slot 1005-c may schedule a PDSCH 1010-c. The PDSCH 1010-a, the PDSCH 1010-b, and the PDSCH 1010-c may be associated with a same group index (e.g., group index 0). A PUCCH 1025-a in slot 1005-c with HARQ ACK/NACK feedback for the PDSCH 1010-a, the PDSCH 1010-b, and the PDSCH 1010-c may fail.

A DCI format 3_0 in slot 1005-d may schedule a PSSCH 1015-a in slot 1005-e, and a DCI format 3_0 in slot 1005-e may schedule a PSSCH 1015-b in slot 1005-f. The transmitting UE 115 may receive a PSFCH in slot 1005-f from the receiving UE 115 indicating feedback for the PSSCH 1015-a and the PSSCH 1015-b. The PSSCH 1015-a and the PSSCH 1015-b may be associated with a same group index (e.g., group index 0) as the PDSCH 1010-a, the PDSCH 1010-b, and the PDSCH 1010-c. A PUCCH 1025-b in slot 1005-g for reporting HARQ ACK/NACK feedback for the PSSCH 1015-a and the PSSCH 1015-b may fail.

A DCI format 1_1 in slot 1005-h may schedule a PDSCH 1010-d and a DCI format 1_1 in slot 1005-i may schedule a PDSCH 1010-e. The DCI format 1_1 in slot 1005-i may schedule a joint HARQ ACK/NACK report. For example, the HARQ ACK/NACK triggering field may include 2 bits, and the and HARQ ACK/NACK trigger field in DCI format 1_1 may be set to “10,” which indicate the UE 115 may report HARQ ACK/NACK feedback for both scheduled downlink group and sidelink group having a same group index as the scheduled downlink group. As shown in FIG. 10, the scheduled PDSCH 1010-e in slot 1005-i is associated with downlink group 0, therefore, the UE may report HARQ ACK/NACK for both downlink group 0 (the PDSCH 1010-a, PDSCH 1010-b, PDSCH 1010-c, PDSCH 1010-d and PDSCH 1010-e) and sidelink group 0 (PSSCH 1015-a and PSSCH 1015-b) in PUCCH 1020 in slot 1005-j. Counter DAI/total DAI in the DCI formats 1_1 that schedules the downlink group 0 (PDSCH 1010-a, the PDSCH 1010-b, the PDSCH 1010-c, PDSCH 1010-d, the PDSCH 1010-e) and counter SAI/total SAI in the DCI formats 3_0 that schedules sidelink group 0 (PSSCH 1015-a and PSSCH 1015-b) are counted separated. The counter DAI in DCI formats 1_1 in slot 1005-a, slot 1005-b, slot 1005-c, slot 1005-h and slot 1005-e are set to 1, 2, 3, 4, 1, respectively. The counter SAI in DCI formats 3_0 in slot 1005-d and slot 1005-e are set to 1 and 2, respectively. For the DCI fields in the last DCI, (e.g., DCI format 1-1 in slot 1005-i that schedules PDSCH 1010-e), T′-DAI and NFI′ may be reinterpreted as the total SAI and NSFI for the sidelink group (PSSCH 1015-a and the PSSCH 1015-b with the same group index as the scheduled downlink transmissions (PDSCH 1010-a, the PDSCH 1010-b, the PDSCH 1010-c, PDSCH 1010-d, the PDSCH 1010-e)).

The UE 115 may generate a joint HARQ ACK/NACK codebook and transmit HARQ ACK/NACK feedback for the PDSCH 1010-a, the PDSCH 1010-b, the PDSCH 1010-c, the PDSCH 1010-d, the PDSCH 1010-e, the PSSCH 1015-a, and the PSSCH 1015-b using the PUCCH 1020 in slot 1005-j. For example, the ACK/NACK for the PDSCHs and PSSCHs may be ordered according to the values of the C-DAI and C-SAI and the types of transmissions as shown in Table 9 below.

TABLE 9

| PDSCH | PDSCH | PDSCH | PDSCH | PDSCH | PSSCH | PSSCH |
|---|---|---|---|---|---|---|
| 1010-a | 1010-b | 1010-c | 1010-d | 1010-e | 1015-a | 1015-b |
| C-DAI = 1 | C-DAI = 2 | C-DAI = 3 | C-DAI = 4 | C-DAI = 1 | C-SAI = 1 | C-SAI = 2 |
| ACK/NACK | ACK/NACK | ACK/NACK | ACK/NACK | ACK/NACK | ACK/NACK | ACK/NACK |

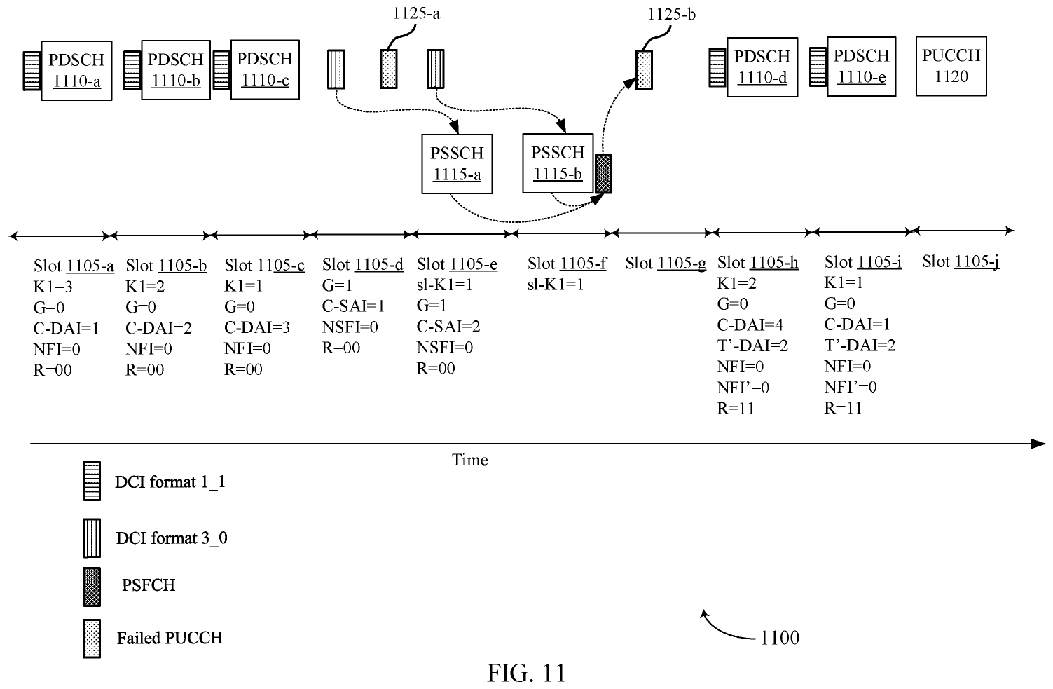

FIG. 11 illustrates an example of a timing diagram 1100 that supports a joint type-2 HARQ codebook for downlink and sidelink communications in accordance with aspects of the present disclosure. In some examples, the timing diagram 1100 may be implemented by or may implement aspects of the wireless communications system 100 or 200.

In the timing diagram 1100, the HARQ ACK/NACK triggering field may include 2 bits, and the and HARQ ACK/NACK trigger field in DCI format 1_1 (the last DCI) may be set to “11.” As shown in timing diagram 1100, a DCI format 1_1 in slot 1105-a may schedule a PDSCH 1110-a, a DCI format 1_1 in slot 1105-b may schedule a PDSCH 1110-b, and a DCI format 1_1 in slot 1105-c may schedule a PDSCH 1110-c. The PDSCH 1110-a, the PDSCH 1110-b, and the PDSCH 1110-c may be associated with a same group index (e.g., group index 0). A PUCCH 1125-a in slot 1105-d with HARQ ACK/NACK feedback for the PDSCH 1110-a, the PDSCH 1110-b, and the PDSCH 1110-c may fail.

A DCI format 3_0 in slot 1105-d may schedule a PSSCH 1115-a in slot 1105-e, and a DCI format 3_0 in slot 1105-e may schedule a PSSCH 1115-b in slot 1105-f. The transmitting UE 115 may receive a PSFCH in slot 1105-f from the receiving UE 115 indicating feedback for the PSSCH 1115-a and the PSSCH 1115-b. The PSSCH 1115-a and the PSSCH 1115-b may be associated with a different group index (e.g., group index 1) as the PDSCH 1110-a, the PDSCH 1110-b, and the PDSCH 1110-c. A PUCCH 1125-b in slot 1105-g for reporting HARQ ACK/NACK feedback for the PSSCH 1115-a and the PSSCH 1115-b may fail.

A DCI format 1_1 in slot 1105-h may schedule a PDSCH 1110-d and a DCI format 1_1 in slot 1105-i may schedule a PDSCH 1110-e. The DCI format 1_1 in slot 1105-i may schedule a joint HARQ ACK/NACK report. For example, the HARQ ACK/NACK triggering field may include 2 bits, and the and HARQ ACK/NACK trigger field in DCI format 1_1 may be set to “11,” which indicate the UE 115 may report HARQ ACK/NACK feedback for both the scheduled downlink group and sidelink group having a different group index as the scheduled downlink group. As shown in FIG. 11, the scheduled PDSCH 1110-e in slot 1105-i is associated with downlink group 0, therefore, the UE may report HARQ ACK/NACK for both downlink group 0 (the PDSCH 1110-a, PDSCH 1110-b, PDSCH 1110-c, PDSCH 1110-d and PDSCH 1110-e) and sidelink group 1 (PSSCH 1115-a and PSSCH 1115-b) in PUCCH 1120 in slot 1105-j. Counter DAI/total DAI in the DCI formats 1_1 that schedules the downlink group 0 (PDSCH 1110-a, the PDSCH 1110-b, the PDSCH 1110-c, PDSCH 1110-d, the PDSCH 1110-e) and counter SAI/total SAI in the DCI formats 3_0 that schedules sidelink group 1 (PSSCH 1115-a and PSSCH 1115-b) are counted separated. The counter DAI in DCI formats 1_1 in slot 1105-a, slot 1105-b, slot 1105-c, slot 1105-h and slot 1105-e are set to 1, 2, 3, 4, 1, respectively. The counter SAI in DCI formats 3_0 in slot 1105-d and slot 1105-e are set to 1 and 2, respectively. For the DCI fields in the last DCI, (e.g., DCI format 1-1 in slot 1105-i that schedules PDSCH 1110-e), T′-DAI and NFI′ may be reinterpreted as the total SAI and NSFI for the non-scheduled sidelink group (PSSCH 1115-a and the PSSCH 1115-b with a different group index as the scheduled downlink transmissions (PDSCH 1110-a, the PDSCH 1110-b, the PDSCH 1110-c, PDSCH 1110-d, the PDSCH 1110-e)).

The UE 115 may generate a joint HARQ ACK/NACK codebook and transmit HARQ ACK/NACK feedback for the PDSCH 1110-a, the PDSCH 1110-b, the PDSCH 1110-c, the PDSCH 1110-d, the PDSCH 1110-e, the PSSCH 1115-a, and the PSSCH 1115-b using the PUCCH 1120 in slot 1105-j. For example, the ACK/NACK for the PDSCHs and PSSCHs may be ordered according to the values of the C-DAI and C-SAI and the types of transmissions as shown in Table 10 below.

TABLE 10

| PDSCH | PDSCH | PDSCH | PDSCH | PDSCH | PSSCH | PSSCH |
|---|---|---|---|---|---|---|
| 1110-a | 1110-b | 1110-c | 1110-d | 1110-e | 1115-a | 1115-b |
| C-DAI = 1 | C-DAI = 2 | C-DAI = 3 | C-DAI = 4 | C-DAI = 1 | C-SAI = 1 | C-SAI = 2 |
| ACK/NACK | ACK/NACK | ACK/NACK | ACK/NACK | ACK/NACK | ACK/NACK | ACK/NACK |

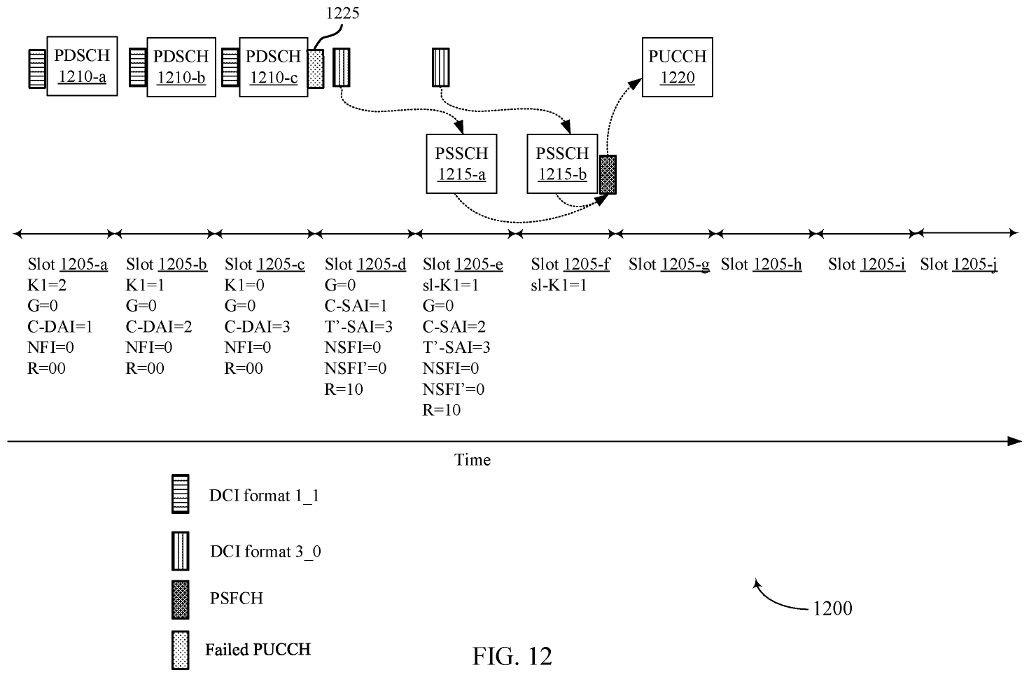

FIG. 12 illustrates an example of a timing diagram 1200 that supports a joint type-2 HARQ codebook for downlink and sidelink communications in accordance with aspects of the present disclosure. In some examples, the timing diagram 1200 may be implemented by or may implement aspects of the wireless communications system 100 or 200.

In the timing diagram 1200, the HARQ ACK/NACK triggering field may include 2 bits, and the and HARQ ACK/NACK trigger field in DCI format 3_0 may be set to “10.” As shown in timing diagram 1200, a DCI format 1_1 in slot 1205-a may schedule a PDSCH 1210-a, a DCI format 1_1 in slot 1205-b may schedule a PDSCH 1210-b, and a DCI format 1_1 in slot 1205-c may schedule a PDSCH 1210-c. The PDSCH 1210-a, the PDSCH 1210-b, and the PDSCH 1210-c may be associated with a same group index (e.g., group index 0). A PUCCH 1225 in slot 1205-c with HARQ ACK/NACK feedback for the PDSCH 1210-a, the PDSCH 1210-b, and the PDSCH 1210-c may fail.

A DCI format 3_0 in slot 1205-d may schedule a PSSCH 1215-a in slot 1205-e, and a DCI format 3_0 in slot 1205-e may schedule a PSSCH 1215-b in slot 1205-f. The transmitting UE 115 may receive a PSFCH in slot 1105-f from the receiving UE 115 indicating feedback for the PSSCH 1215-a and the PSSCH 1215-b. The PSSCH 1215-a and the PSSCH 1215-b may be associated with a same group index (e.g., group index 0) as the PDSCH 1210-a, the PDSCH 1210-b, and the PDSCH 1210-c.

The DCI format 3_0 in slot 1205-e may schedule a joint HARQ ACK/NACK report. For example, the HARQ ACK/NACK triggering field may include 2 bits, and the and HARQ ACK/NACK trigger field in DCI format 3_0 may be set to “10,” which indicate the UE 115 may report HARQ ACK/NACK feedback for both the scheduled sidelink group and downlink group having a same group index as the scheduled sidelink group. As shown in FIG. 12, the scheduled PSSCH 1215-b in slot 1205-f is associated with sidelink group 0, therefore, the UE may report HARQ ACK/NACK for both sidelink group 0 (PSSCH 1115-a and PSSCH 1115-b) and downlink group 0 (the PDSCH 1210-a, PDSCH 1210-b, PDSCH 1210-c) in PUCCH 1220 in slot 1205-g. Counter DAI/total DAI in the DCI formats 1_1 that schedules the downlink group 0 (PDSCH 1210-a, the PDSCH 1210-b, the PDSCH 1210-c) and counter SAI/total SAI in the DCI formats 3_0 that schedules sidelink group 0 (PSSCH 1215-a and PSSCH 1215-b) are counted separately. The counter DAI in DCI formats 1_1 in slot 1205-a, slot 1205-b, slot 1205-c are set to 1, 2, and 3, respectively. The counter SAI in DCI formats 3_0 in slot 1205-d and slot 1205-e are set to 1 and 2, respectively. For the DCI fields in the last DCI, (e.g., DCI format 3_0 in slot 1205-e that schedules PSSCH 1215-b), T′-SAI and NSFI′ may be reinterpreted as the total DAI and NFI for the downlink group (PDSCH 1210-a, the PDSCH 1210-b, the PDSCH 1210-c) having the same group index as the sidelink group (PSSCH 1215-a and PSSCH 1215-b).

The UE 115 may generate a joint HARQ ACK/NACK codebook and transmit HARQ ACK/NACK feedback for the PDSCH 1210-a, the PDSCH 1210-b, the PDSCH 1210-c, the PSSCH 1215-a, and the PSSCH 1215-b using the PUCCH 1220 in slot 1205-g. For example, the ACK/NACK for the PDSCHs and PSSCHs may be ordered according to the values of the C-DAI and C-SAI and the types of transmissions as shown in Table 11 below.

TABLE 11

| PSSCH | PSSCH | PDSCH | PDSCH | PDSCH |
|---|---|---|---|---|
| 1215-a | 1215-b | 1210-a | 1210-b | 1210-c |
| C-SAI = 1 | C-SAI = 2 | C-DAI = 1 | C-DAI = 2 | C-DAI = 3 |
| ACK/NACK | ACK/NACK | ACK/NACK | ACK/NACK | ACK/NACK |

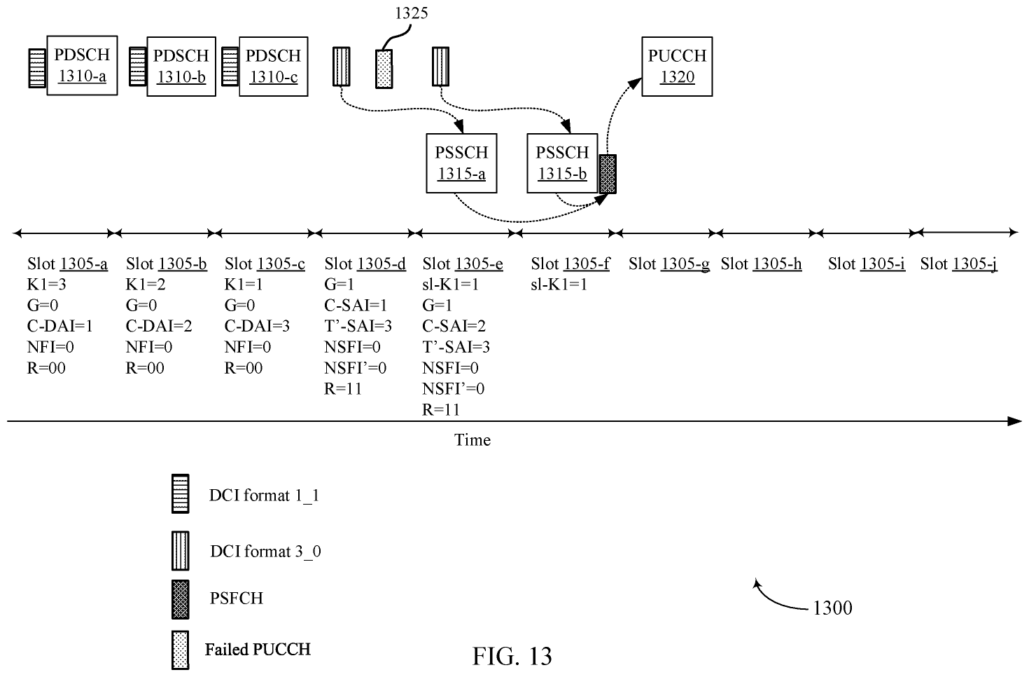

FIG. 13 illustrates an example of a timing diagram 1300 that supports a joint type-2 HARQ codebook for downlink and sidelink communications in accordance with aspects of the present disclosure. In some examples, the timing diagram 1300 may be implemented by or may implement aspects of the wireless communications system 100 or 200.

In the timing diagram 1200, the HARQ ACK/NACK triggering field may include 2 bits, and the and HARQ ACK/NACK trigger field in DCI format 3_0 may be set to “11.” As shown in timing diagram 1300, a DCI format 1_1 in slot 1305-a may schedule a PDSCH 1310-a, a DCI format 1_1 in slot 1305-b may schedule a PDSCH 1310-b, and a DCI format 1_1 in slot 1305-c may schedule a PDSCH 1310-c. The PDSCH 1310-a, the PDSCH 1310-b, and the PDSCH 1310-c may be associated with a same group index (e.g., group index 0). A PUCCH 1325 in slot 1305-d with HARQ ACK/NACK feedback for the PDSCH 1310-a, the PDSCH 1310-b, and the PDSCH 1310-c may fail.

A DCI format 3_0 in slot 1305-d may schedule a PSSCH 1315-a in slot 1305-e, and a DCI format 3_0 in slot 1305-e may schedule a PSSCH 1315-b in slot 1305-f. The transmitting UE 115 may receive a PSFCH in slot 1305-f from the receiving UE 115 indicating feedback for the PSSCH 1115-a and the PSSCH 1315-b. The PSSCH 1315-a and the PSSCH 1315-b may be associated with a different group index (e.g., group index 1) as the PDSCH 1310-a, the PDSCH 1310-b, and the PDSCH 1310-c.

The DCI format 3_0 in slot 1305-e may schedule a joint HARQ ACK/NACK report. For example, the HARQ ACK/NACK triggering field may include 2 bits, and the and HARQ ACK/NACK trigger field in DCI format 3_0 may be set to “11,” which indicate the UE 115 may report HARQ ACK/NACK feedback for both the scheduled sidelink group and downlink group having a different group index as the scheduled sidelink group. As shown in FIG. 13, the scheduled PSSCH 1315-b in slot 1305-f is associated with sidelink group 1, therefore, the UE may report HARQ ACK/NACK for both sidelink group 1 (PSSCH 1315-a and PSSCH 1315-b) and downlink group 0 (the PDSCH 1310-a, PDSCH 1310-b, PDSCH 1310-c) in PUCCH 1320 in slot 1305-g. Counter DAI/total DAI in the DCI formats 1_1 that schedules the downlink group 0 (PDSCH 1310-a, the PDSCH 1310-b, the PDSCH 1310-c) and counter SAI/total SAI in the DCI formats 3_0 that schedules sidelink group 1 (PSSCH 1315-a and PSSCH 1315-b) are counted separately. The counter DAI in DCI formats 1_1 in slot 1305-a, slot 1305-b, slot 1305-c are set to 1, 2, and 3, respectively. The counter SAI in DCI formats 3_0 in slot 1305-d and slot 1305-e are set to 1 and 2, respectively. For (e.g., DCI format 3_0 in slot 1305-e that schedules PSSCH 1315-b), T′-SAI and NSFI′ may be reinterpreted as the total DAI and NFI for the downlink group (PDSCH 1110-a, the PDSCH 1310-b, the PDSCH 1310-c) having a different group index as the sidelink group (PSSCH 1315-a and PSSCH 1315-b).

The UE 115 may generate a joint HARQ ACK/NACK codebook and transmit HARQ ACK/NACK feedback for the PDSCH 1310-a, the PDSCH 1310-b, the PDSCH 1310-c, the PSSCH 1315-a, and the PSSCH 1315-b using the PUCCH 1320 in slot 1305-g. For example, the ACK/NACK for the PDSCHs and PSSCHs may be ordered according to the values of the C-DAI and C-SAI and the types of transmissions as shown in Table 12 below.

TABLE 12

| PDSCH | PDSCH | PDSCH | PSSCH | PSSCH |
|---|---|---|---|---|
| 1310-a | 1310-b | 1310-c | 1315-a | 1315-b |
| C-DAI = 1 | C-DAI = 2 | C-DAI = 3 | C-SAI = 1 | C-SAI = 2 |
| ACK/NACK | ACK/NACK | ACK/NACK | ACK/NACK | ACK/NACK |

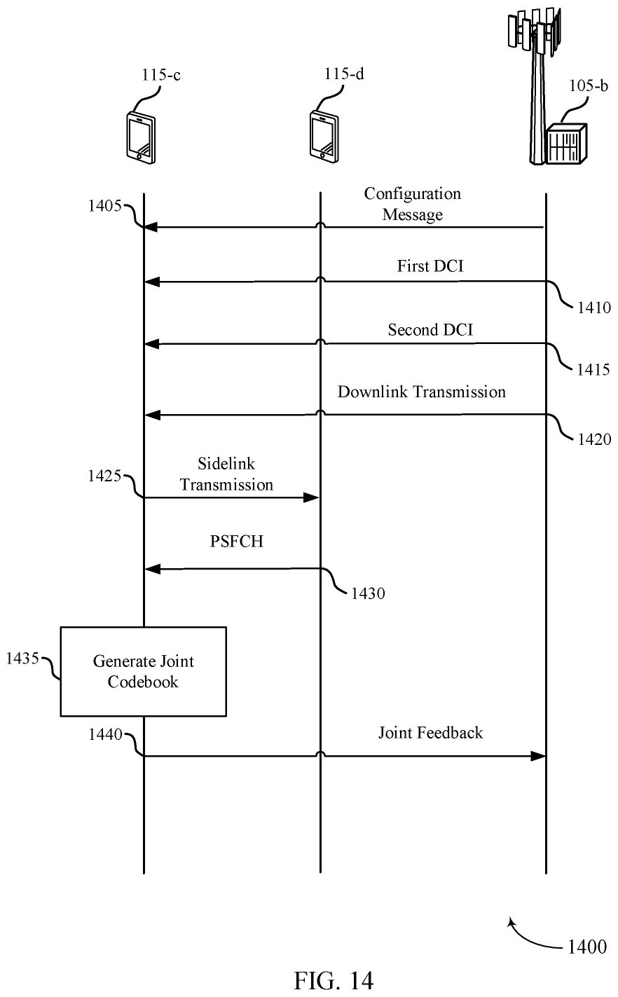

FIG. 14 illustrates an example of a process flow 1400 that supports a joint type-2 HARQ codebook for downlink and sidelink communications in accordance with aspects of the present disclosure. In some examples, the process flow 1400 may be implemented by or may implement aspects of the wireless communications system 100 or 200. The process flow 1400 may include a UE 115-c and a UE 115-d, which may be examples of a UE 115 as described herein. The process flow 1400 may also include a base station 105-b, which may be an example of the base station 105 as described herein. In the following description of the process flow 1400, the operations between the base station 105-b, the UE 115-c, and the UE 115-d may be transmitted in a different order than the example order shown, or the operations performed by the base station 105-b, the UE 115-c, and the UE 115-d may be performed in different orders or at different times. Some operations may also be omitted from the process flow 1400, and other operations may be added to the process flow 1400.

At 1405, the UE 115-c may receive, from the base station 105-b, control signaling indicating a configuration for a joint codebook for HARQ feedback for sidelink transmissions and downlink transmissions.

At 1410, the UE 115-c may receive, from the base station 105-b, a first DCI scheduling a set of downlink transmissions or a set of sidelink transmissions. At 1415, the UE 115-c may receive, from the base station 105-b, a second DCI scheduling a set of sidelink transmissions (if the first DCI scheduled a set of downlink transmissions) or a set of downlink transmissions (if the first DCI scheduled a set of sidelink transmissions). In some examples, the second DCI may indicate a T-SAI or a T-DAI indicating a cumulative number of transmissions of the sidelink transmissions and the downlink transmissions.

At 1420, the UE 115-c may receive, from the base station 105-b, the scheduled set of downlink transmissions. At 1425, the UE 115-c may transmit, to a second UE 115-d, the scheduled set of sidelink transmissions. At 1430, the UE 115-c may receive a PSFCH from the UE 115-d indicating feedback for the transmitted set of sidelink transmissions.

At 1435, the UE 115-c may generate a joint HARQ codebook for the set of sidelink transmissions and the set of downlink transmissions based at least in part on a C-SAI associated with the set of sidelink transmissions and a C-DAI associated with the set of downlink transmissions and based at least in part on the configuration, where the C-SAI and the C-DAI are jointly summed.

At 1440, the UE 115-c may transmit, to the base station 105-b, feedback (e.g., HARQ ACK/NACK) for the set of sidelink transmissions and the set of downlink transmissions based on the joint HARQ codebook. In some examples, the UE 115-c may transmit the feedback via a PUCCH. In some examples, the PUCCH may be scheduled by the second DCI received at 1415.

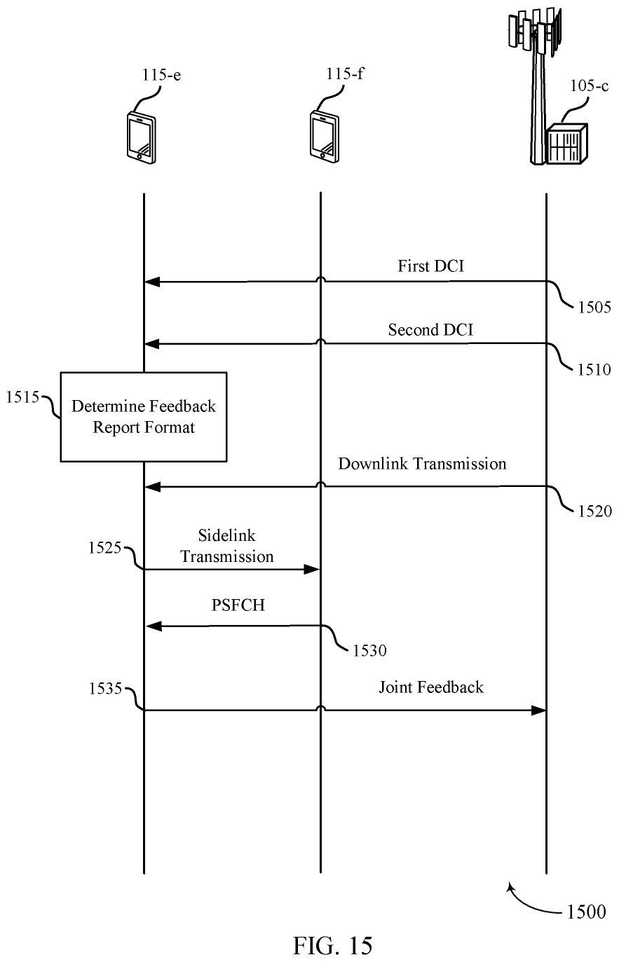

FIG. 15 illustrates an example of a process flow 1500 that supports a joint type-2 HARQ codebook for downlink and sidelink communications in accordance with aspects of the present disclosure. In some examples, the process flow 1500 may be implemented by or may implement aspects of the wireless communications system 100 or 200. The process flow 1500 may include a UE 115-e and a UE 115-f, which may be examples of a UE 115 as described herein. The process flow 1500 may also include a base station 105-c, which may be an example of the base station 105 as described herein. In the following description of the process flow 1500, the operations between the base station 105-c, the UE 115-e, and the UE 115-f may be transmitted in a different order than the example order shown, or the operations performed by the base station 105-c, the UE 115-e, and the UE 115-f may be performed in different orders or at different times. Some operations may also be omitted from the process flow 1500, and other operations may be added to the process flow 1500.

At 1505, the UE 115-f may receive, from the base station 105-c, a first DCI scheduling a set of downlink transmissions or a set of sidelink transmissions. At 1510, the UE 115-e may receive, from the base station 105-c, a second DCI scheduling a set of sidelink transmissions (if the first DCI scheduled a set of downlink transmissions) or a set of downlink transmissions (if the first DCI scheduled a set of sidelink transmissions).

At 1515, the UE 115-e may determine a joint HARQ ACK/NACK report format. The formats may include, for example, transmitting HARQ feedback for a scheduled set of sidelink transmissions; transmitting HARQ feedback for a scheduled set of downlink transmissions; transmitting HARQ-ACK feedback for a scheduled set of sidelink transmissions having a first HARQ group index and an unscheduled set of sidelink transmissions; transmitting HARQ-ACK feedback for a scheduled set of downlink transmissions having a first HARQ group index and an unscheduled set of downlink transmissions having a different HARQ group index; transmitting HARQ feedback for a scheduled set of sidelink transmissions and an unscheduled (e.g., not scheduled by the DCI indicating the feedback report format) set of downlink transmissions (where the set of sidelink transmissions and the set of downlink transmissions may be associated with the same or different HARQ group indices); transmitting HARQ feedback for a scheduled set of downlink transmissions and an unscheduled set of sidelink transmissions (where the set of sidelink transmissions and the set of downlink transmissions may be associated with the same or different HARQ group indices); transmitting HARQ feedback for a scheduled set of sidelink transmissions, an unscheduled set of downlink transmissions (where the set of sidelink transmissions and the set of downlink transmissions may be associated with the same or different HARQ group indices), and a set of unscheduled sidelink transmissions having a different HARQ group index; transmitting HARQ feedback for a scheduled set of sidelink transmissions having a first HARQ group index, an unscheduled set of downlink transmissions having the same HARQ group index and an unscheduled set of downlink transmissions having a different HARQ group index; transmitting HARQ feedback for a scheduled set of downlink transmissions having a first HARQ group index, an unscheduled set of sidelink transmissions having the same HARQ group index and an unscheduled set of sidelink transmissions having a different HARQ group index; transmitting HARQ feedback for a scheduled set of downlink transmissions, an unscheduled set of sidelink transmissions (where the set of sidelink transmissions and the set of downlink transmissions may be associated with the same or different HARQ group indices), and a set of unscheduled downlink transmissions having a different HARQ group index; transmitting HARQ feedback for a scheduled set of sidelink transmissions having a first HARQ group index, a set of unscheduled downlink transmissions having the same group index, a set of unscheduled downlink transmissions having a different HARQ group index, and an unscheduled set of sidelink transmissions having a different HARQ group index; and transmitting HARQ feedback for a scheduled set of downlink transmissions having a first HARQ group index, a set of unscheduled sidelink transmissions having the same group index, a set of unscheduled sidelink transmissions having a different HARQ group index, and an unscheduled set of downlink transmissions having a different HARQ group index.

At 1520, the UE 115-e may receive the set of downlink transmissions. At 1525, the UE 115-e may transmit the set of sidelink transmissions to the UE 115-f. At 1530, the UE 115-e may receive a PSFCH from the UE 115-f indicating feedback for the transmitted set of sidelink transmissions.

At 1535, the UE 115-e may transmit a feedback report (e.g., a HARQ ACK/NACK report) for at least one of the set of sidelink transmissions or the set of downlink transmissions according to the determined feedback report format.

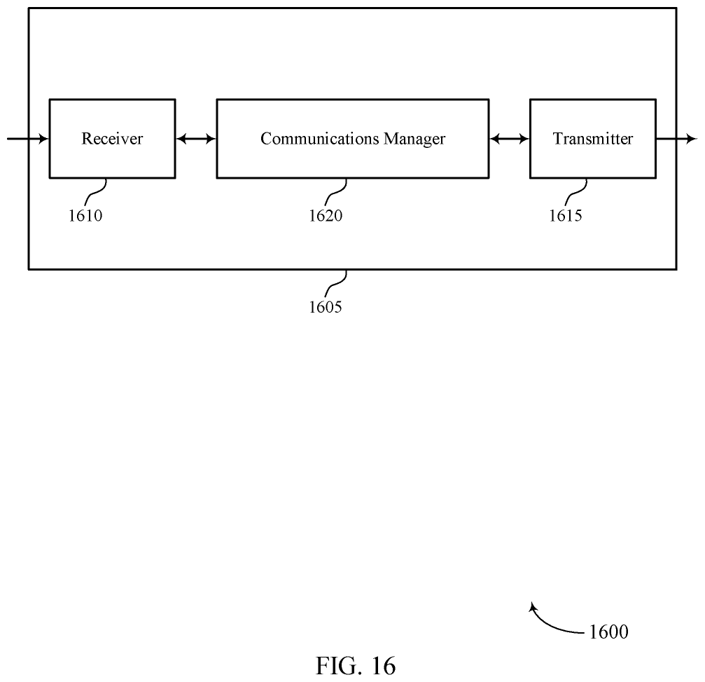

FIG. 16 shows a block diagram 1600 of a device 1605 that supports a joint type-2 HARQ codebook for downlink and sidelink communications in accordance with aspects of the present disclosure. The device 1605 may be an example of aspects of a UE 115 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to joint type-2 HARQ codebooks for downlink and sidelink communications). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to joint type-2 HARQ codebooks for downlink and sidelink communications). In some examples, the transmitter 1615 may be co-located with a receiver 1610 in a transceiver module. The transmitter 1615 may utilize a single antenna or a set of multiple antennas.

The communications manager 1620, the receiver 1610, the transmitter 1615, or various combinations thereof or various components thereof may be examples of means for performing various aspects of joint type-2 HARQ codebooks for downlink and sidelink communications as described herein. For example, the communications manager 1620, the receiver 1610, the transmitter 1615, or various combinations or components thereof may support a method for performing one or more of the functions described herein.

In some examples, the communications manager 1620, the receiver 1610, the transmitter 1615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1620, the receiver 1610, the transmitter 1615, or various combinations or components thereof may be implemented in code (e.g., as communications management software or firmware) executed by a processor. If implemented in code executed by a processor, the functions of the communications manager 1620, the receiver 1610, the transmitter 1615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1620 may be configured to perform various operations (e.g., receiving, monitoring, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to receive information, transmit information, or perform various other operations as described herein.

The communications manager 1620 may support wireless communications at a first UE in accordance with examples as disclosed herein. For example, the communications manager 1620 may be configured as or otherwise support a means for receiving, from a base station, a downlink control information message indicating a feedback report format for reporting HARQ feedback for sidelink transmissions and downlink transmissions. The communications manager 1620 may be configured as or otherwise support a means for transmitting, to at least a second UE, a set of sidelink transmissions. The communications manager 1620 may be configured as or otherwise support a means for receiving, from the base station, a set of downlink transmissions. The communications manager 1620 may be configured as or otherwise support a means for transmitting, to the base station, a feedback report for at least one of the set of sidelink transmissions or the set of downlink transmissions based on the feedback report format.

By including or configuring the communications manager 1620 in accordance with examples as described herein, the device 1605 (e.g., a processor controlling or otherwise coupled to the receiver 1610, the transmitter 1615, the communications manager 1620, or a combination thereof) may support techniques for more efficient utilization of communication resources by facilitating joint HARQ feedback for sidelink and downlink transmissions.

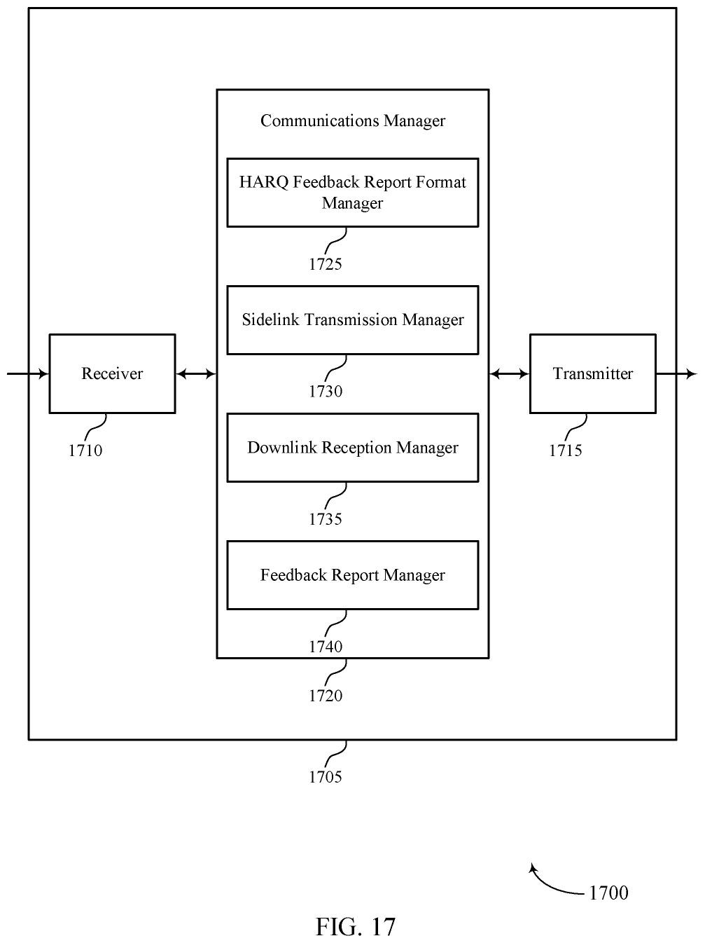

FIG. 17 shows a block diagram 1700 of a device 1705 that supports a joint type-2 HARQ codebook for downlink and sidelink communications in accordance with aspects of the present disclosure. The device 1705 may be an example of aspects of a device 1605 or a UE 115 as described herein. The device 1705 may include a receiver 1710, a transmitter 1715, and a communications manager 1720. The device 1705 may also include a processor. Each of these components may be in communication with one another (e.g., via one or more buses).

The receiver 1710 may provide a means for receiving information such as packets, user data, control information, or any combination thereof associated with various information channels (e.g., control channels, data channels, information channels related to joint type-2 HARQ codebooks for downlink and sidelink communications). Information may be passed on to other components of the device 1705. The receiver 1710 may utilize a single antenna or a set of multiple antennas.

The transmitter 1715 may provide a means for transmitting signals generated by other components of the device 1705. For example, the transmitter 1715 may transmit information such as packets, user data, control information, or any combination thereof associated with various information channels (e.g., control channels, data channels, information channels related to joint type-2 HARQ codebooks for downlink and sidelink communications). In some examples, the transmitter 1715 may be co-located with a receiver 1710 in a transceiver module. The transmitter 1715 may utilize a single antenna or a set of multiple antennas.

The device 1705, or various components thereof, may be an example of means for performing various aspects of joint type-2 HARQ codebooks for downlink and sidelink communications as described herein. For example, the communications manager 1720 may include an HARQ feedback report format manager 1725, a sidelink transmission manager 1730, a downlink reception manager 1735, a feedback report manager 1740, or any combination thereof. The communications manager 1720 may be an example of aspects of a communications manager 1620 as described herein. In some examples, the communications manager 1720, or various components thereof, may be configured to perform various operations (e.g., receiving, monitoring, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to receive information, transmit information, or perform various other operations as described herein.

The communications manager 1720 may support wireless communications at a first UE in accordance with examples as disclosed herein. The HARQ feedback report format manager 1725 may be configured as or otherwise support a means for receiving, from a base station, a downlink control information message indicating a feedback report format for reporting HARQ feedback for sidelink transmissions and downlink transmissions. The sidelink transmission manager 1730 may be configured as or otherwise support a means for transmitting, to at least a second UE, a set of sidelink transmissions. The downlink reception manager 1735 may be configured as or otherwise support a means for receiving, from the base station, a set of downlink transmissions. The feedback report manager 1740 may be configured as or otherwise support a means for transmit, to the base station, a feedback report for at least one of the set of sidelink transmissions or the set of downlink transmissions based on the feedback report format.

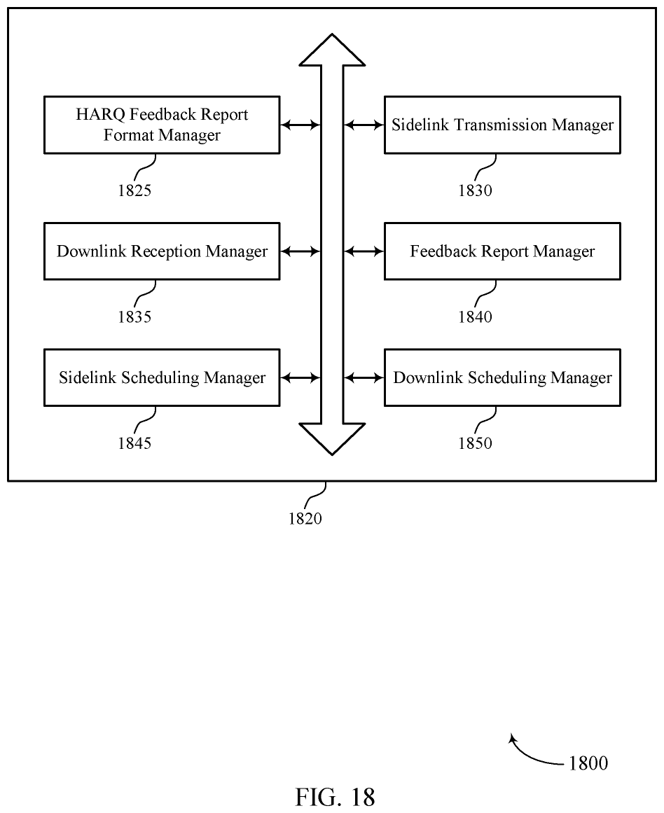

FIG. 18 shows a block diagram 1800 of a communications manager 1820 that supports a joint type-2 HARQ codebook for downlink and sidelink communications in accordance with aspects of the present disclosure. The communications manager 1820 may be an example of aspects of a communications manager 1620, a communications manager 1720, or both, as described herein. The communications manager 1820, or various components thereof, may be an example of means for performing various aspects of a joint type-2 HARQ codebooks for downlink and sidelink communications as described herein. For example, the communications manager 1820 may include an HARQ feedback report format manager 1825, a sidelink transmission manager 1830, a downlink reception manager 1835, a feedback report manager 1840, a sidelink scheduling manager 1845, a downlink scheduling manager 1850, or any combination thereof. Each of these components may communicate, directly or indirectly, with one another (e.g., via one or more buses).

The communications manager 1820 may support wireless communications at a first UE in accordance with examples as disclosed herein. The HARQ feedback report format manager 1825 may be configured as or otherwise support a means for receiving, from a base station, a downlink control information message indicating a feedback report format for reporting HARQ feedback for sidelink transmissions and downlink transmissions. The sidelink transmission manager 1830 may be configured as or otherwise support a means for transmitting, to at least a second UE, a set of sidelink transmissions. The downlink reception manager 1835 may be configured as or otherwise support a means for receiving, from the base station, a set of downlink transmissions. The feedback report manager 1840 may be configured as or otherwise support a means for transmit, to the base station, a feedback report for at least one of the set of sidelink transmissions or the set of downlink transmissions based on the feedback report format.

In some examples, the sidelink scheduling manager 1845 may be configured as or otherwise support a means for receiving, from the base station, a second downlink control information message indicating scheduling information for the set of sidelink transmissions and a group index associated with the set of sidelink transmissions. In some examples, the downlink scheduling manager 1850 may be configured as or otherwise support a means for receiving, with the downlink control information message, an indication of scheduling information for the set of downlink transmissions and that the set of downlink transmissions is associated with the group index, and where the feedback report format includes a joint feedback report for reporting the set of sidelink transmissions associated with the group index and the set of downlink transmissions associated with the group index.

In some examples, an order for feedback for each transmission of the set of downlink transmissions and the set of sidelink transmissions in the joint feedback report is based on a transmission type for each transmission.

In some examples, the downlink scheduling manager 1850 may be configured as or otherwise support a means for receiving, from the base station, a second downlink control information message indicating scheduling information for the set of downlink transmissions and a group index associated with the set of downlink transmissions. In some examples, the sidelink scheduling manager 1845 may be configured as or otherwise support a means for receiving, with the downlink control information message, an indication of scheduling information for the set of sidelink transmissions and that the set of sidelink transmissions is associated with the group index, and where the feedback report format includes a joint feedback report for reporting feedback information for the set of sidelink transmissions associated with the group index and the set of downlink transmissions associated with the group index.

In some examples, an order for feedback for each transmission of the set of downlink transmissions and the set of sidelink transmissions in the joint feedback report is based on a transmission type for each transmission.

In some examples, the sidelink scheduling manager 1845 may be configured as or otherwise support a means for receiving, from the base station, a second downlink control information message indicating scheduling information for the set of sidelink transmissions and a first group index associated with the set of sidelink transmissions. In some examples, the downlink scheduling manager 1850 may be configured as or otherwise support a means for receiving, with the downlink control information message, an indication of scheduling information for the set of downlink transmissions and that the set of downlink transmissions is associated with a second group index, and where the feedback report format includes a joint feedback report for reporting feedback information for the set of sidelink transmissions associated with the first group index and the set of downlink transmissions associated with the second group index.

In some examples, an order for feedback for each transmission of the set of downlink transmissions and the set of sidelink transmissions in the joint feedback report is based on the first group index and the second group index.

In some examples, the downlink scheduling manager 1850 may be configured as or otherwise support a means for receiving, from the base station, a second downlink control information message indicating scheduling information for the set of downlink transmissions and a first group index associated with the set of downlink transmissions. In some examples, the sidelink scheduling manager 1845 may be configured as or otherwise support a means for receiving, with the downlink control information message, an indication of scheduling information for the set of sidelink transmissions and that the set of sidelink transmissions is associated with a second group index, and where the feedback report format includes a joint feedback report for reporting feedback information for the set of sidelink transmissions associated with the first group index and the set of downlink transmissions associated with the second group index.

In some examples, an order for feedback for each transmission of the set of downlink transmissions and the set of sidelink transmissions in the joint feedback report is based on the first group index and the second group index.

In some examples, the sidelink scheduling manager 1845 may be configured as or otherwise support a means for receiving, from the base station, a third downlink control information message indicating scheduling information for a second set of sidelink transmissions and a third group index associated with the second set of sidelink transmissions. In some examples, the sidelink transmission manager 1830 may be configured as or otherwise support a means for transmitting, to at least the second UE, the second set of sidelink transmissions. In some examples, the downlink scheduling manager 1850 may be configured as or otherwise support a means for receiving, from the base station, a second downlink control information message indicating scheduling information for the set of downlink transmissions and a first group index associated with the set of downlink transmissions. In some examples, the sidelink scheduling manager 1845 may be configured as or otherwise support a means for receiving, with the downlink control information message, an indication of scheduling information for the set of sidelink transmissions and that the set of sidelink transmissions is associated with the first group index, and where the feedback report format includes a joint feedback report for reporting the set of downlink transmissions associated with the first group index, the set of sidelink transmissions associated with the first group index, and the second set of sidelink transmissions associated with the third group index.

In some examples, the sidelink scheduling manager 1845 may be configured as or otherwise support a means for receiving, from the base station, a third downlink control information message indicating scheduling information for a second set of sidelink transmissions and a third group index associated with the second set of sidelink transmissions. In some examples, the sidelink transmission manager 1830 may be configured as or otherwise support a means for transmitting, to at least the second UE, the second set of sidelink transmissions. In some examples, the downlink scheduling manager 1850 may be configured as or otherwise support a means for receiving, from the base station, a second downlink control information message indicating scheduling information for the set of downlink transmissions and a first group index associated with the set of downlink transmissions. In some examples, the sidelink scheduling manager 1845 may be configured as or otherwise support a means for receiving, with the downlink control information message, an indication of scheduling information for the set of sidelink transmissions and that the set of sidelink transmissions is associated with a second group index, and where the feedback report format includes a joint feedback report for reporting the set of downlink transmissions associated with the first group index, the set of sidelink transmissions associated with the second group index, and the second set of sidelink transmissions associated with the third group index.

In some examples, the downlink scheduling manager 1850 may be configured as or otherwise support a means for receiving, from the base station, a third downlink control information message indicating scheduling information for a second set of downlink transmissions and a third group index associated with the second set of downlink transmissions. In some examples, the downlink reception manager 1835 may be configured as or otherwise support a means for receiving, from the base station, the second set of downlink transmissions. In some examples, the sidelink scheduling manager 1845 may be configured as or otherwise support a means for receiving, from the base station, a second downlink control information message indicating scheduling information for the set of sidelink transmissions and a first group index associated with the set of sidelink transmissions. In some examples, the downlink scheduling manager 1850 may be configured as or otherwise support a means for receiving, with the downlink control information message, an indication of scheduling information for the set of downlink transmissions and that the set of downlink transmissions is associated with the first group index, and where the feedback report format includes a joint feedback report for reporting the set of sidelink transmissions associated with the first group index, the set of downlink transmissions associated with the first group index, and the second set of downlink transmissions associated with the third group index.

In some examples, the downlink scheduling manager 1850 may be configured as or otherwise support a means for receiving, from the base station, a third downlink control information message indicating scheduling information for a second set of downlink transmissions and a third group index associated with the second set of downlink transmissions. In some examples, the downlink reception manager 1835 may be configured as or otherwise support a means for receiving, from the base station, the second set of downlink transmissions. In some examples, the sidelink scheduling manager 1845 may be configured as or otherwise support a means for receiving, from the base station, a second downlink control information message indicating scheduling information for the set of sidelink transmissions and a first group index associated with the set of sidelink transmissions. In some examples, the downlink scheduling manager 1850 may be configured as or otherwise support a means for receiving, with the downlink control information message, an indication of scheduling information for the set of downlink transmissions and that the set of downlink transmissions is associated with a second group index, and where the feedback report format includes a joint feedback report for reporting the set of sidelink transmissions associated with the first group index, the set of downlink transmissions associated with the second group index, and the second set of downlink transmissions associated with the third group index.

In some examples, the downlink scheduling manager 1850 may be configured as or otherwise support a means for receiving, from the base station, a third downlink control information message indicating scheduling information for a second set of downlink transmissions and a third group index associated with the second set of downlink transmissions. In some examples, the downlink reception manager 1835 may be configured as or otherwise support a means for receiving, from the base station, the second set of downlink transmissions. In some examples, the downlink scheduling manager 1850 may be configured as or otherwise support a means for receiving, from the base station, a second downlink control information message indicating scheduling information for the set of downlink transmissions and a first group index associated with the set of downlink transmissions. In some examples, the sidelink scheduling manager 1845 may be configured as or otherwise support a means for receiving, with the downlink control information message, an indication of scheduling information for the set of sidelink transmissions and that the set of sidelink transmissions is associated with the first group index, and where the feedback report format includes a joint feedback report for reporting the set of downlink transmissions associated with the first group index, the set of sidelink transmissions associated with the first group index, and the second set of downlink transmissions associated with the third group index.

In some examples, the sidelink scheduling manager 1845 may be configured as or otherwise support a means for receiving, from the base station, a third downlink control information message indicating scheduling information for a second set of sidelink transmissions and a third group index associated with the second set of sidelink transmissions. In some examples, the sidelink transmission manager 1830 may be configured as or otherwise support a means for transmitting, to at least the second UE, the second set of sidelink transmissions. In some examples, the sidelink scheduling manager 1845 may be configured as or otherwise support a means for receiving, from the base station, a second downlink control information message indicating scheduling information for the set of sidelink transmissions and a first group index associated with the set of sidelink transmissions. In some examples, the downlink scheduling manager 1850 may be configured as or otherwise support a means for receiving, with the downlink control information message, an indication of scheduling information for the set of downlink transmissions and that the set of downlink transmissions is associated with the first group index, and where the feedback report format includes a joint feedback report for reporting the set of sidelink transmissions associated with the first group index, the set of downlink transmissions associated with the first group index, and the second set of sidelink transmissions associated with the third group index.

In some examples, the sidelink scheduling manager 1845 may be configured as or otherwise support a means for receiving, from the base station, a third downlink control information message indicating scheduling information for a second set of sidelink transmissions and a third group index associated with the second set of sidelink transmissions. In some examples, the sidelink transmission manager 1830 may be configured as or otherwise support a means for transmitting, to at least the second UE, the second set of sidelink transmissions. In some examples, the downlink scheduling manager 1850 may be configured as or otherwise support a means for receiving, from the base station, a fourth downlink control information message indicating scheduling information for a second set of downlink transmissions and a fourth group index associated with the second set of downlink transmissions. In some examples, the downlink reception manager 1835 may be configured as or otherwise support a means for receiving, from the base station, the second set of downlink transmissions. In some examples, the downlink scheduling manager 1850 may be configured as or otherwise support a means for receiving, from the base station, a second downlink control information message indicating scheduling information for the set of downlink transmissions and a first group index associated with the set of downlink transmissions. In some examples, the sidelink scheduling manager 1845 may be configured as or otherwise support a means for receiving, with the downlink control information message, an indication of scheduling information for the set of sidelink transmissions and that the set of sidelink transmissions is associated with the first group index, and where the feedback report format includes a joint feedback report for reporting the set of downlink transmissions associated with the first group index, the set of sidelink transmissions associated with the first group index, the second set of sidelink transmissions associated with the third group index, and the second set of downlink transmissions associated with the fourth group index.

In some examples, an order for feedback for each transmission of the set of downlink transmissions, the set of sidelink transmissions, the second set of downlink transmissions, and the second set of sidelink transmissions in the joint feedback report is based on the first group index, the third group index, the fourth group index, and a transmission type for each transmission.

In some examples, the downlink scheduling manager 1850 may be configured as or otherwise support a means for receiving, from the base station, a third downlink control information message indicating scheduling information for a second set of downlink transmissions and a third group index associated with the second set of downlink transmissions. In some examples, the downlink reception manager 1835 may be configured as or otherwise support a means for receiving, from the base station, the second set of downlink transmissions. In some examples, the sidelink scheduling manager 1845 may be configured as or otherwise support a means for receiving, from the base station, a fourth downlink control information message indicating scheduling information for a second set of sidelink transmissions and a fourth group index associated with the second set of sidelink transmissions. In some examples, the sidelink transmission manager 1830 may be configured as or otherwise support a means for transmitting, to at least the second UE, the second set of sidelink transmissions. In some examples, the sidelink scheduling manager 1845 may be configured as or otherwise support a means for receiving, from the base station, a second downlink control information message indicating scheduling information for the set of sidelink transmissions and a first group index associated with the set of sidelink transmissions. In some examples, the downlink scheduling manager 1850 may be configured as or otherwise support a means for receiving, with the downlink control information message, an indication of scheduling information for the set of downlink transmissions and that the set of downlink transmissions is associated with the first group index, and where the feedback report format includes a joint feedback report for reporting the set of sidelink transmissions associated with the first group index, the set of downlink transmissions associated with the first group index, the second set of downlink transmissions associated with the third group index, and the second set of sidelink transmissions associated with the fourth group index.

In some examples, an order for feedback for each transmission of the set of downlink transmissions, the set of sidelink transmissions, the second set of downlink transmissions, and the second set of sidelink transmissions in the joint feedback report is based on the first group index, the third group index, the fourth group index, and a transmission type for each transmission.

In some examples, the HARQ feedback report format manager 1825 may be configured as or otherwise support a means for receiving, with the downlink control information message, a set of bits indicating the feedback report format.

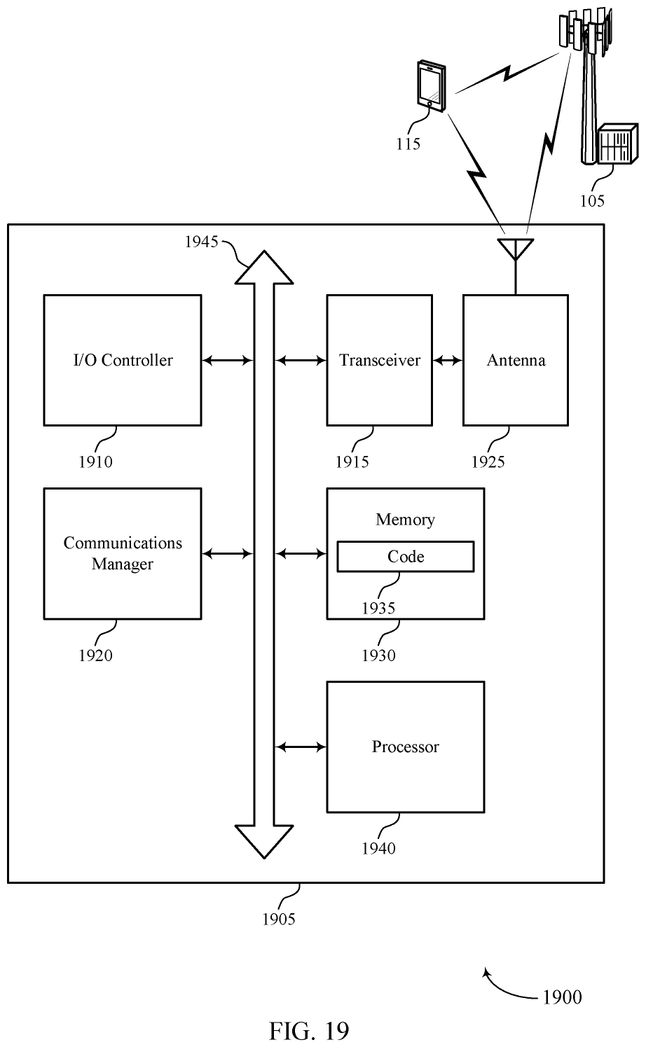

FIG. 19 shows a diagram of a system 1900 including a device 1905 that supports a joint type-2 HARQ codebook for downlink and sidelink communications in accordance with aspects of the present disclosure. The device 1905 may be an example of or include the components of a device 1605, a device 1705, or a UE 115 as described herein. The device 1905 may communicate wirelessly with one or more base stations 105, UEs 115, or any combination thereof. The device 1905 may include components for bi-directional voice and data communications including components for transmitting and receiving communications, such as a communications manager 1920, an input/output (I/O) controller 1910, a transceiver 1915, an antenna 1925, a memory 1930, code 1935, and a processor 1940. These components may be in electronic communication or otherwise coupled (e.g., operatively, communicatively, functionally, electronically, electrically) via one or more buses (e.g., a bus 1945).

The I/O controller 1910 may manage input and output signals for the device 1905. The I/O controller 1910 may also manage peripherals not integrated into the device 1905. In some cases, the I/O controller 1910 may represent a physical connection or port to an external peripheral. In some cases, the I/O controller 1910 may utilize an operating system such as iOS®, ANDROID®, MS-DOS®, MS-WINDOWS®, OS/2®, UNIX®, LINUX®, or another known operating system. Additionally or alternatively, the I/O controller 1910 may represent or interact with a modem, a keyboard, a mouse, a touchscreen, or a similar device. In some cases, the I/O controller 1910 may be implemented as part of a processor, such as the processor 1940. In some cases, a user may interact with the device 1905 via the I/O controller 1910 or via hardware components controlled by the I/O controller 1910.

In some cases, the device 1905 may include a single antenna 1925. However, in some other cases, the device 1905 may have more than one antenna 1925, which may be capable of concurrently transmitting or receiving multiple wireless transmissions. The transceiver 1915 may communicate bi-directionally, via the one or more antennas 1925, wired, or wireless links as described herein. For example, the transceiver 1915 may represent a wireless transceiver and may communicate bi-directionally with another wireless transceiver. The transceiver 1915 may also include a modem to modulate the packets, to provide the modulated packets to one or more antennas 1925 for transmission, and to demodulate packets received from the one or more antennas 1925. The transceiver 1915, or the transceiver 1915 and one or more antennas 1925, may be an example of a transmitter 1615, a transmitter 1715, a receiver 1610, a receiver 1710, or any combination thereof or component thereof, as described herein.

The memory 1930 may include random access memory (RAM) and read-only memory (ROM). The memory 1930 may store computer-readable, computer-executable code 1935 including instructions that, when executed by the processor 1940, cause the device 1905 to perform various functions described herein. The code 1935 may be stored in a non-transitory computer-readable medium such as system memory or another type of memory. In some cases, the code 1935 may not be directly executable by the processor 1940 but may cause a computer (e.g., when compiled and executed) to perform functions described herein. In some cases, the memory 1930 may contain, among other things, a basic I/O system (BIOS) which may control basic hardware or software operation such as the interaction with peripheral components or devices.

The processor 1940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1940 may be configured to operate a memory array using a memory controller. In some other cases, a memory controller may be integrated into the processor 1940. The processor 1940 may be configured to execute computer-readable instructions stored in a memory (e.g., the memory 1930) to cause the device 1905 to perform various functions (e.g., functions or tasks supporting joint type-2 HARQ codebooks for downlink and sidelink communications). For example, the device 1905 or a component of the device 1905 may include a processor 1940 and memory 1930 coupled to the processor 1940, the processor 1940 and memory 1930 configured to perform various functions described herein.

The communications manager 1920 may support wireless communications at a first UE in accordance with examples as disclosed herein. For example, the communications manager 1920 may be configured as or otherwise support a means for receiving, from a base station, a downlink control information message indicating a feedback report format for reporting HARQ feedback for sidelink transmissions and downlink transmissions. The communications manager 1920 may be configured as or otherwise support a means for transmitting, to at least a second UE, a set of sidelink transmissions. The communications manager 1920 may be configured as or otherwise support a means for receiving, from the base station, a set of downlink transmissions. The communications manager 1920 may be configured as or otherwise support a means for transmitting, to the base station, a feedback report for at least one of the set of sidelink transmissions or the set of downlink transmissions based on the feedback report format.

By including or configuring the communications manager 1920 in accordance with examples as described herein, the device 1905 may support techniques for improved communication reliability, more efficient utilization of communication resources, and improved coordination between devices by facilitating joint HARQ feedback for sidelink and downlink transmissions.

In some examples, the communications manager 1920 may be configured to perform various operations (e.g., receiving, monitoring, transmitting) using or otherwise in cooperation with the transceiver 1915, the one or more antennas 1925, or any combination thereof. Although the communications manager 1920 is illustrated as a separate component, in some examples, one or more functions described with reference to the communications manager 1920 may be supported by or performed by the processor 1940, the memory 1930, the code 1935, or any combination thereof. For example, the code 1935 may include instructions executable by the processor 1940 to cause the device 1905 to perform various aspects of a joint type-2 HARQ codebook for downlink and sidelink communications as described herein, or the processor 1940 and the memory 1930 may be otherwise configured to perform or support such operations.

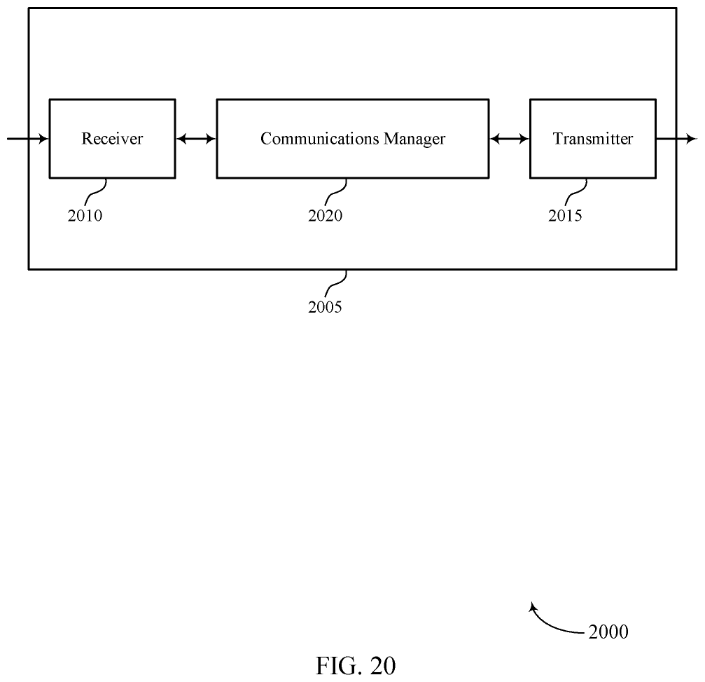

FIG. 20 shows a block diagram 2000 of a device 2005 that supports a joint type-2 HARQ codebook for downlink and sidelink communications in accordance with aspects of the present disclosure. The device 2005 may be an example of aspects of a base station 105 as described herein. The device 2005 may include a receiver 2010, a transmitter 2015, and a communications manager 2020. The device 2005 may also include a processor. Each of these components may be in communication with one another (e.g., via one or more buses).

The receiver 2010 may provide a means for receiving information such as packets, user data, control information, or any combination thereof associated with various information channels (e.g., control channels, data channels, information channels related to a joint type-2 HARQ codebook for downlink and sidelink communications). Information may be passed on to other components of the device 2005. The receiver 2010 may utilize a single antenna or a set of multiple antennas.

The transmitter 2015 may provide a means for transmitting signals generated by other components of the device 2005. For example, the transmitter 2015 may transmit information such as packets, user data, control information, or any combination thereof associated with various information channels (e.g., control channels, data channels, information channels related to a joint type-2 HARQ codebook for downlink and sidelink communications). In some examples, the transmitter 2015 may be co-located with a receiver 2010 in a transceiver module. The transmitter 2015 may utilize a single antenna or a set of multiple antennas.

The communications manager 2020, the receiver 2010, the transmitter 2015, or various combinations thereof or various components thereof may be examples of means for performing various aspects of a joint type-2 HARQ codebook for downlink and sidelink communications as described herein. For example, the communications manager 2020, the receiver 2010, the transmitter 2015, or various combinations or components thereof may support a method for performing one or more of the functions described herein.

In some examples, the communications manager 2020, the receiver 2010, the transmitter 2015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 2020, the receiver 2010, the transmitter 2015, or various combinations or components thereof may be implemented in code (e.g., as communications management software or firmware) executed by a processor. If implemented in code executed by a processor, the functions of the communications manager 2020, the receiver 2010, the transmitter 2015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 2020 may be configured to perform various operations (e.g., receiving, monitoring, transmitting) using or otherwise in cooperation with the receiver 2010, the transmitter 2015, or both. For example, the communications manager 2020 may receive information from the receiver 2010, send information to the transmitter 2015, or be integrated in combination with the receiver 2010, the transmitter 2015, or both to receive information, transmit information, or perform various other operations as described herein.

The communications manager 2020 may support wireless communications at a base station in accordance with examples as disclosed herein. For example, the communications manager 2020 may be configured as or otherwise support a means for transmitting, to a UE, a downlink control information message indicating a feedback report format for reporting HARQ feedback for sidelink transmissions and downlink transmissions. The communications manager 2020 may be configured as or otherwise support a means for transmitting, to the UE, scheduling information for a set of sidelink transmissions. The communications manager 2020 may be configured as or otherwise support a means for transmitting, to the UE, a set of downlink transmissions. The communications manager 2020 may be configured as or otherwise support a means for receiving, from the UE, a feedback report for at least one of the set of sidelink transmissions or the set of downlink transmissions based on the feedback report format.

By including or configuring the communications manager 2020 in accordance with examples as described herein, the device 2005 (e.g., a processor controlling or otherwise coupled to the receiver 2010, the transmitter 2015, the communications manager 2020, or a combination thereof) may support techniques for more efficient utilization of communication resources by facilitating joint HARQ feedback for sidelink and downlink transmissions.

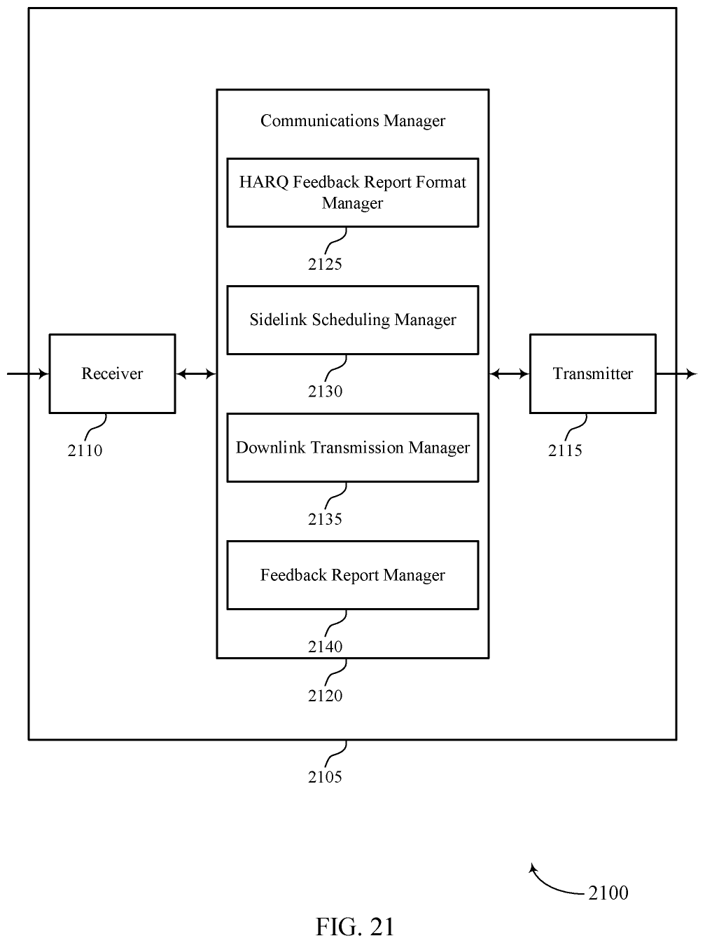

FIG. 21 shows a block diagram 2100 of a device 2105 that supports a joint type-2 HARQ codebook for downlink and sidelink communications in accordance with aspects of the present disclosure. The device 2105 may be an example of aspects of a device 2005 or a base station 105 as described herein. The device 2105 may include a receiver 2110, a transmitter 2115, and a communications manager 2120. The device 2105 may also include a processor. Each of these components may be in communication with one another (e.g., via one or more buses).

The receiver 2110 may provide a means for receiving information such as packets, user data, control information, or any combination thereof associated with various information channels (e.g., control channels, data channels, information channels related to a joint type-2 HARQ codebook for downlink and sidelink communications). Information may be passed on to other components of the device 2105. The receiver 2110 may utilize a single antenna or a set of multiple antennas.

The transmitter 2115 may provide a means for transmitting signals generated by other components of the device 2105. For example, the transmitter 2115 may transmit information such as packets, user data, control information, or any combination thereof associated with various information channels (e.g., control channels, data channels, information channels related to a joint type-2 HARQ codebook for downlink and sidelink communications). In some examples, the transmitter 2115 may be co-located with a receiver 2110 in a transceiver module. The transmitter 2115 may utilize a single antenna or a set of multiple antennas.

The device 2105, or various components thereof, may be an example of means for performing various aspects of a joint type-2 HARQ codebook for downlink and sidelink communications as described herein. For example, the communications manager 2120 may include an HARQ feedback report format manager 2125, a sidelink scheduling manager 2130, a downlink transmission manager 2135, a feedback report manager 2140, or any combination thereof. The communications manager 2120 may be an example of aspects of a communications manager 2020 as described herein. In some examples, the communications manager 2120, or various components thereof, may be configured to perform various operations (e.g., receiving, monitoring, transmitting) using or otherwise in cooperation with the receiver 2110, the transmitter 2115, or both. For example, the communications manager 2120 may receive information from the receiver 2110, send information to the transmitter 2115, or be integrated in combination with the receiver 2110, the transmitter 2115, or both to receive information, transmit information, or perform various other operations as described herein.

The communications manager 2120 may support wireless communications at a base station in accordance with examples as disclosed herein. The HARQ feedback report format manager 2125 may be configured as or otherwise support a means for transmitting, to a UE, a downlink control information message indicating a feedback report format for reporting HARQ feedback for sidelink transmissions and downlink transmissions. The sidelink scheduling manager 2130 may be configured as or otherwise support a means for transmitting, to the UE, scheduling information for a set of sidelink transmissions. The downlink transmission manager 2135 may be configured as or otherwise support a means for transmitting, to the UE, a set of downlink transmissions. The feedback report manager 2140 may be configured as or otherwise support a means for receiving, from the UE, a feedback report for at least one of the set of sidelink transmissions or the set of downlink transmissions based on the feedback report format.

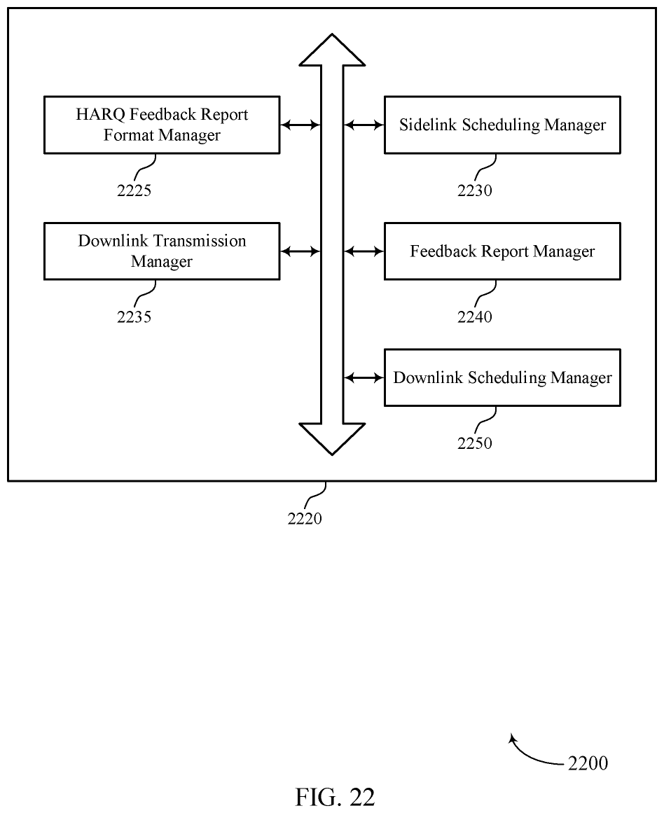

FIG. 22 shows a block diagram 2200 of a communications manager 2220 that supports a joint type-2 HARQ codebook for downlink and sidelink communications in accordance with aspects of the present disclosure. The communications manager 2220 may be an example of aspects of a communications manager 2020, a communications manager 2120, or both, as described herein. The communications manager 2220, or various components thereof, may be an example of means for performing various aspects of a joint type-2 HARQ codebook for downlink and sidelink communications as described herein. For example, the communications manager 2220 may include an HARQ feedback report format manager 2225, a sidelink scheduling manager 2230, a downlink transmission manager 2235, a feedback report manager 2240, a downlink scheduling manager 2250, or any combination thereof. Each of these components may communicate, directly or indirectly, with one another (e.g., via one or more buses).

The communications manager 2220 may support wireless communications at a base station in accordance with examples as disclosed herein. The HARQ feedback report format manager 2225 may be configured as or otherwise support a means for transmitting, to a UE, a downlink control information message indicating a feedback report format for reporting HARQ feedback for sidelink transmissions and downlink transmissions. The sidelink scheduling manager 2230 may be configured as or otherwise support a means for transmitting, to the UE, scheduling information for a set of sidelink transmissions. The downlink transmission manager 2235 may be configured as or otherwise support a means for transmitting, to the UE, a set of downlink transmissions. The feedback report manager 2240 may be configured as or otherwise support a means for receiving, from the UE, a feedback report for at least one of the set of sidelink transmissions or the set of downlink transmissions based on the feedback report format.

In some examples, the sidelink scheduling manager 2230 may be configured as or otherwise support a means for transmitting, to the UE, a second downlink control information message indicating scheduling information for the set of sidelink transmissions and a group index associated with the set of sidelink transmissions. In some examples, the sidelink scheduling manager 2230 may be configured as or otherwise support a means for transmitting, with the downlink control information message, an indication of scheduling information for the set of downlink transmissions and that the set of downlink transmissions is associated with the group index, and where the feedback report format includes a joint feedback report for reporting the set of sidelink transmissions associated with the group index and the set of downlink transmissions associated with the group index.

In some examples, an order for feedback for each transmission of the set of downlink transmissions and the set of sidelink transmissions in the joint feedback report is based on a transmission type for each transmission.

In some examples, the downlink scheduling manager 2250 may be configured as or otherwise support a means for transmitting, to the UE, a second downlink control information message indicating scheduling information for the set of downlink transmissions and a group index associated with the set of downlink transmissions. In some examples, the sidelink scheduling manager 2230 may be configured as or otherwise support a means for transmitting, with the downlink control information message, an indication of scheduling information for the set of sidelink transmissions and that the set of sidelink transmissions is associated with the group index, and where the feedback report format includes a joint feedback report for reporting feedback information for the set of sidelink transmissions associated with the group index and the set of downlink transmissions associated with the group index.

In some examples, an order for feedback for each transmission of the set of downlink transmissions and the set of sidelink transmissions in the joint feedback report is based on a transmission type for each transmission.

In some examples, the sidelink scheduling manager 2230 may be configured as or otherwise support a means for transmitting, to the UE, a second downlink control information message indicating scheduling information for the set of sidelink transmissions and a first group index associated with the set of sidelink transmissions. In some examples, the downlink scheduling manager 2250 may be configured as or otherwise support a means for transmitting, with the downlink control information message, an indication of scheduling information for the set of downlink transmissions and that the set of downlink transmissions is associated with a second group index, and where the feedback report format includes a joint feedback report for reporting feedback information for the set of sidelink transmissions associated with the first group index and the set of downlink transmissions associated with the second group index.

In some examples, an order for feedback for each transmission of the set of downlink transmissions and the set of sidelink transmissions in the joint feedback report is based on the first group index and the second group index.

In some examples, the downlink scheduling manager 2250 may be configured as or otherwise support a means for transmitting, to the UE, a second downlink control information message indicating scheduling information for the set of downlink transmissions and a first group index associated with the set of downlink transmissions. In some examples, the sidelink scheduling manager 2230 may be configured as or otherwise support a means for transmitting, with the downlink control information message, an indication of scheduling information for the set of sidelink transmissions and that the set of sidelink transmissions is associated with a second group index, and where the feedback report format includes a joint feedback report for reporting feedback information for the set of sidelink transmissions associated with the first group index and the set of downlink transmissions associated with the second group index.

In some examples, an order for feedback for each transmission of the set of downlink transmissions and the set of sidelink transmissions in the joint feedback report is based on the first group index and the second group index.

In some examples, the sidelink scheduling manager 2230 may be configured as or otherwise support a means for transmitting, to the UE, a third downlink control information message indicating scheduling information for a second set of sidelink transmissions and a third group index associated with the second set of sidelink transmissions. In some examples, the downlink scheduling manager 2250 may be configured as or otherwise support a means for transmitting, to the UE, a second downlink control information message indicating scheduling information for the set of downlink transmissions and a first group index associated with the set of downlink transmissions. In some examples, the sidelink scheduling manager 2230 may be configured as or otherwise support a means for transmitting, with the downlink control information message, an indication of scheduling information for the set of sidelink transmissions and that the set of sidelink transmissions is associated with the first group index, and where the feedback report format includes a joint feedback report for reporting the set of downlink transmissions associated with the first group index, the set of sidelink transmissions associated with the first group index, and the second set of sidelink transmissions associated with the third group index.

In some examples, the sidelink scheduling manager 2230 may be configured as or otherwise support a means for transmitting, to the UE, a third downlink control information message indicating scheduling information for a second set of sidelink transmissions and a third group index associated with the second set of sidelink transmissions. In some examples, the downlink scheduling manager 2250 may be configured as or otherwise support a means for transmitting, to the UE, a second downlink control information message indicating scheduling information for the set of downlink transmissions and a first group index associated with the set of downlink transmissions. In some examples, the sidelink scheduling manager 2230 may be configured as or otherwise support a means for transmitting, with the downlink control information message, an indication of scheduling information for the set of sidelink transmissions and that the set of sidelink transmissions is associated with a second group index, and where the feedback report format includes a joint feedback report for reporting the set of downlink transmissions associated with the first group index, the set of sidelink transmissions associated with the second group index, and the second set of sidelink transmissions associated with the third group index.

In some examples, the downlink scheduling manager 2250 may be configured as or otherwise support a means for transmitting, to the UE, a third downlink control information message indicating scheduling information for a second set of downlink transmissions and a third group index associated with the second set of downlink transmissions. In some examples, the downlink transmission manager 2235 may be configured as or otherwise support a means for transmitting, to the UE, the second set of downlink transmissions. In some examples, the sidelink scheduling manager 2230 may be configured as or otherwise support a means for transmitting, to the UE, a second downlink control information message indicating scheduling information for the set of sidelink transmissions and a first group index associated with the set of sidelink transmissions. In some examples, the downlink scheduling manager 2250 may be configured as or otherwise support a means for transmitting, with the downlink control information message, an indication of scheduling information for the set of downlink transmissions and that the set of downlink transmissions is associated with the first group index, and where the feedback report format includes a joint feedback report for reporting the set of sidelink transmissions associated with the first group index, the set of downlink transmissions associated with the first group index, and the second set of downlink transmissions associated with the third group index.

In some examples, the downlink scheduling manager 2250 may be configured as or otherwise support a means for transmitting, to the UE, a third downlink control information message indicating scheduling information for a second set of downlink transmissions and a third group index associated with the second set of downlink transmissions. In some examples, the downlink transmission manager 2235 may be configured as or otherwise support a means for transmitting, to the UE, the second set of downlink transmissions. In some examples, the sidelink scheduling manager 2230 may be configured as or otherwise support a means for transmitting, to the UE, a second downlink control information message indicating scheduling information for the set of sidelink transmissions and a first group index associated with the set of sidelink transmissions. In some examples, the downlink scheduling manager 2250 may be configured as or otherwise support a means for transmitting, with the downlink control information message, an indication of scheduling information for the set of downlink transmissions and that the set of downlink transmissions is associated with a second group index, and where the feedback report format includes a joint feedback report for reporting the set of sidelink transmissions associated with the first group index, the set of downlink transmissions associated with the second group index, and the second set of downlink transmissions associated with the third group index.

In some examples, the downlink scheduling manager 2250 may be configured as or otherwise support a means for transmitting, to the UE, a third downlink control information message indicating scheduling information for a second set of downlink transmissions and a third group index associated with the second set of downlink transmissions. In some examples, the downlink transmission manager 2235 may be configured as or otherwise support a means for transmitting, to the UE, the second set of downlink transmissions. In some examples, the sidelink scheduling manager 2230 may be configured as or otherwise support a means for transmitting, to the UE, a second downlink control information message indicating scheduling information for the set of downlink transmissions and a first group index associated with the set of downlink transmissions. In some examples, the sidelink scheduling manager 2230 may be configured as or otherwise support a means for transmitting, with the downlink control information message, an indication of scheduling information for the set of sidelink transmissions and that the set of sidelink transmissions is associated with the first group index, and where the feedback report format includes a joint feedback report for reporting the set of downlink transmissions associated with the first group index, the set of sidelink transmissions associated with the first group index, and the second set of downlink transmissions associated with the third group index.

In some examples, the sidelink scheduling manager 2230 may be configured as or otherwise support a means for transmitting, to the UE, a third downlink control information message indicating scheduling information for a second set of sidelink transmissions and a third group index associated with the second set of sidelink transmissions. In some examples, the sidelink scheduling manager 2230 may be configured as or otherwise support a means for transmitting, to the UE, a second downlink control information message indicating scheduling information for the set of sidelink transmissions and a first group index associated with the set of sidelink transmissions. In some examples, the downlink scheduling manager 2250 may be configured as or otherwise support a means for transmitting, with the downlink control information message, an indication of scheduling information for the set of downlink transmissions and that the set of downlink transmissions is associated with the first group index, and where the feedback report format includes a joint feedback report for reporting the set of sidelink transmissions associated with the first group index, the set of downlink transmissions associated with the first group index, and the second set of sidelink transmissions associated with the third group index.

In some examples, the sidelink scheduling manager 2230 may be configured as or otherwise support a means for transmitting, to the UE, a third downlink control information message indicating scheduling information for a second set of sidelink transmissions and a third group index associated with the second set of sidelink transmissions. In some examples, the downlink scheduling manager 2250 may be configured as or otherwise support a means for transmitting, to the UE, a fourth downlink control information message indicating scheduling information for a second set of downlink transmissions and a fourth group index associated with the second set of downlink transmissions. In some examples, the downlink transmission manager 2235 may be configured as or otherwise support a means for transmitting, to the UE, the second set of downlink transmissions. In some examples, the downlink scheduling manager 2250 may be configured as or otherwise support a means for transmitting, to the UE, a second downlink control information message information indicating scheduling information for the set of downlink transmissions and a first group index associated with the set of downlink transmissions. In some examples, the sidelink scheduling manager 2230 may be configured as or otherwise support a means for transmitting, with the downlink control information message, an indication of scheduling information for the set of sidelink transmissions and that the set of sidelink transmissions is associated with the first group index, and where the feedback report format includes a joint feedback report for reporting the set of downlink transmissions associated with the first group index, the set of sidelink transmissions associated with the first group index, the second set of sidelink transmissions associated with the third group index, and the second set of downlink transmissions associated with the fourth group index.

In some examples, an order for feedback for each transmission of the set of downlink transmissions, the set of sidelink transmissions, the second set of downlink transmissions, and the second set of sidelink transmissions in the joint feedback report is based on the first group index, the third group index, the fourth group index, and a transmission type for each transmission.

In some examples, the downlink scheduling manager 2250 may be configured as or otherwise support a means for transmitting, to the UE, a third downlink control information message indicating scheduling information for a second set of downlink transmissions and a third group index associated with the second set of downlink transmissions. In some examples, the downlink transmission manager 2235 may be configured as or otherwise support a means for transmitting, to the UE, the second set of downlink transmissions. In some examples, the sidelink scheduling manager 2230 may be configured as or otherwise support a means for transmitting, to the UE, a fourth downlink control information message indicating scheduling information for a second set of sidelink transmissions and a fourth group index associated with the second set of sidelink transmissions. In some examples, the sidelink scheduling manager 2230 may be configured as or otherwise support a means for transmitting, to the UE, a second downlink control information message indicating scheduling information for the set of sidelink transmissions and a first group index associated with the set of sidelink transmissions. In some examples, the downlink scheduling manager 2250 may be configured as or otherwise support a means for transmitting, with the downlink control information message, an indication of scheduling information for the set of downlink transmissions and that the set of downlink transmissions is associated with the first group index, and where the feedback report format includes a joint feedback report for reporting the set of sidelink transmissions associated with the first group index, the set of downlink transmissions associated with the first group index, the second set of downlink transmissions associated with the third group index, and the second set of sidelink transmissions associated with the fourth group index.

In some examples, an order for feedback for each transmission of the set of downlink transmissions, the set of sidelink transmissions, the second set of downlink transmissions, and the second set of sidelink transmissions in the joint feedback report is based on the first group index, the third group index, the fourth group index, and a transmission type for each transmission.

In some examples, the feedback report manager 2240 may be configured as or otherwise support a means for transmitting, with the downlink control information message, a set of bits indicating the feedback report format.

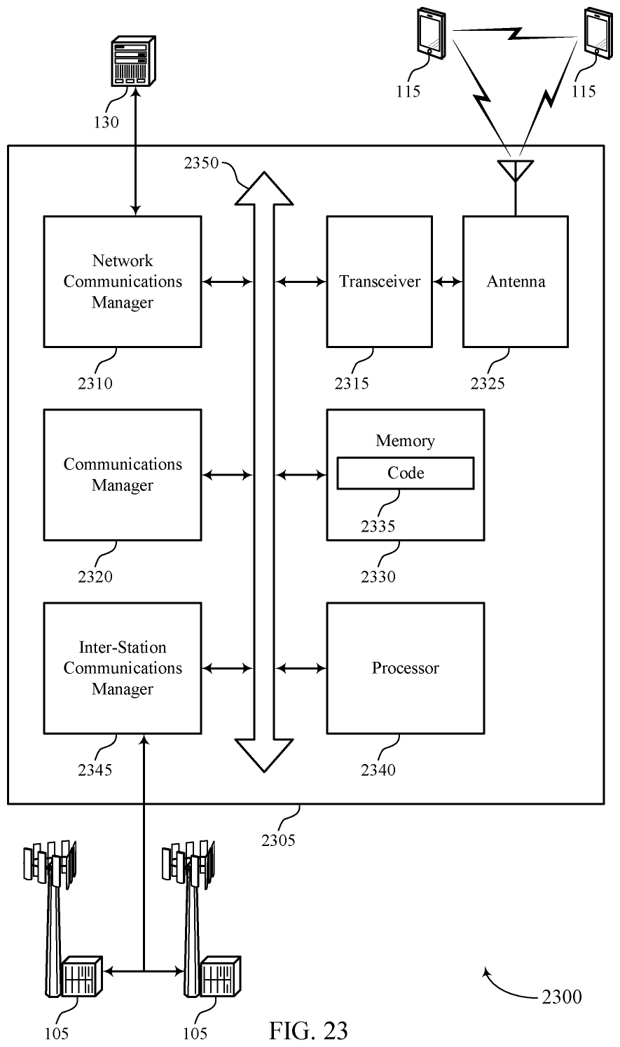

FIG. 23 shows a diagram of a system 2300 including a device 2305 that supports a joint type-2 HARQ codebook for downlink and sidelink communications in accordance with aspects of the present disclosure. The device 2305 may be an example of or include the components of a device 2005, a device 2105, or a base station 105 as described herein. The device 2305 may communicate wirelessly with one or more base stations 105, UEs 115, or any combination thereof. The device 2305 may include components for bi-directional voice and data communications including components for transmitting and receiving communications, such as a communications manager 2320, a network communications manager 2310, a transceiver 2315, an antenna 2325, a memory 2330, code 2335, a processor 2340, and an inter-station communications manager 2345. These components may be in electronic communication or otherwise coupled (e.g., operatively, communicatively, functionally, electronically, electrically) via one or more buses (e.g., a bus 2350).

The network communications manager 2310 may manage communications with a core network 130 (e.g., via one or more wired backhaul links). For example, the network communications manager 2310 may manage the transfer of data communications for client devices, such as one or more UEs 115.

In some cases, the device 2305 may include a single antenna 2325. However, in some other cases the device 2305 may have more than one antenna 2325, which may be capable of concurrently transmitting or receiving multiple wireless transmissions. The transceiver 2315 may communicate bi-directionally, via the one or more antennas 2325, wired, or wireless links as described herein. For example, the transceiver 2315 may represent a wireless transceiver and may communicate bi-directionally with another wireless transceiver. The transceiver 2315 may also include a modem to modulate the packets, to provide the modulated packets to one or more antennas 2325 for transmission, and to demodulate packets received from the one or more antennas 2325. The transceiver 2315, or the transceiver 2315 and one or more antennas 2325, may be an example of a transmitter 2015, a transmitter 2115, a receiver 2010, a receiver 2110, or any combination thereof or component thereof, as described herein.

The memory 2330 may include RAM and ROM. The memory 2330 may store computer-readable, computer-executable code 2335 including instructions that, when executed by the processor 2340, cause the device 2305 to perform various functions described herein. The code 2335 may be stored in a non-transitory computer-readable medium such as system memory or another type of memory. In some cases, the code 2335 may not be directly executable by the processor 2340 but may cause a computer (e.g., when compiled and executed) to perform functions described herein. In some cases, the memory 2330 may contain, among other things, a BIOS which may control basic hardware or software operation such as the interaction with peripheral components or devices.

The processor 2340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 2340 may be configured to operate a memory array using a memory controller. In some other cases, a memory controller may be integrated into the processor 2340. The processor 2340 may be configured to execute computer-readable instructions stored in a memory (e.g., the memory 2330) to cause the device 2305 to perform various functions (e.g., functions or tasks supporting joint type-2 HARQ codebooks for downlink and sidelink communications). For example, the device 2305 or a component of the device 2305 may include a processor 2340 and memory 2330 coupled to the processor 2340, the processor 2340 and memory 2330 configured to perform various functions described herein.

The inter-station communications manager 2345 may manage communications with other base stations 105, and may include a controller or scheduler for controlling communications with UEs 115 in cooperation with other base stations 105. For example, the inter-station communications manager 2345 may coordinate scheduling for transmissions to UEs 115 for various interference mitigation techniques such as beamforming or joint transmission. In some examples, the inter-station communications manager 2345 may provide an X2 interface within an LTE/LTE-A wireless communications network technology to provide communication between base stations 105.

The communications manager 2320 may support wireless communications at a base station in accordance with examples as disclosed herein. For example, the communications manager 2320 may be configured as or otherwise support a means for transmitting, to a UE, a downlink control information message indicating a feedback report format for reporting HARQ feedback for sidelink transmissions and downlink transmissions. The communications manager 2320 may be configured as or otherwise support a means for transmitting, to the UE, scheduling information for a set of sidelink transmissions. The communications manager 2320 may be configured as or otherwise support a means for transmitting, to the UE, a set of downlink transmissions. The communications manager 2320 may be configured as or otherwise support a means for receiving, from the UE, a feedback report for at least one of the set of sidelink transmissions or the set of downlink transmissions based on the feedback report format.

By including or configuring the communications manager 2320 in accordance with examples as described herein, the device 2305 may support techniques for improved communication reliability, more efficient utilization of communication resources, and improved coordination between devices by facilitating joint HARQ feedback for sidelink and downlink transmissions.

In some examples, the communications manager 2320 may be configured to perform various operations (e.g., receiving, monitoring, transmitting) using or otherwise in cooperation with the transceiver 2315, the one or more antennas 2325, or any combination thereof. Although the communications manager 2320 is illustrated as a separate component, in some examples, one or more functions described with reference to the communications manager 2320 may be supported by or performed by the processor 2340, the memory 2330, the code 2335, or any combination thereof. For example, the code 2335 may include instructions executable by the processor 2340 to cause the device 2305 to perform various aspects of a joint type-2 HARQ codebook for downlink and sidelink communications as described herein, or the processor 2340 and the memory 2330 may be otherwise configured to perform or support such operations.

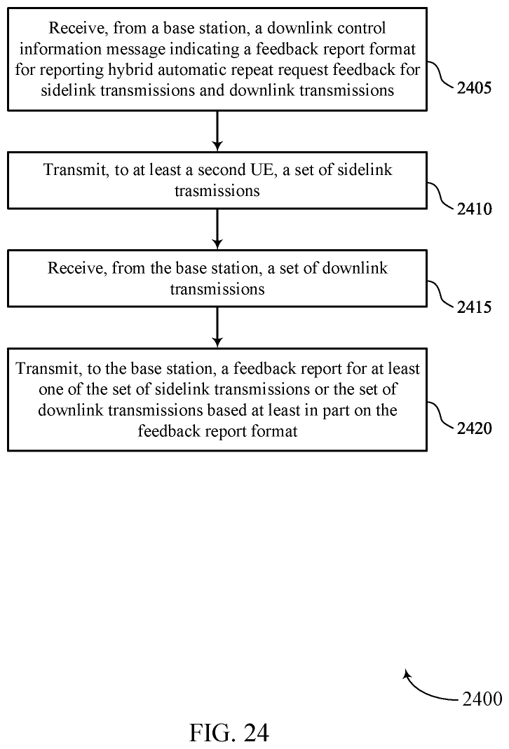

FIG. 24 shows a flowchart illustrating a method 2400 that supports a joint type-2 HARQ codebook for downlink and sidelink communications in accordance with aspects of the present disclosure. The operations of the method 2400 may be implemented by a UE or its components as described herein. For example, the operations of the method 2400 may be performed by a UE 115 as described with reference to FIGS. 1 through 19. In some examples, a UE may execute a set of instructions to control the functional elements of the UE to perform the described functions. Additionally or alternatively, the UE may perform aspects of the described functions using special-purpose hardware.

At 2405, the method may include receiving, from a base station, a downlink control information message indicating a feedback report format for reporting HARQ feedback for sidelink transmissions and downlink transmissions. The operations of 2405 may be performed in accordance with examples as disclosed herein. In some examples, aspects of the operations of 2405 may be performed by an HARQ feedback report format manager 1825 as described with reference to FIG. 18.

At 2410, the method may include transmitting, to at least a second UE, a set of sidelink transmissions. The operations of 2410 may be performed in accordance with examples as disclosed herein. In some examples, aspects of the operations of 2410 may be performed by a sidelink transmission manager 1830 as described with reference to FIG. 18.

At 2415, the method may include receiving, from the base station, a set of downlink transmissions. The operations of 2415 may be performed in accordance with examples as disclosed herein. In some examples, aspects of the operations of 2415 may be performed by a downlink reception manager 1835 as described with reference to FIG. 18.

At 2420, the method may include transmit, to the base station, a feedback report for at least one of the set of sidelink transmissions or the set of downlink transmissions based on the feedback report format. The operations of 2420 may be performed in accordance with examples as disclosed herein. In some examples, aspects of the operations of 2420 may be performed by a feedback report manager 1840 as described with reference to FIG. 18.

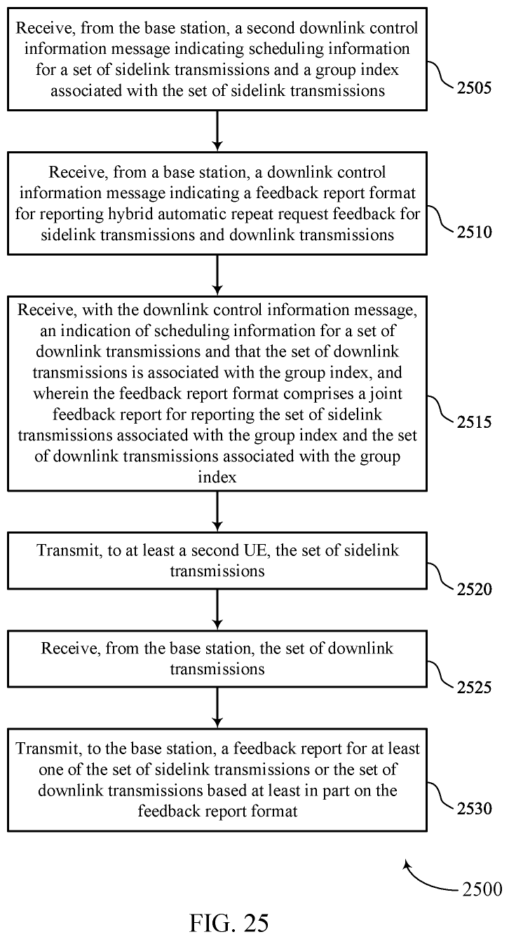

FIG. 25 shows a flowchart illustrating a method 2500 that supports a joint type-2 HARQ codebook for downlink and sidelink communications in accordance with aspects of the present disclosure. The operations of the method 2500 may be implemented by a UE or its components as described herein. For example, the operations of the method 2500 may be performed by a UE 115 as described with reference to FIGS. 1 through 19. In some examples, a UE may execute a set of instructions to control the functional elements of the UE to perform the described functions. Additionally or alternatively, the UE may perform aspects of the described functions using special-purpose hardware.

At 2505, the method may include receiving, from the base station, a second downlink control information message indicating scheduling information for a set of sidelink transmissions and a group index associated with the set of sidelink transmissions. The operations of 2505 may be performed in accordance with examples as disclosed herein. In some examples, aspects of the operations of 2505 may be performed by a sidelink scheduling manager 1845 as described with reference to FIG. 18.

At 2510, the method may include receiving, from a base station, a downlink control information message indicating a feedback report format for reporting HARQ feedback for sidelink transmissions and downlink transmissions. The operations of 2510 may be performed in accordance with examples as disclosed herein. In some examples, aspects of the operations of 2510 may be performed by an HARQ feedback report format manager 1825 as described with reference to FIG. 18.

At 2515, the method may include receiving, with the downlink control information message, an indication of scheduling information for a set of downlink transmissions and that the set of downlink transmissions is associated with the group index, and where the feedback report format includes a joint feedback report for reporting the set of sidelink transmissions associated with the group index and the set of downlink transmissions associated with the group index. The operations of 2515 may be performed in accordance with examples as disclosed herein. In some examples, aspects of the operations of 2515 may be performed by a downlink scheduling manager 1850 as described with reference to FIG. 18.

At 2520, the method may include transmitting, to at least a second UE, a set of sidelink transmissions. The operations of 2520 may be performed in accordance with examples as disclosed herein. In some examples, aspects of the operations of 2520 may be performed by a sidelink transmission manager 1830 as described with reference to FIG. 18.

At 2525, the method may include receiving, from the base station, a set of downlink transmissions. The operations of 2525 may be performed in accordance with examples as disclosed herein. In some examples, aspects of the operations of 2525 may be performed by a downlink reception manager 1835 as described with reference to FIG. 18.

At 2530, the method may include transmit, to the base station, a feedback report for at least one of the set of sidelink transmissions or the set of downlink transmissions based on the feedback report format. The operations of 2530 may be performed in accordance with examples as disclosed herein. In some examples, aspects of the operations of 2530 may be performed by a feedback report manager 1840 as described with reference to FIG. 18.

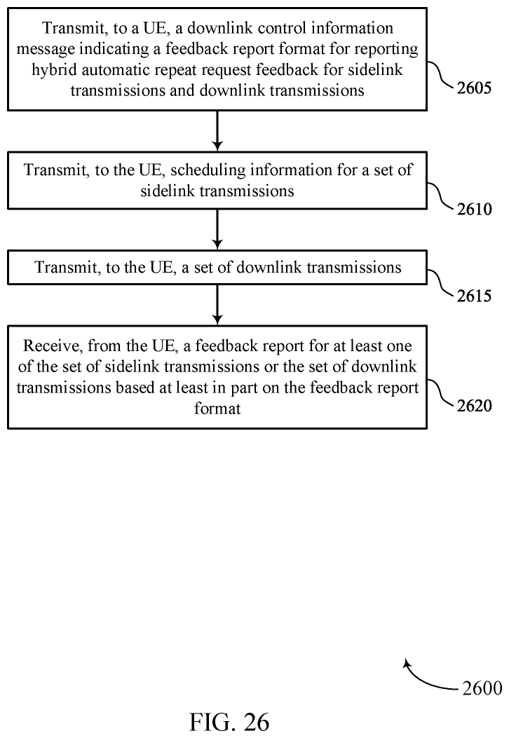

FIG. 26 shows a flowchart illustrating a method 2600 that supports a joint type-2 HARQ codebook for downlink and sidelink communications in accordance with aspects of the present disclosure. The operations of the method 2600 may be implemented by a base station or its components as described herein. For example, the operations of the method 2600 may be performed by a base station 105 as described with reference to FIGS. 1 through 15 and 20 through 23. In some examples, a base station may execute a set of instructions to control the functional elements of the base station to perform the described functions. Additionally or alternatively, the base station may perform aspects of the described functions using special-purpose hardware.

At 2605, the method may include transmitting, to a UE, a downlink control information message indicating a feedback report format for reporting HARQ feedback for sidelink transmissions and downlink transmissions. The operations of 2605 may be performed in accordance with examples as disclosed herein. In some examples, aspects of the operations of 2605 may be performed by an HARQ feedback report format manager 2225 as described with reference to FIG. 22.

At 2610, the method may include transmitting, to the UE, scheduling information for a set of sidelink transmissions. The operations of 2610 may be performed in accordance with examples as disclosed herein. In some examples, aspects of the operations of 2610 may be performed by a sidelink scheduling manager 2230 as described with reference to FIG. 22.

At 2615, the method may include transmitting, to the UE, a set of downlink transmissions. The operations of 2615 may be performed in accordance with examples as disclosed herein. In some examples, aspects of the operations of 2615 may be performed by a downlink transmission manager 2235 as described with reference to FIG. 22.

At 2620, the method may include receiving, from the UE, a feedback report for at least one of the set of sidelink transmissions or the set of downlink transmissions based on the feedback report format. The operations of 2620 may be performed in accordance with examples as disclosed herein. In some examples, aspects of the operations of 2620 may be performed by a feedback report manager 2240 as described with reference to FIG. 22.

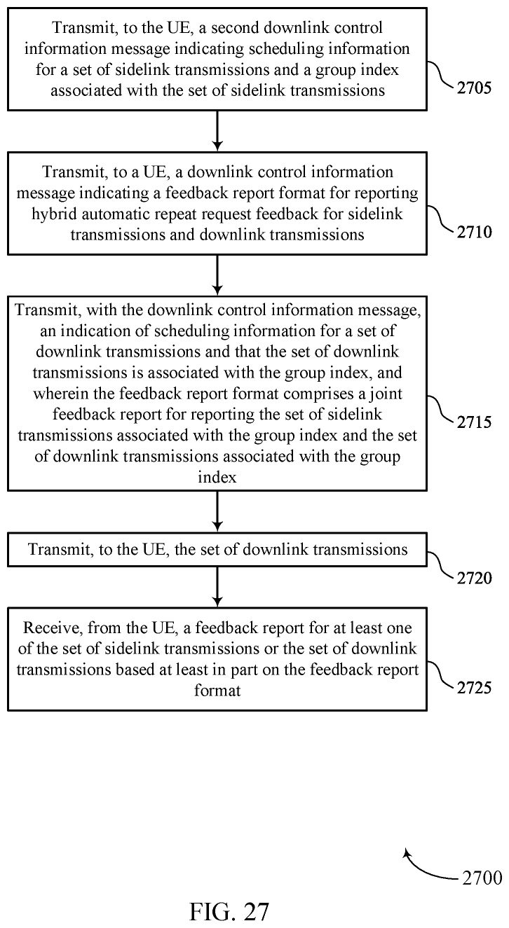

FIG. 27 shows a flowchart illustrating a method 2700 that supports a joint type-2 HARQ codebook for downlink and sidelink communications in accordance with aspects of the present disclosure. The operations of the method 2700 may be implemented by a base station or its components as described herein. For example, the operations of the method 2700 may be performed by a base station 105 as described with reference to FIGS. 1 through 15 and 20 through 23. In some examples, a base station may execute a set of instructions to control the functional elements of the base station to perform the described functions. Additionally or alternatively, the base station may perform aspects of the described functions using special-purpose hardware.

At 2705, the method may include transmitting, to the UE, a second downlink control information message indicating scheduling information for a set of sidelink transmissions and a group index associated with the set of sidelink transmissions. The operations of 2705 may be performed in accordance with examples as disclosed herein. In some examples, aspects of the operations of 2705 may be performed by a sidelink scheduling manager 2230 as described with reference to FIG. 22.

At 2710, the method may include transmitting, to a UE, a downlink control information message indicating a feedback report format for reporting HARQ feedback for sidelink transmissions and downlink transmissions. The operations of 2710 may be performed in accordance with examples as disclosed herein. In some examples, aspects of the operations of 2710 may be performed by an HARQ feedback report format manager 2225 as described with reference to FIG. 22.

At 2715, the method may include transmitting, with the downlink control information message, an indication of scheduling information for a set of downlink transmissions and that the set of downlink transmissions is associated with the group index, and where the feedback report format includes a joint feedback report for reporting the set of sidelink transmissions associated with the group index and the set of downlink transmissions associated with the group index. The operations of 2715 may be performed in accordance with examples as disclosed herein. In some examples, aspects of the operations of 2715 may be performed by the sidelink scheduling manager 2230 as described with reference to FIG. 22.

At 2720, the method may include transmitting, to the UE, the set of downlink transmissions. The operations of 2720 may be performed in accordance with examples as disclosed herein. In some examples, aspects of the operations of 2720 may be performed by a downlink transmission manager 2235 as described with reference to FIG. 22.

At 2725, the method may include receiving, from the UE, a feedback report for at least one of the set of sidelink transmissions or the set of downlink transmissions based on the feedback report format. The operations of 2725 may be performed in accordance with examples as disclosed herein. In some examples, aspects of the operations of 2725 may be performed by a feedback report manager 2240 as described with reference to FIG. 22.

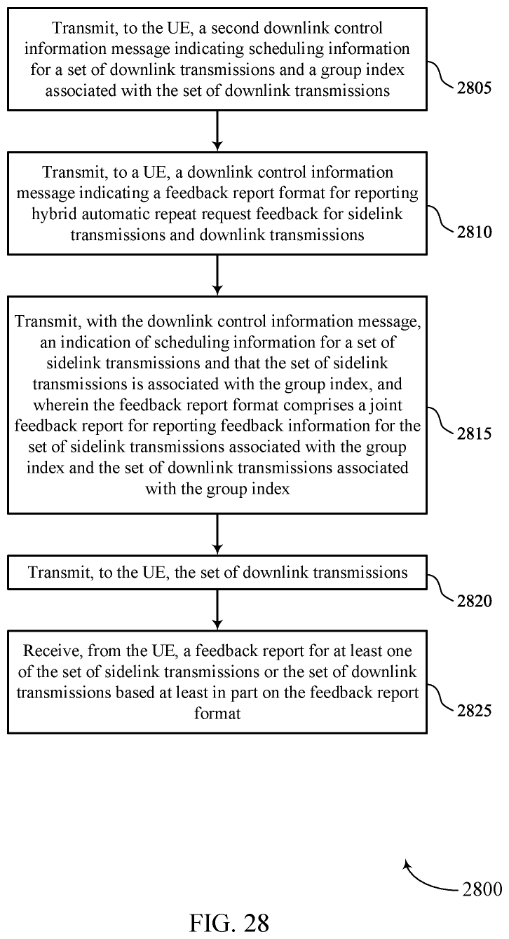

FIG. 28 shows a flowchart illustrating a method 2800 that supports a joint type-2 HARQ codebook for downlink and sidelink communications in accordance with aspects of the present disclosure. The operations of the method 2800 may be implemented by a base station or its components as described herein. For example, the operations of the method 2800 may be performed by a base station 105 as described with reference to FIGS. 1 through 15 and 20 through 23. In some examples, a base station may execute a set of instructions to control the functional elements of the base station to perform the described functions. Additionally or alternatively, the base station may perform aspects of the described functions using special-purpose hardware.

At 2805, the method may include transmitting, to the UE, a second downlink control information message indicating scheduling information for a set of downlink transmissions and a group index associated with the set of downlink transmissions. The operations of 2805 may be performed in accordance with examples as disclosed herein. In some examples, aspects of the operations of 2805 may be performed by a downlink scheduling manager 2250 as described with reference to FIG. 22.

At 2810, the method may include transmitting, to a UE, a downlink control information message indicating a feedback report format for reporting HARQ feedback for sidelink transmissions and downlink transmissions. The operations of 2810 may be performed in accordance with examples as disclosed herein. In some examples, aspects of the operations of 2810 may be performed by an HARQ feedback report format manager 2225 as described with reference to FIG. 22.

At 2815, the method may include transmitting, with the downlink control information message, an indication of scheduling information for the set of sidelink transmissions and that the set of sidelink transmissions is associated with the group index, and where the feedback report format includes a joint feedback report for reporting feedback information for the set of sidelink transmissions associated with the group index and the set of downlink transmissions associated with the group index. The operations of 2815 may be performed in accordance with examples as disclosed herein. In some examples, aspects of the operations of 2815 may be performed by a sidelink scheduling manager 2230 as described with reference to FIG. 22.

At 2820, the method may include transmitting, to the UE, a set of downlink transmissions. The operations of 2820 may be performed in accordance with examples as disclosed herein. In some examples, aspects of the operations of 2820 may be performed by a downlink transmission manager 2235 as described with reference to FIG. 22.

At 2825, the method may include receiving, from the UE, a feedback report for at least one of the set of sidelink transmissions or the set of downlink transmissions based on the feedback report format. The operations of 2825 may be performed in accordance with examples as disclosed herein. In some examples, aspects of the operations of 2825 may be performed by a feedback report manager 2240 as described with reference to FIG. 22.

The following provides an overview of aspects of the present disclosure:

Aspect 1: A method for wireless communications at a first UE, comprising: receiving, from a base station, a downlink control information message indicating a feedback report format for reporting hybrid automatic repeat request feedback for sidelink transmissions and downlink transmissions; transmitting, to at least a second UE, a set of sidelink transmissions; receiving, from the base station, a set of downlink transmissions; transmit, to the base station, a feedback report for at least one of the set of sidelink transmissions or the set of downlink transmissions based at least in part on the feedback report format.

Aspect 2: The method of aspect 1, further comprising: receiving, from the base station, a second downlink control information message indicating scheduling information for the set of sidelink transmissions and a group index associated with the set of sidelink transmissions; and receiving, with the downlink control information message, an indication of scheduling information for the set of downlink transmissions and that the set of downlink transmissions is associated with the group index, and wherein the feedback report format comprises a joint feedback report for reporting the set of sidelink transmissions associated with the group index and the set of downlink transmissions associated with the group index.

Aspect 3: The method of aspect 2, wherein an order for feedback for each transmission of the set of downlink transmissions and the set of sidelink transmissions in the joint feedback report is based at least in part on a transmission type for each transmission.

Aspect 4: The method of any of aspects 1 through 3, further comprising: receiving, from the base station, a second downlink control information message indicating scheduling information for the set of downlink transmissions and a group index associated with the set of downlink transmissions; and receiving, with the downlink control information message, an indication of scheduling information for the set of sidelink transmissions and that the set of sidelink transmissions is associated with the group index, and wherein the feedback report format comprises a joint feedback report for reporting feedback information for the set of sidelink transmissions associated with the group index and the set of downlink transmissions associated with the group index.

Aspect 5: The method of aspect 4, wherein an order for feedback for each transmission of the set of downlink transmissions and the set of sidelink transmissions in the joint feedback report is based at least in part on a transmission type for each transmission.

Aspect 6: The method of any of aspects 1 through 5, further comprising: receiving, from the base station, a second downlink control information message indicating scheduling information for the set of sidelink transmissions and a first group index associated with the set of sidelink transmissions; and receiving, with the downlink control information message, an indication of scheduling information for the set of downlink transmissions and that the set of downlink transmissions is associated with a second group index, and wherein the feedback report format comprises a joint feedback report for reporting feedback information for the set of sidelink transmissions associated with the first group index and the set of downlink transmissions associated with the second group index.

Aspect 7: The method of aspect 6, wherein an order for feedback for each transmission of the set of downlink transmissions and the set of sidelink transmissions in the joint feedback report is based at least in part on the first group index and the second group index.

Aspect 8: The method of any of aspects 1 through 7, further comprising: receiving, from the base station, a second downlink control information message indicating scheduling information for the set of downlink transmissions and a first group index associated with the set of downlink transmissions; and receiving, with the downlink control information message, an indication of scheduling information for the set of sidelink transmissions and that the set of sidelink transmissions is associated with a second group index, and wherein the feedback report format comprises a joint feedback report for reporting feedback information for the set of sidelink transmissions associated with the first group index and the set of downlink transmissions associated with the second group index.

Aspect 9: The method of aspect 8, wherein an order for feedback for each transmission of the set of downlink transmissions and the set of sidelink transmissions in the joint feedback report is based at least in part on the first group index and the second group index.

Aspect 10: The method of any of aspects 1 through 9, further comprising: receiving, from the base station, a third downlink control information message indicating scheduling information for a second set of sidelink transmissions and a third group index associated with the second set of sidelink transmissions; transmitting, to at least the second UE, the second set of sidelink transmissions; receiving, from the base station, a second downlink control information message indicating scheduling information for the set of downlink transmissions and a first group index associated with the set of downlink transmissions; and receiving, with the downlink control information message, an indication of scheduling information for the set of sidelink transmissions and that the set of sidelink transmissions is associated with the first group index, and wherein the feedback report format comprises a joint feedback report for reporting the set of downlink transmissions associated with the first group index, the set of sidelink transmissions associated with the first group index, and the second set of sidelink transmissions associated with the third group index.

Aspect 11: The method of any of aspects 1 through 10, further comprising: receiving, from the base station, a third downlink control information message indicating scheduling information for a second set of sidelink transmissions and a third group index associated with the second set of sidelink transmissions; transmitting, to at least the second UE, the second set of sidelink transmissions; receiving, from the base station, a second downlink control information message indicating scheduling information for the set of downlink transmissions and a first group index associated with the set of downlink transmissions; and receiving, with the downlink control information message, an indication of scheduling information for the set of sidelink transmissions and that the set of sidelink transmissions is associated with a second group index, and wherein the feedback report format comprises a joint feedback report for reporting the set of downlink transmissions associated with the first group index, the set of sidelink transmissions associated with the second group index, and the second set of sidelink transmissions associated with the third group index.

Aspect 12: The method of any of aspects 1 through 11, further comprising: receiving, from the base station, a third downlink control information message indicating scheduling information for a second set of downlink transmissions and a third group index associated with the second set of downlink transmissions; receiving, from the base station, the second set of downlink transmissions; receiving, from the base station, a second downlink control information message indicating scheduling information for the set of sidelink transmissions and a first group index associated with the set of sidelink transmissions; and receiving, with the downlink control information message, an indication of scheduling information for the set of downlink transmissions and that the set of downlink transmissions is associated with the first group index, and wherein the feedback report format comprises a joint feedback report for reporting the set of sidelink transmissions associated with the first group index, the set of downlink transmissions associated with the first group index, and the second set of downlink transmissions associated with the third group index.

Aspect 13: The method of any of aspects 1 through 12, further comprising: receiving, from the base station, a third downlink control information message indicating scheduling information for a second set of downlink transmissions and a third group index associated with the second set of downlink transmissions; receiving, from the base station, the second set of downlink transmissions; receiving, from the base station, a second downlink control information message indicating scheduling information for the set of sidelink transmissions and a first group index associated with the set of sidelink transmissions; and receiving, with the downlink control information message, an indication of scheduling information for the set of downlink transmissions and that the set of downlink transmissions is associated with a second group index, and wherein the feedback report format comprises a joint feedback report for reporting the set of sidelink transmissions associated with the first group index, the set of downlink transmissions associated with the second group index, and the second set of downlink transmissions associated with the third group index.

Aspect 14: The method of any of aspects 1 through 13, further comprising: receiving, from the base station, a third downlink control information message indicating scheduling information for a second set of downlink transmissions and a third group index associated with the second set of downlink transmissions; receiving, from the base station, the second set of downlink transmissions; receiving, from the base station, a second downlink control information message indicating scheduling information for the set of downlink transmissions and a first group index associated with the set of downlink transmissions; and receiving, with the downlink control information message, an indication of scheduling information for the set of sidelink transmissions and that the set of sidelink transmissions is associated with the first group index, and wherein the feedback report format comprises a joint feedback report for reporting the set of downlink transmissions associated with the first group index, the set of sidelink transmissions associated with the first group index, and the second set of downlink transmissions associated with the third group index.

Aspect 15: The method of any of aspects 1 through 14, further comprising: receiving, from the base station, a third downlink control information message indicating scheduling information for a second set of sidelink transmissions and a third group index associated with the second set of sidelink transmissions; transmitting, to at least the second UE, the second set of sidelink transmissions; receiving, from the base station, a second downlink control information message indicating scheduling information for the set of sidelink transmissions and a first group index associated with the set of sidelink transmissions; and receiving, with the downlink control information message, an indication of scheduling information for the set of downlink transmissions and that the set of downlink transmissions is associated with the first group index, and wherein the feedback report format comprises a joint feedback report for reporting the set of sidelink transmissions associated with the first group index, the set of downlink transmissions associated with the first group index, and the second set of sidelink transmissions associated with the third group index.

Aspect 16: The method of any of aspects 1 through 15, further comprising: receiving, from the base station, a third downlink control information message indicating scheduling information for a second set of sidelink transmissions and a third group index associated with the second set of sidelink transmissions; transmitting, to at least the second UE, the second set of sidelink transmissions; receiving, from the base station, a fourth downlink control information message indicating scheduling information for a second set of downlink transmissions and a fourth group index associated with the second set of downlink transmissions; receiving, from the base station, the second set of downlink transmissions; receiving, from the base station, a second downlink control information message indicating scheduling information for the set of downlink transmissions and a first group index associated with the set of downlink transmissions; and receiving, with the downlink control information message, an indication of scheduling information for the set of sidelink transmissions and that the set of sidelink transmissions is associated with the first group index, and wherein the feedback report format comprises a joint feedback report for reporting the set of downlink transmissions associated with the first group index, the set of sidelink transmissions associated with the first group index, the second set of sidelink transmissions associated with the third group index, and the second set of downlink transmissions associated with the fourth group index.

Aspect 17: The method of aspect 16, wherein an order for feedback for each transmission of the set of downlink transmissions, the set of sidelink transmissions, the second set of downlink transmissions, and the second set of sidelink transmissions in the joint feedback report is based at least in part on the first group index, the third group index, the fourth group index, and a transmission type for each transmission.

Aspect 18: The method of any of aspects 1 through 17, further comprising: receiving, from the base station, a third downlink control information message indicating scheduling information for a second set of downlink transmissions and a third group index associated with the second set of downlink transmissions; receiving, from the base station, the second set of downlink transmissions; receiving, from the base station, a fourth downlink control information message indicating scheduling information for a second set of sidelink transmissions and a fourth group index associated with the second set of sidelink transmissions; transmitting, to at least the second UE, the second set of sidelink transmissions; receiving, from the base station, a second downlink control information message indicating scheduling information for the set of sidelink transmissions and a first group index associated with the set of sidelink transmissions; and receiving, with the downlink control information message, an indication of scheduling information for the set of downlink transmissions and that the set of downlink transmissions is associated with the first group index, and wherein the feedback report format comprises a joint feedback report for reporting the set of sidelink transmissions associated with the first group index, the set of downlink transmissions associated with the first group index, the second set of downlink transmissions associated with the third group index, and the second set of sidelink transmissions associated with the fourth group index.

Aspect 19: The method of aspect 18, wherein an order for feedback for each transmission of the set of downlink transmissions, the set of sidelink transmissions, the second set of downlink transmissions, and the second set of sidelink transmissions in the joint feedback report is based at least in part on the first group index, the third group index, the fourth group index, and a transmission type for each transmission.

Aspect 20: The method of any of aspects 1 through 19, further comprising: receiving, with the downlink control information message, a set of bits indicating the feedback report format.

Aspect 21: A method for wireless communications at a base station, comprising: transmitting, to a UE, a downlink control information message indicating a feedback report format for reporting hybrid automatic repeat request feedback for sidelink transmissions and downlink transmissions; transmitting, to the UE, scheduling information for a set of sidelink transmissions; transmitting, to the UE, a set of downlink transmissions; receiving, from the UE, a feedback report for at least one of the set of sidelink transmissions or the set of downlink transmissions based at least in part on the feedback report format.

Aspect 22: The method of aspect 21, further comprising: transmitting, to the UE, a second downlink control information message indicating scheduling information for the set of sidelink transmissions and a group index associated with the set of sidelink transmissions; and transmitting, with the downlink control information message, an indication of scheduling information for the set of downlink transmissions and that the set of downlink transmissions is associated with the group index, and wherein the feedback report format comprises a joint feedback report for reporting the set of sidelink transmissions associated with the group index and the set of downlink transmissions associated with the group index.

Aspect 23: The method of aspect 22, wherein an order for feedback for each transmission of the set of downlink transmissions and the set of sidelink transmissions in the joint feedback report is based at least in part on a transmission type for each transmission.

Aspect 24: The method of any of aspects 21 through 23, further comprising: transmitting, to the UE, a second downlink control information message indicating scheduling information for the set of downlink transmissions and a group index associated with the set of downlink transmissions; and transmitting, with the downlink control information message, an indication of scheduling information for the set of sidelink transmissions and that the set of sidelink transmissions is associated with the group index, and wherein the feedback report format comprises a joint feedback report for reporting feedback information for the set of sidelink transmissions associated with the group index and the set of downlink transmissions associated with the group index.

Aspect 25: The method of aspect 24, wherein an order for feedback for each transmission of the set of downlink transmissions and the set of sidelink transmissions in the joint feedback report is based at least in part on a transmission type for each transmission.

Aspect 26: The method of any of aspects 21 through 25, further comprising: transmitting, to the UE, a second downlink control information message indicating scheduling information for the set of sidelink transmissions and a first group index associated with the set of sidelink transmissions; and transmitting, with the downlink control information message, an indication of scheduling information for the set of downlink transmissions and that the set of downlink transmissions is associated with a second group index, and wherein the feedback report format comprises a joint feedback report for reporting feedback information for the set of sidelink transmissions associated with the first group index and the set of downlink transmissions associated with the second group index.

Aspect 27: The method of aspect 26, wherein an order for feedback for each transmission of the set of downlink transmissions and the set of sidelink transmissions in the joint feedback report is based at least in part on the first group index and the second group index.

Aspect 28: The method of any of aspects 21 through 27, further comprising: transmitting, to the UE, a second downlink control information message indicating scheduling information for the set of downlink transmissions and a first group index associated with the set of downlink transmissions; and transmitting, with the downlink control information message, an indication of scheduling information for the set of sidelink transmissions and that the set of sidelink transmissions is associated with a second group index, and wherein the feedback report format comprises a joint feedback report for reporting feedback information for the set of sidelink transmissions associated with the first group index and the set of downlink transmissions associated with the second group index.

Aspect 29: The method of aspect 28, wherein an order for feedback for each transmission of the set of downlink transmissions and the set of sidelink transmissions in the joint feedback report is based at least in part on the first group index and the second group index.

Aspect 30: The method of any of aspects 21 through 29, further comprising: transmitting, to the UE, a third downlink control information message indicating scheduling information for a second set of sidelink transmissions and a third group index associated with the second set of sidelink transmissions; transmitting, to the UE, a second downlink control information message indicating scheduling information for the set of downlink transmissions and a first group index associated with the set of downlink transmissions; and transmitting, with the downlink control information message, an indication of scheduling information for the set of sidelink transmissions and that the set of sidelink transmissions is associated with the first group index, and wherein the feedback report format comprises a joint feedback report for reporting the set of downlink transmissions associated with the first group index, the set of sidelink transmissions associated with the first group index, and the second set of sidelink transmissions associated with the third group index.

Aspect 31: The method of any of aspects 21 through 30, further comprising: transmitting, to the UE, a third downlink control information message indicating scheduling information for a second set of sidelink transmissions and a third group index associated with the second set of sidelink transmissions; transmitting, to the UE, a second downlink control information message indicating scheduling information for the set of downlink transmissions and a first group index associated with the set of downlink transmissions; and transmitting, with the downlink control information message, an indication of scheduling information for the set of sidelink transmissions and that the set of sidelink transmissions is associated with a second group index, and wherein the feedback report format comprises a joint feedback report for reporting the set of downlink transmissions associated with the first group index, the set of sidelink transmissions associated with the second group index, and the second set of sidelink transmissions associated with the third group index.

Aspect 32: The method of any of aspects 21 through 31, further comprising: transmitting, to the UE, a third downlink control information message indicating scheduling information for a second set of downlink transmissions and a third group index associated with the second set of downlink transmissions; transmitting, to the UE, the second set of downlink transmissions; transmitting, to the UE, a second downlink control information message indicating scheduling information for the set of sidelink transmissions and a first group index associated with the set of sidelink transmissions; and transmitting, with the downlink control information message, an indication of scheduling information for the set of downlink transmissions and that the set of downlink transmissions is associated with the first group index, and wherein the feedback report format comprises a joint feedback report for reporting the set of sidelink transmissions associated with the first group index, the set of downlink transmissions associated with the first group index, and the second set of downlink transmissions associated with the third group index.

Aspect 33: The method of any of aspects 21 through 32, further comprising: transmitting, to the UE, a third downlink control information message indicating scheduling information for a second set of downlink transmissions and a third group index associated with the second set of downlink transmissions; transmitting, to the UE, the second set of downlink transmissions; transmitting, to the UE, a second downlink control information message indicating scheduling information for the set of sidelink transmissions and a first group index associated with the set of sidelink transmissions; and transmitting, with the downlink control information message, an indication of scheduling information for the set of downlink transmissions and that the set of downlink transmissions is associated with a second group index, and wherein the feedback report format comprises a joint feedback report for reporting the set of sidelink transmissions associated with the first group index, the set of downlink transmissions associated with the second group index, and the second set of downlink transmissions associated with the third group index.

Aspect 34: The method of any of aspects 21 through 33, further comprising: transmitting, to the UE, a third downlink control information message indicating scheduling information for a second set of downlink transmissions and a third group index associated with the second set of downlink transmissions; transmitting, to the UE, the second set of downlink transmissions; transmitting, to the UE, a second downlink control information message indicating scheduling information for the set of downlink transmissions and a first group index associated with the set of downlink transmissions; and transmitting, with the downlink control information message, an indication of scheduling information for the set of sidelink transmissions and that the set of sidelink transmissions is associated with the first group index, and wherein the feedback report format comprises a joint feedback report for reporting the set of downlink transmissions associated with the first group index, the set of sidelink transmissions associated with the first group index, and the second set of downlink transmissions associated with the third group index.

Aspect 35: The method of any of aspects 21 through 34, further comprising: transmitting, to the UE, a third downlink control information message indicating scheduling information for a second set of sidelink transmissions and a third group index associated with the second set of sidelink transmissions; transmitting, to the UE, a second downlink control information message indicating scheduling information for the set of sidelink transmissions and a first group index associated with the set of sidelink transmissions; and transmitting, with the downlink control information message, an indication of scheduling information for the set of downlink transmissions and that the set of downlink transmissions is associated with the first group index, and wherein the feedback report format comprises a joint feedback report for reporting the set of sidelink transmissions associated with the first group index, the set of downlink transmissions associated with the first group index, and the second set of sidelink transmissions associated with the third group index.

Aspect 36: The method of any of aspects 21 through 35, further comprising: transmitting, to the UE, a third downlink control information message indicating scheduling information for a second set of sidelink transmissions and a third group index associated with the second set of sidelink transmissions; transmitting, to the UE, a fourth downlink control information message indicating scheduling information for a second set of downlink transmissions and a fourth group index associated with the second set of downlink transmissions; transmitting, to the UE, the second set of downlink transmissions; transmitting, to the UE, a second downlink control information message information indicating scheduling information for the set of downlink transmissions and a first group index associated with the set of downlink transmissions; and transmitting, with the downlink control information message, an indication of scheduling information for the set of sidelink transmissions and that the set of sidelink transmissions is associated with the first group index, and wherein the feedback report format comprises a joint feedback report for reporting the set of downlink transmissions associated with the first group index, the set of sidelink transmissions associated with the first group index, the second set of sidelink transmissions associated with the third group index, and the second set of downlink transmissions associated with the fourth group index.

Aspect 37: The method of aspect 36, wherein an order for feedback for each transmission of the set of downlink transmissions, the set of sidelink transmissions, the second set of downlink transmissions, and the second set of sidelink transmissions in the joint feedback report is based at least in part on the first group index, the third group index, the fourth group index, and a transmission type for each transmission

Aspect 38: The method of any of aspects 21 through 37, further comprising: transmitting, to the UE, a third downlink control information message indicating scheduling information for a second set of downlink transmissions and a third group index associated with the second set of downlink transmissions; transmitting, to the UE, the second set of downlink transmissions; transmitting, to the UE, a fourth downlink control information message indicating scheduling information for a second set of sidelink transmissions and a fourth group index associated with the second set of sidelink transmissions; transmitting, to the UE, a second downlink control information message indicating scheduling information for the set of sidelink transmissions and a first group index associated with the set of sidelink transmissions; and transmitting, with the downlink control information message, an indication of scheduling information for the set of downlink transmissions and that the set of downlink transmissions is associated with the first group index, and wherein the feedback report format comprises a joint feedback report for reporting the set of sidelink transmissions associated with the first group index, the set of downlink transmissions associated with the first group index, the second set of downlink transmissions associated with the third group index, and the second set of sidelink transmissions associated with the fourth group index.

Aspect 39: The method of aspect 38, wherein an order for feedback for each transmission of the set of downlink transmissions, the set of sidelink transmissions, the second set of downlink transmissions, and the second set of sidelink transmissions in the joint feedback report is based at least in part on the first group index, the third group index, the fourth group index, and a transmission type for each transmission.

Aspect 40: The method of any of aspects 21 through 39, further comprising: transmitting, with the downlink control information message, a set of bits indicating the feedback report format.

Aspect 41: An apparatus for wireless communications at a first UE, comprising a processor; memory coupled with the processor; and instructions stored in the memory and executable by the processor to cause the apparatus to perform a method of any of aspects 1 through 20.

Aspect 42: An apparatus for wireless communications at a first UE, comprising at least one means for performing a method of any of aspects 1 through 20.

Aspect 43: A non-transitory computer-readable medium storing code for wireless communications at a first UE, the code comprising instructions executable by a processor to perform a method of any of aspects 1 through 20.

Aspect 44: An apparatus for wireless communications at a base station, comprising a processor; memory coupled with the processor; and instructions stored in the memory and executable by the processor to cause the apparatus to perform a method of any of aspects 21 through 40.

Aspect 45: An apparatus for wireless communications at a base station, comprising at least one means for performing a method of any of aspects 21 through 40.

Aspect 46: A non-transitory computer-readable medium storing code for wireless communications at a base station, the code comprising instructions executable by a processor to perform a method of any of aspects 21 through 40.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first user equipment (UE), comprising:
receiving, from a base station, a downlink control information message indicating a feedback report format for reporting hybrid automatic repeat request feedback for sidelink transmissions and downlink transmissions;
transmitting, to at least a second UE, a set of sidelink transmissions;
receiving, from the base station, a set of downlink transmissions;
transmit, to the base station, a feedback report for at least one of the set of sidelink transmissions or the set of downlink transmissions based at least in part on the feedback report format.

2. The method of claim 1, further comprising:
receiving, from the base station, a second downlink control information message indicating scheduling information for the set of sidelink transmissions and a group index associated with the set of sidelink transmissions; and
receiving, with the downlink control information message, an indication of scheduling information for the set of downlink transmissions and that the set of downlink transmissions is associated with the group index, and wherein the feedback report format comprises a joint feedback report for reporting the set of sidelink transmissions associated with the group index and the set of downlink transmissions associated with the group index.

3. The method of claim 2, wherein an order for feedback for each transmission of the set of downlink transmissions and the set of sidelink transmissions in the joint feedback report is based at least in part on a transmission type for each transmission.

4. The method of claim 1, further comprising:
receiving, from the base station, a second downlink control information message indicating scheduling information for the set of downlink transmissions and a group index associated with the set of downlink transmissions; and
receiving, with the downlink control information message, an indication of scheduling information for the set of sidelink transmissions and that the set of sidelink transmissions is associated with the group index, and wherein the feedback report format comprises a joint feedback report for reporting feedback information for the set of sidelink transmissions associated with the group index and the set of downlink transmissions associated with the group index.

5. The method of claim 4, wherein an order for feedback for each transmission of the set of downlink transmissions and the set of sidelink transmissions in the joint feedback report is based at least in part on a transmission type for each transmission.

6. The method of claim 1, further comprising:
receiving, from the base station, a second downlink control information message indicating scheduling information for the set of sidelink transmissions and a first group index associated with the set of sidelink transmissions; and
receiving, with the downlink control information message, an indication of scheduling information for the set of downlink transmissions and that the set of downlink transmissions is associated with a second group index, and wherein the feedback report format comprises a joint feedback report for reporting feedback information for the set of sidelink transmissions associated with the first group index and the set of downlink transmissions associated with the second group index.

7. The method of claim 6, wherein an order for feedback for each transmission of the set of downlink transmissions and the set of sidelink transmissions in the joint feedback report is based at least in part on the first group index and the second group index.

8. The method of claim 1, further comprising:
receiving, from the base station, a second downlink control information message indicating scheduling information for the set of downlink transmissions and a first group index associated with the set of downlink transmissions; and
receiving, with the downlink control information message, an indication of scheduling information for the set of sidelink transmissions and that the set of sidelink transmissions is associated with a second group index, and wherein the feedback report format comprises a joint feedback report for reporting feedback information for the set of sidelink transmissions associated with the first group index and the set of downlink transmissions associated with the second group index.

9. The method of claim 8, wherein an order for feedback for each transmission of the set of downlink transmissions and the set of sidelink transmissions in the joint feedback report is based at least in part on the first group index and the second group index.

10. The method of claim 1, further comprising:
receiving, from the base station, a third downlink control information message indicating scheduling information for a second set of sidelink transmissions and a third group index associated with the second set of sidelink transmissions;
transmitting, to at least the second UE, the second set of sidelink transmissions;
receiving, from the base station, a second downlink control information message indicating scheduling information for the set of downlink transmissions and a first group index associated with the set of downlink transmissions; and
receiving, with the downlink control information message, an indication of scheduling information for the set of sidelink transmissions and that the set of sidelink transmissions is associated with the first group index, and wherein the feedback report format comprises a joint feedback report for reporting the set of downlink transmissions associated with the first group index, the set of sidelink transmissions associated with the first group index, and the second set of sidelink transmissions associated with the third group index.

11. The method of claim 1, further comprising:
receiving, from the base station, a third downlink control information message indicating scheduling information for a second set of sidelink transmissions and a third group index associated with the second set of sidelink transmissions;
transmitting, to at least the second UE, the second set of sidelink transmissions;
receiving, from the base station, a second downlink control information message indicating scheduling information for the set of downlink transmissions and a first group index associated with the set of downlink transmissions; and
receiving, with the downlink control information message, an indication of scheduling information for the set of sidelink transmissions and that the set of sidelink transmissions is associated with a second group index, and wherein the feedback report format comprises a joint feedback report for reporting the set of downlink transmissions associated with the first group index, the set of sidelink transmissions associated with the second group index, and the second set of sidelink transmissions associated with the third group index.

12. The method of claim 1, further comprising:
receiving, from the base station, a third downlink control information message indicating scheduling information for a second set of downlink transmissions and a third group index associated with the second set of downlink transmissions;
receiving, from the base station, the second set of downlink transmissions;
receiving, from the base station, a second downlink control information message indicating scheduling information for the set of sidelink transmissions and a first group index associated with the set of sidelink transmissions; and
receiving, with the downlink control information message, an indication of scheduling information for the set of downlink transmissions and that the set of downlink transmissions is associated with the first group index, and wherein the feedback report format comprises a joint feedback report for reporting the set of sidelink transmissions associated with the first group index, the set of downlink transmissions associated with the first group index, and the second set of downlink transmissions associated with the third group index.

13. The method of claim 1, further comprising:
receiving, from the base station, a third downlink control information message indicating scheduling information for a second set of downlink transmissions and a third group index associated with the second set of downlink transmissions;
receiving, from the base station, the second set of downlink transmissions;
receiving, from the base station, a second downlink control information message indicating scheduling information for the set of sidelink transmissions and a first group index associated with the set of sidelink transmissions; and
receiving, with the downlink control information message, an indication of scheduling information for the set of downlink transmissions and that the set of downlink transmissions is associated with a second group index, and wherein the feedback report format comprises a joint feedback report for reporting the set of sidelink transmissions associated with the first group index, the set of downlink transmissions associated with the second group index, and the second set of downlink transmissions associated with the third group index.

14. The method of claim 1, further comprising:
receiving, from the base station, a third downlink control information message indicating scheduling information for a second set of downlink transmissions and a third group index associated with the second set of downlink transmissions;
receiving, from the base station, the second set of downlink transmissions;
receiving, from the base station, a second downlink control information message indicating scheduling information for the set of downlink transmissions and a first group index associated with the set of downlink transmissions; and
receiving, with the downlink control information message, an indication of scheduling information for the set of sidelink transmissions and that the set of sidelink transmissions is associated with the first group index, and wherein the feedback report format comprises a joint feedback report for reporting the set of downlink transmissions associated with the first group index, the set of sidelink transmissions associated with the first group index, and the second set of downlink transmissions associated with the third group index.

15. The method of claim 1, further comprising:
receiving, from the base station, a third downlink control information message indicating scheduling information for a second set of sidelink transmissions and a third group index associated with the second set of sidelink transmissions;
transmitting, to at least the second UE, the second set of sidelink transmissions;
receiving, from the base station, a second downlink control information message indicating scheduling information for the set of sidelink transmissions and a first group index associated with the set of sidelink transmissions; and
receiving, with the downlink control information message, an indication of scheduling information for the set of downlink transmissions and that the set of downlink transmissions is associated with the first group index, and wherein the feedback report format comprises a joint feedback report for reporting the set of sidelink transmissions associated with the first group index, the set of downlink transmissions associated with the first group index, and the second set of sidelink transmissions associated with the third group index.

16. The method of claim 1, further comprising:
receiving, from the base station, a third downlink control information message indicating scheduling information for a second set of sidelink transmissions and a third group index associated with the second set of sidelink transmissions;
transmitting, to at least the second UE, the second set of sidelink transmissions;
receiving, from the base station, a fourth downlink control information message indicating scheduling information for a second set of downlink transmissions and a fourth group index associated with the second set of downlink transmissions;
receiving, from the base station, the second set of downlink transmissions;
receiving, from the base station, a second downlink control information message indicating scheduling information for the set of downlink transmissions and a first group index associated with the set of downlink transmissions; and
receiving, with the downlink control information message, an indication of scheduling information for the set of sidelink transmissions and that the set of sidelink transmissions is associated with the first group index, and wherein the feedback report format comprises a joint feedback report for reporting the set of downlink transmissions associated with the first group index, the set of sidelink transmissions associated with the first group index, the second set of sidelink transmissions associated with the third group index, and the second set of downlink transmissions associated with the fourth group index.

17. The method of claim 16, wherein an order for feedback for each transmission of the set of downlink transmissions, the set of sidelink transmissions, the second set of downlink transmissions, and the second set of sidelink transmissions in the joint feedback report is based at least in part on the first group index, the third group index, the fourth group index, and a transmission type for each transmission.

18. The method of claim 1, further comprising:
receiving, from the base station, a third downlink control information message indicating scheduling information for a second set of downlink transmissions and a third group index associated with the second set of downlink transmissions;
receiving, from the base station, the second set of downlink transmissions;
receiving, from the base station, a fourth downlink control information message indicating scheduling information for a second set of sidelink transmissions and a fourth group index associated with the second set of sidelink transmissions;
transmitting, to at least the second UE, the second set of sidelink transmissions;
receiving, from the base station, a second downlink control information message indicating scheduling information for the set of sidelink transmissions and a first group index associated with the set of sidelink transmissions; and
receiving, with the downlink control information message, an indication of scheduling information for the set of downlink transmissions and that the set of downlink transmissions is associated with the first group index, and wherein the feedback report format comprises a joint feedback report for reporting the set of sidelink transmissions associated with the first group index, the set of downlink transmissions associated with the first group index, the second set of downlink transmissions associated with the third group index, and the second set of sidelink transmissions associated with the fourth group index.

19. The method of claim 18, wherein an order for feedback for each transmission of the set of downlink transmissions, the set of sidelink transmissions, the second set of downlink transmissions, and the second set of sidelink transmissions in the joint feedback report is based at least in part on the first group index, the third group index, the fourth group index, and a transmission type for each transmission.

20. The method of claim 1, further comprising:
receiving, with the downlink control information message, a set of bits indicating the feedback report format.

21. A method for wireless communications at a base station, comprising:
transmitting, to a user equipment (UE), a downlink control information message indicating a feedback report format for reporting hybrid automatic repeat request feedback for sidelink transmissions and downlink transmissions;
transmitting, to the UE, scheduling information for a set of sidelink transmissions;
transmitting, to the UE, a set of downlink transmissions;
receiving, from the UE, a feedback report for at least one of the set of sidelink transmissions or the set of downlink transmissions based at least in part on the feedback report format.

22. The method of claim 21, further comprising:
transmitting, to the UE, a second downlink control information message indicating scheduling information for the set of sidelink transmissions and a group index associated with the set of sidelink transmissions; and
transmitting, with the downlink control information message, an indication of scheduling information for the set of downlink transmissions and that the set of downlink transmissions is associated with the group index, and wherein the feedback report format comprises a joint feedback report for reporting the set of sidelink transmissions associated with the group index and the set of downlink transmissions associated with the group index.

23. The method of claim 22, wherein an order for feedback for each transmission of the set of downlink transmissions and the set of sidelink transmissions in the joint feedback report is based at least in part on a transmission type for each transmission.

24. The method of claim 21, further comprising:
transmitting, to the UE, a second downlink control information message indicating scheduling information for the set of downlink transmissions and a group index associated with the set of downlink transmissions; and
transmitting, with the downlink control information message, an indication of scheduling information for the set of sidelink transmissions and that the set of sidelink transmissions is associated with the group index, and wherein the feedback report format comprises a joint feedback report for reporting feedback information for the set of sidelink transmissions associated with the group index and the set of downlink transmissions associated with the group index.

25. The method of claim 24, wherein an order for feedback for each transmission of the set of downlink transmissions and the set of sidelink transmissions in the joint feedback report is based at least in part on a transmission type for each transmission.

26. The method of claim 21, further comprising:
transmitting, to the UE, a second downlink control information message indicating scheduling information for the set of sidelink transmissions and a first group index associated with the set of sidelink transmissions; and
transmitting, with the downlink control information message, an indication of scheduling information for the set of downlink transmissions and that the set of downlink transmissions is associated with a second group index, and wherein the feedback report format comprises a joint feedback report for reporting feedback information for the set of sidelink transmissions associated with the first group index and the set of downlink transmissions associated with the second group index.

27. The method of claim 26, wherein an order for feedback for each transmission of the set of downlink transmissions and the set of sidelink transmissions in the joint feedback report is based at least in part on the first group index and the second group index.

28. The method of claim 21, further comprising:
transmitting, to the UE, a second downlink control information message indicating scheduling information for the set of downlink transmissions and a first group index associated with the set of downlink transmissions; and
transmitting, with the downlink control information message, an indication of scheduling information for the set of sidelink transmissions and that the set of sidelink transmissions is associated with a second group index, and wherein the feedback report format comprises a joint feedback report for reporting feedback information for the set of sidelink transmissions associated with the first group index and the set of downlink transmissions associated with the second group index.

29. An apparatus for wireless communications at a first user equipment (UE), comprising:
a processor;
memory coupled with the processor; and
instructions stored in the memory and executable by the processor to cause the apparatus to:
receive, from a base station, a downlink control information message indicating a feedback report format for reporting hybrid automatic repeat request feedback for sidelink transmissions and downlink transmissions;
transmit, to at least a second UE, a set of sidelink transmissions;
receive, from the base station, a set of downlink transmissions;
transmit, to the base station, a feedback report for at least one of the set of sidelink transmissions or the set of downlink transmissions based at least in part on the feedback report format.

30. An apparatus for wireless communications at a base station, comprising:
a processor;
memory coupled with the processor; and
instructions stored in the memory and executable by the processor to cause the apparatus to:
transmit, to a user equipment (UE), a downlink control information message indicating a feedback report format for reporting hybrid automatic repeat request feedback for sidelink transmissions and downlink transmissions;
transmit, to the UE, scheduling information for a set of sidelink transmissions;
transmit, to the UE, a set of downlink transmissions;
receive, from the UE, a feedback report for at least one of the set of sidelink transmissions or the set of downlink transmissions based at least in part on the feedback report format.
